(19) United States
(12) Patent Application Publication
(10) Pub. No.: US 2004/0236843 A1
(43) Pub. Date: Nov. 25, 2004

(54) Online diagnosing of computer hardware and software

(76) Inventors: Robert Wing, Louisville, CO (US); Harvey Lawton, Westminster, CO (US)

Correspondence Address: SHERIDAN ROSS PC, 1560 BROADWAY, SUITE 1200, DENVER, CO, 80202

(21) Appl. No.: 10/450,011

(22) PCT Filed: Nov. 15, 2001
(86) PCT No.: PCT/US01/43538

(51) Int. Cl. G06F 15/16

(52) U.S. Cl. 709/219; 709/203

(57) ABSTRACT

A method and apparatus for online diagnosis and repair of computer hardware and software are provided. A client application and executable program scripts are downloaded to a computer (108) to be diagnosed. The client application executes the scripts and returns information obtained as a result of executing those scripts to a server (104). The server (104) then applies a rule based analysis to the returned information and provides a disposition to the computer (108) to be diagnosed. The disposition may include information regarding a potential remedy for the detected problems, or may include provisions to automatically effect a repair. In one embodiment, the client computer (108) is directed to the exact universal resource location at which information or a file needed to effect a repair can be found.

### FIELD OF THE INVENTION

The present invention relates to the diagnosing of computers from a remote location. In particular, the present invention relates to a method and apparatus for diagnosing computer hardware, software and performance problems from a remote location, at least substantially without requiring human assistance at the remote location.

### BACKGROUND OF THE INVENTION

The diagnosis and remediation of problems associated with the operation of computers is increasingly important to the computer industry. In particular, assisting both experienced and inexperienced computer users in remedying recurring problems has become a significant drain on computer hardware and software manufacturers. Typically, problems encountered by computer users are dealt with by human telephone operators. The telephone operators, or “support personnel,” may or may not have access via a communications link to the problem computer. Generally, the process of diagnosing and remedying computer problems from a remote location is time consuming for both the computer user and the support personnel. Furthermore, the provision of support personnel is a significant cost to the computer industry.

In order to reduce the expenses associated with maintaining a cadre of support personnel, the computer industry has implemented various approaches. For instance, some software and hardware companies severely limit user access to support personnel. Access may be limited to recent purchasers of a product, or the user may be charged a fee for contacting the support personnel. However, limiting the access of customers to assistance by restricting those customers who are eligible for such assistance or by charging fees for such assistance generates ill will among customers. In addition, such approaches do not reduce the time required to successfully remedy problems and they do not reduce the difficulty of diagnosing and remedying problems from a remote location.

As an alternative or in addition to restrictions on access to support personnel, some computer hardware and software providers supply “online” help. Such online help may be in the form of statements of typical problems and suggested solutions to those problems. This online help may be stored in media provided with the hardware or software or may be accessible to the user by contacting a specified server over a computer network, such as the Internet. However, such systems are ineffective if the computer user is unable to recognize his or her particular problem from among the included problems and suggested solutions. In addition, such systems provide assistance only with problems directly associated with a particular piece of hardware or software. Therefore, they are generally unable to assist a user in successfully addressing, for example, problems that affect the particular hardware or software but that are caused by another hardware or software component in the user's computer.

The providers of computer hardware and software have also utilized programs that allow support personnel at a remote location to operate or obtain information from a user's computer from the remote location. Such systems have the advantage of allowing trained personnel to directly address the user's computer. However, users may object to allowing a stranger to have complete access to the user's computer. In addition, such systems do not remove the need for maintaining support staff, and such systems have a relatively high impact on the resources of the user's computer.

Still another approach to providing support for computer users is to provide automated or semiautomated diagnostic programs. Such programs may be resident on the user's computer, or may be accessed over a computer network, such as the Internet. However, providing a support program resident on a user's computer having the ability to diagnose and potentially address a wide range of problems requires a relatively large program. Particularly where a user's computer is not operating properly, loading or accessing such a program can be problematic. Similarly, diagnostic programs that allow a user to interconnect to them over a computer network generally have a high impact on the user's computer, in that the programs are relatively large and require a relatively large amount of memory and resources to operate. For instance, Internet browsers may allow access to a computer's system information and control settings, however the browser components necessary to allow such interactivity, such as ACTIVE X or other browser “plug ins,” demand a relatively large amount of resources on the user's computer. In addition, not every type or version of browser is compatible with a particular browser plug-in, and the user may be required to obtain and install additional or alternative browsers or plug-ins. Accordingly, the operation of such systems can be problematic. Furthermore, such systems are incapable of effecting automatic repairs to a user's computer.

It would be advantageous to provide a method and apparatus that enabled computer problems to be diagnosed and remedied from a remote location. In particular, it would be advantageous to provide a method and apparatus to remotely diagnose and remedy computer problems from a remote location that essentially did not require involvement by support personnel at the remote location. In addition, it would be advantageous to provide a method and apparatus for diagnosing computer problems from a remote location capable of operating on computers having limited resources available as a result of a problem or problems requiring diagnosis. It would also be advantageous to provide a method and apparatus that did not require a user to state the exact nature of the problem in order to obtain a suggested solution. Furthermore, it would be advantageous to provide a method and apparatus for diagnosing computer problems from a remote location capable of successfully diagnosing a majority of presented problems, and that could be provided at reasonable cost.

### SUMMARY OF THE INVENTION

In accordance with the present invention, a method and apparatus for diagnosing computer problems from a remote location are provided. The present invention generally allows diagnostic tests or individual commands to be downloaded from a remote location and operated on a computer or other device to be diagnosed. In particular, the present invention allows for the diagnosis of a computer without requiring a large amount of the resources of the computer to be diagnosed. Furthermore, where an automated solution is available, the present invention is capable of repairing the computer.

In accordance with one embodiment of the present invention, method and apparatus are provided that allows for the remote diagnosis of computer problems. According to the method and apparatus, the user of a computer to be diagnosed initiates contact with a diagnosing server. This contact may be made over a computer network, including a wireless network, using a communications interface, such as an Internet browser program. A client application is then downloaded from the server to the computer. The client application is capable of executing scripts or individual commands that may be downloaded from the diagnosing server. In general, the scripts comprise diagnostic tools for collecting various information regarding the client computer. The results obtained from executing the client scripts or individual commands are returned to the diagnosing server. The returned results are compared to stored results using a rules based analysis, and a disposition is returned to the browser of the computer. The disposition may include automatically performing a maintenance or repair procedure, may suggest that the user perform a particular maintenance or updating procedure, may automatically take the user to a web page or information source, or may refer the user to a source of further information or assistance regarding the diagnosed problem.

In accordance with another embodiment of the present invention, a client application running on a computer to be diagnosed is provided with an identifier generated by the diagnosing server by passing the identifier from the title bar of the browser to the client application.

According to still another embodiment of the present invention, the client application polls a server application running on a remotely located server. In particular, the client application polls the server for instructions concerning a next operation to be performed in connection with the computer. For instance, the client application may poll a server application for an instruction to execute a script or command. After executing a script or command, the client application signals the server application that execution has been completed. An indication that execution of a particular script has been completed is entered in a database record associated with the client computer and identified by the identifier. In addition, the browser may poll the server application to detect an indication that execution of the script has been completed. In response to detecting such an indication, the browser or screen displays a next page to the user.

According to yet another embodiment of the present invention, a user establishes contact with a remotely located server using an Internet browser or other communications interface. The user registers with the server and is assigned an identifier. A client application is downloaded from the server and installed on the client computer or device. Next, a script or command, for execution using the client application, is downloaded to the client computer. The client application polls a record in a database maintained by the remotely located server and having the same identifier as the client computer to detect a signal to begin execution of the script or command. The indication to execute the script or command maybe provided in response to a signal from the browser or other communications interface authorizing such execution. Upon detection of the indication, the script is executed, and the results are returned to the server. The browser or other communications interface polls the database record to detect an indication that execution of the script or command has been completed. Upon detecting such an indication, the browser or other communications interface displays a next page.

According to still another embodiment of the present invention, the user of the client computer is prompted to specify whether the problem is believed to be a hardware, software or performance problem. Based on the user's selection, additional scripts or commands may be downloaded to the client application and executed. For instance, if a user specifies a software problem, a script may be downloaded to the client application to determine the nature of the problem. For instance, upon execution, such a script can instruct the user to start the problem application. The script may then determine the amount of time required for the computer to load the application, or may collect an error message generated in response to the user's attempt to start the problem application and return that error message to the server for analysis.

A variety of diagnostic tools in the form of scripts or commands may be downloaded to and executed by the client application. In general, the scripts or commands are provided to perform inventory and diagnostic functions. The client application and associated scripts or commands are designed to have a low impact on the system resources of the computer.

Based on the foregoing summary, a number of salient features of the present invention are readily discerned. A method and apparatus for diagnosing problems on a computer or other device from a remote location are provided. The method and apparatus of the present invention enable problems to be diagnosed and potential solutions proposed to a user of the computer or other device substantially without requiring human intervention at the server side. The present invention may also provide an automated solution to a problem on a computer being diagnosed. In addition, the method and apparatus of the present invention have a low impact on the resources of the computer or other device being diagnosed, thereby increasing the probability that the method and apparatus will successfully diagnose problems even on computers or other devices having reduced system capabilities due to the problem or problems requiring diagnosis.

Additional advantages of the present invention will become readily apparent from the following discussion, particularly when taken together with the accompanying drawings.

### BRIEF DESCRIPTION OF THE DRAWINGS

FIG. 1 is a block diagram depicting the major components of a system in accordance with an embodiment of the present invention;

FIG. 2 is a block diagram depicting a server in accordance with an embodiment of the present invention;

FIG. 3 is a block diagram depicting a client computer in accordance with an embodiment of the present invention;

FIG. 4 is a block diagram depicting the logical lines of communication between a server and a client computer in accordance with an embodiment of the present invention;

FIG. 5 is a flow chart illustrating the operation of a system in accordance with an embodiment of the present invention;

FIG. 6 is a diagram depicting the operation of a client application in accordance with an embodiment of the present invention;

FIG. 7 is a diagram depicting the operation of a communications interface in accordance with an embodiment of the present invention;

FIG. 8 is a flow chart depicting the operation of test modules in accordance with an embodiment of the present invention;

FIG. 9 is a flow chart depicting the operation of a system in accordance with an embodiment of the present invention in response to the selection of a hardware problem;

FIG. 10 is a flow chart depicting the operation of a system in accordance with an embodiment of the present invention in response to the selection of a software problem;

FIG. 11 is a flow chart depicting the operation of a system in accordance with an embodiment of the present invention in response to the selection of a performance problem;

FIG. 12 is a flow chart depicting the operation of a system in accordance with an embodiment of the present invention in response to the selection of an unknown problem;

FIG. 13 is a flow chart depicting the provision of a disposition to a client computer in accordance with an embodiment of the present invention;

FIGS. 14A-14E illustrate categories and subcategories of self-help dispositions in accordance with embodiment of the present invention;

FIG. 15 is a flow chart depicting a disposition determining process in accordance with an embodiment of the present invention;

FIG. 16 is a screen shot of a diagnostic service welcome screen in accordance with an embodiment of the present invention;

FIG. 17 is a screen shot of disclaimer and security notification page in accordance with an embodiment of the present invention;

FIG. 18 is a screen shot of a minimum system requirements page in accordance with an embodiment of the present invention;

FIG. 19 is a screen shot of a log-in page in accordance with an embodiment of the present invention;

FIGS. 20A and 20B are screen shots of a subscription purchase page in accordance with an embodiment of the present invention;

FIG. 21 is a screen shot of a log-in name and password selection page in accordance with an embodiment of the present invention;

FIG. 22 is a screen shot of a functional test sequence welcome page in accordance with an embodiment of the present invention;

FIG. 23 is a screen shot of a test in progress page in accordance with an embodiment of the present invention;

FIGS. 24A-C are screen shots of a system information report in accordance with an embodiment of the present invention;

FIG. 25 is a screen shot of a problem selection page in accordance with an embodiment of the present invention;

FIGS. 26A-26C are screen shots of a hardware problem selection page in accordance with an embodiment of the present invention;

FIG. 27 is a screen shot of a monitor problem solution page in accordance with an embodiment of the present invention;

FIGS. 28A and 28B are screen shots of a bad or distorted picture solution page in accordance with an embodiment of the present invention;

FIGS. 29A and 29B are screen shots of a video driver problem solution page in accordance with an embodiment of the present invention;

FIGS. 30A and 30B are screen shots of a video connector problem solution page in accordance with an embodiment of the present invention;

FIGS. 31A and 31B are screen shots of a video card connection problem solution page in accordance with an embodiment of the present invention;

FIG. 32 is a screen shot of a video card capability problem solution page in accordance with an embodiment of the present invention;

FIG. 33 is a screen shot of a hard disk drive problem selection page in accordance with an embodiment of the present invention;

FIGS. 34A and 34B are screen shots of a hard disk drive write problem solution page in accordance with an embodiment of the present invention;

FIG. 35 is a screen shot of full hard disk drive problem solution page in accordance with an embodiment of the present invention;

FIG. 36 is a screen shot of a fragmented hard disk drive problem solution page in accordance with an embodiment of the present invention;

FIGS. 37A and 37B are screen shots of a hard disk drive connector solution page in accordance with an embodiment of the present invention;

FIG. 38 is a screen shot of a printer not detected solution page in accordance with an embodiment of the present invention;

FIGS. 39A-39C are screen shots of a printer CMOS entry problem solution page in accordance with an embodiment of the present invention;

FIGS. 40A-40D are screen shots of a printer connection problem solution page in accordance with an embodiment of the present invention;

FIG. 41 is a screen shot of a software problem selection page in accordance with an embodiment of the present invention;

FIG. 42 is a screen shot of a software error, scan disk disposition screen in accordance with an embodiment of the present invention;

FIG. 43 is a screen shot of a scan disk information page in accordance with an embodiment of the present invention;

FIG. 44 is a screen shot of a software error defragmentation diagnostic page in accordance with an embodiment of the present invention;

FIG. 45 is a screen shot of a defragmentation information page in accordance with an embodiment of the present invention;

FIG. 46 is a screen shot of a software error, check for error message disposition page in accordance with an embodiment of the present invention;

FIG. 47 is a screen shot of a check program error information page in accordance with an embodiment of the present invention;

FIG. 48 is a screen shot of an error message found page in accordance with an embodiment of the present invention;

FIG. 49 is a screen shot of an uninstall program information page in accordance with an embodiment of the present invention;

FIGS. 50A and 50B are screen shots of a problem status page in accordance with an embodiment of the present invention;

FIGS. 51A and 51B are screen shots of a summary report page in accordance with an embodiment of the present invention;

FIG. 52 is a screen shot of a potential issues page in accordance with an embodiment of the present invention;

FIG. 53 is a screen shot of a maintenance issues page in accordance with an embodiment of the present invention; and

FIG. 54 is a screen shot of a service and upgrade options page in accordance with an embodiment of the present invention.

### DETAILED DESCRIPTION

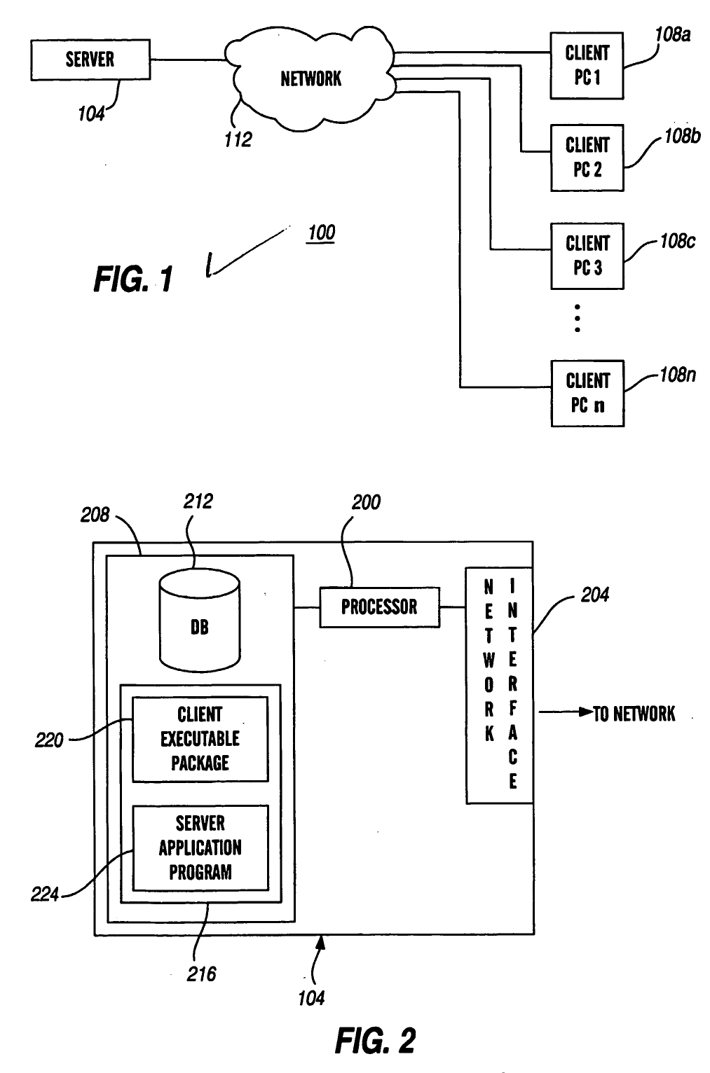

FIG. 1 illustrates a system 100 in accordance with an embodiment of the present invention. The system 100 generally includes a server 104 interconnected to a plurality of client computers 108a to 108n by a network 112. In general, the network 112 may be any computer network or means of establishing communications between two computers, including the Internet and wireless methods.

With reference now to FIG. 2, a server 104 in accordance with an embodiment of the present invention is illustrated. The server 104 generally includes a processor 200, a network interface 204 and storage 208. The storage 208 may include a database 212 and stored programs 216. The stored programs 216 may include a client executable package 220 and a server application program 224.

In general, the processor 200 may be any computer processor suitable for use in a general purpose server computer. For instance, the processor 200 may comprise one or more INTEL PENTIUM® class microprocessors. The network interface 204 may be any communications interface suitable for interconnecting a server computer to a communication network 112. For example, the network interface 204 may comprise a TCP/IP interface or others. The storage 208 may comprise any mass media storage device, such as a hard drive, tape drive, or optical drive. In addition, the storage 208 may comprise multiple devices of various types.

The database 212 may be any control program and associated records suitable for storing and organizing information. The client executable package 220 generally includes programs for downloading to client computers 108. The server application program 224 includes the commands and instructions required to coordinate the registration of users with the system 100, the downloading and execution of components of the client executable package 220, and the exchange of information between the database 212 and the client computers 108. Accordingly, the server application program 224 may include components to interface the database 212 to the client computers 108.

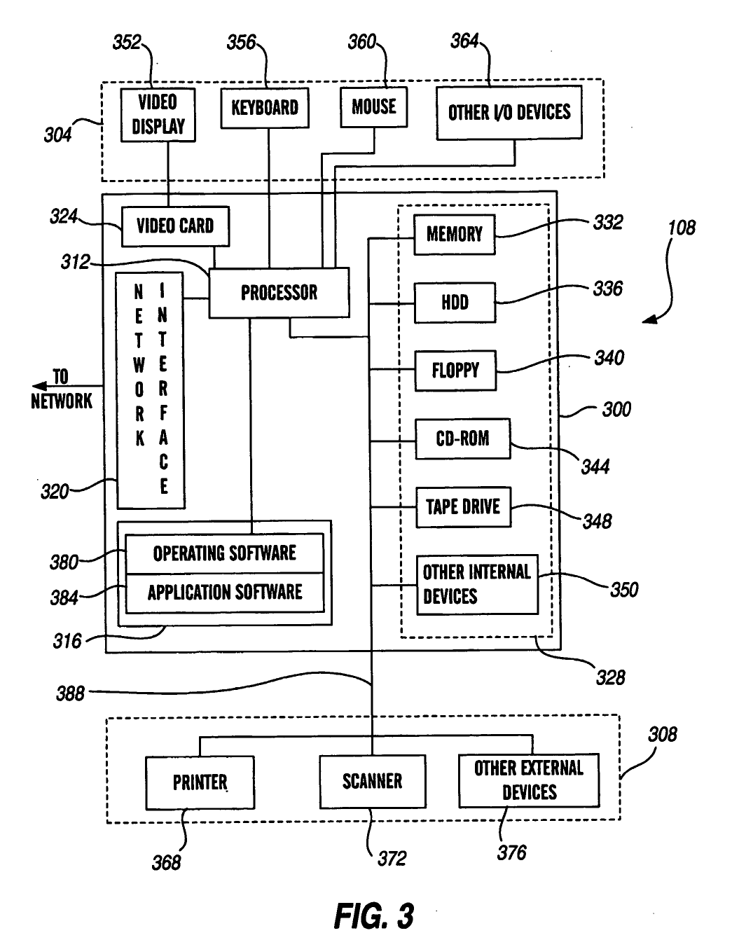

FIG. 3 depicts a client computer 108 in accordance with an embodiment of the present invention. The client computer 108 may comprise a central processing unit (CPU) 300, input/output devices 304 and peripheral devices 308. According to one embodiment of the present invention, the client computer 108 is any general or personal type computer. According to a further embodiment of the present invention, the client computer 108 is a PC computer running a MICROSOFT WINDOWS® operating system. As used herein, the term client computer may, in addition to a general or personal type computer, also refer to a variety of digital devices capable of communicating with another digital device, including personal digital assistants (PDA's) or other hand held devices.

According to one embodiment of the present invention, the CPU 300 generally includes a processor 312, storage 316, a network interface 320, a video card 324 and a plurality of internal devices 328. The internal devices may comprise memory 332, a hard disk drive 336, a floppy disk drive 340, a CD-ROM drive 344, a tape drive 348 and other internal devices 350. The input/output devices may include a video display or monitor 352, a keyboard 356, a mouse 360 and other input/output devices 364 such as audio devices and additional pointing devices. The peripheral devices 308 may generally include a printer 368, a scanner 372 and other external devices 376. The client computer 108 may also include operating software 380 and application software 384. In general, the various components of the client computer communicate with one another over a communications bus 388.

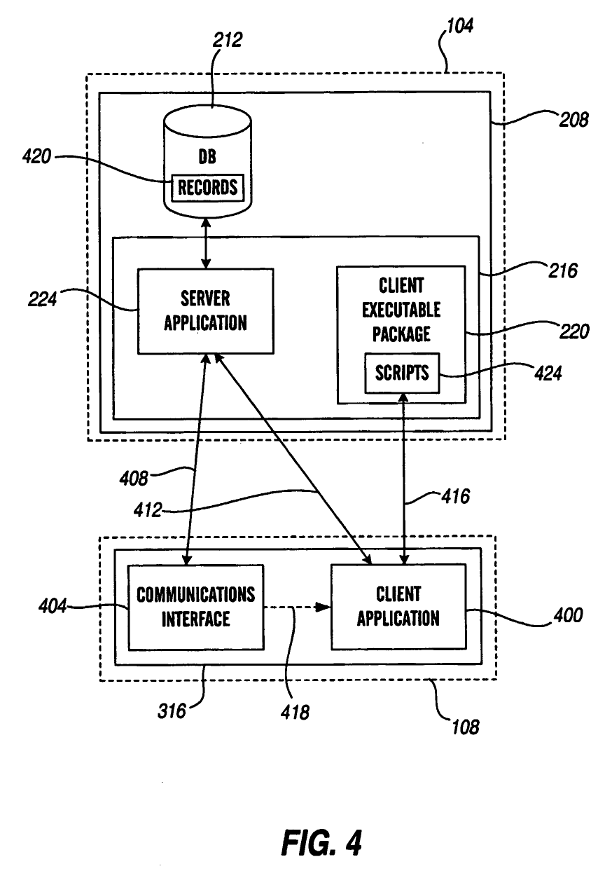

With reference now to FIG. 4, the logical lines of communication between the server 104 and the client computer 108 are illustrated. In general, a first logical line of communication 408 extends between the server application 224 and a communications interface 404. The communications interface 404 may include any communications application running on the client computer or device 108 that is capable of passing data between the client computer or device 108 and the server application program 224. For example, the communications interface may comprise an Internet browser. Similarly, a second logical line of communication 412 extends between the server application 224 and the client application 400. A third logical line of communication 416 extends between the client executable package 220 and the client application 400. As is evident from FIG. 4, except for an identifier communication path 418, there is generally no direct line of communication between the client application 400 and the communications interface 404. Accordingly, with the exception of passing an identifier from the communications interface 404 to the client application 400 over the identifier communication path 418, as will be described below, the client application 400 and the communications interface 404 communicate via the server application 224. The physical communications link over which the logical communication channels 408, 412 and 416 are established may comprise the computer network 112 and associated network interfaces 204 and 320 described above. The physical communications link over which the identifier communication path 418 is established may comprise the communications bus 388 or internal registers.

The operation of the client application 400 and the communications interface 404 are synchronized to each other by monitoring a field in tables or records 420 stored in the database 212 through an interface provided by the server application 224, as will be explained in detail below. This arrangement allows the client application 400 to be implemented as a relatively small program that requires relatively few of the client computer's 108 system resources to operate. In particular, it allows the client application 400 to control aspects of the operation of the client computer 108 without requiring a program that is integrated with the communications interface 404. More particularly, the client application 400 is selectively provided with diagnostic tools, such as individual commands or application scripts 424 that perform selected functions. For example, the diagnostic tools may comprise code that is capable of execution while residing on the client computer 108. This is advantageous, as programs integrated with a communications interface 404, such as an Internet browser, that are capable of detailed interaction with the operational aspects of the client computer 108 typically consume a relatively large amount of system resources. In addition, such programs may not be compatible with all versions or types of a communications interface 404. Accordingly, the arrangement illustrated in FIG. 4 enables the present invention to function even on client computers 108 having compromised performance characteristics, for example due to a problem requiring diagnosis. The arrangement illustrated in FIG. 4 also allows the present invention to operate in cooperation with a wide range of communications interfaces 404.

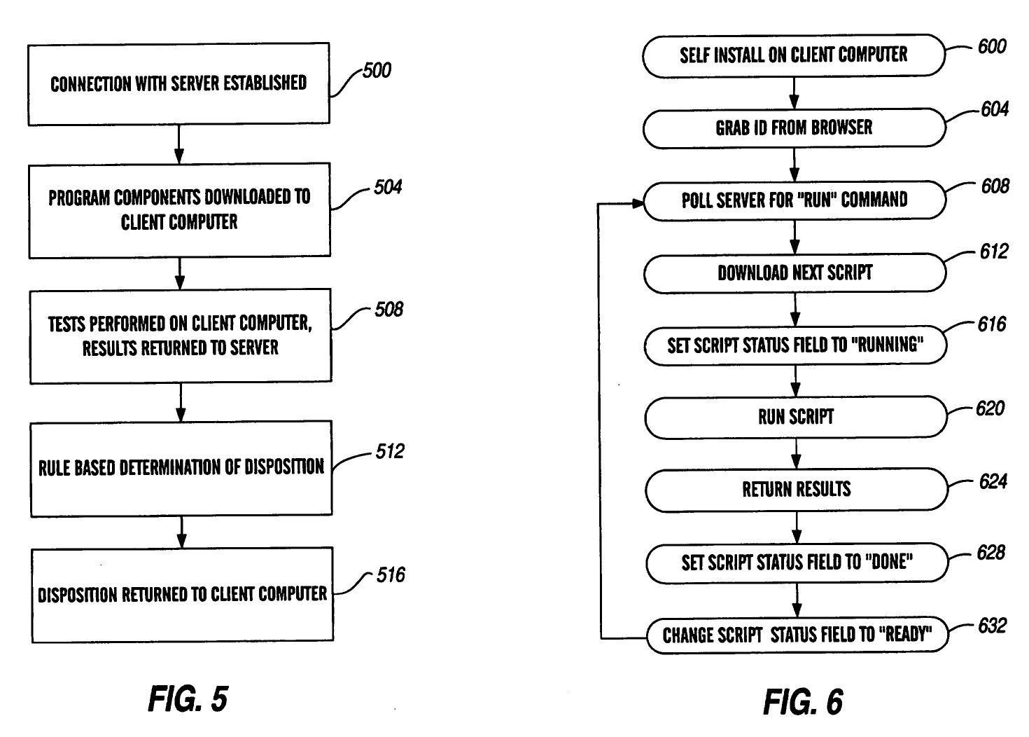

With reference now to FIG. 5, the operation of a system 100 in accordance with an embodiment of the present invention is illustrated. Initially, the user of a client computer or device 108 establishes a connection with the server 104 (step 500). The user may establish the connection by, for example, directing a communications interface 404 on the client computer 108 to a website providing access to the server 104 over a computer network 112. According to one embodiment of the present invention, active server pages may be used to provide the user of the client computer or device 108 with information from the server application 224. Information from the user may be provided to the server application 224 using the communications interface 404.

As part of establishing a connection with the server 104, the user may be required to register with the server 104. Registration may include the provision of information identifying the user to the server 104. In particular, registration may include the creation of a record 420 in the database 212 for recording various information collected from the user. For instance, the record 420 for user information may include fields for a user name, a user address, and billing information, such as a credit card number and expiration date. Furthermore, the record 420 for user information may include a field for storing an identifier assigned by the server application program 224 and used by the system 100 to distinguish a particular client computer 108 from any other client computers 108 that are or have been in communication with the server 104. The identifier also allows an individual user to register and diagnose more than one client computer 108. A field for indicating a next script or command and a next page of information to display may also be provided. In addition, a script status field may be provided and used to synchronize the operation of the client application 400 and the communications interface 404.

Following the completion of registration, the client application 400 is downloaded to and installed in the client computer 108 (step 504). A first command, script or set of scripts 424 may be downloaded with the client application 400. As used herein, the term script 424 should be understood to include a command or set of commands capable of being executed by the client application program 400. The command or commands comprising a script 424 may define a diagnostic tool that is useful in triggering execution of a program code that is already resident in the client computer 108. In general, the client application program 400 receives scripts 424 from the server 104 and executes those scripts 424. According to one embodiment of the present invention, a number of scripts 424 are provided. The use of a number of relatively small scripts 424 minimizes the impact that running the scripts 424 using the client application 400 has on the client computer 108. In addition, the use of multiple scripts 424 allows the diagnosis of the client computer 108 to progress at a steady pace, rather than requiring a relatively long initial wait to download program code before testing can begin. Furthermore, the use of multiple scripts 424 allows the download and performance of only those tests that may be useful in diagnosing a particular client computer 108, thereby providing an efficient test process.

The scripts 424 may be grouped as one or more test modules or diagnostic tools that perform various functions. The diagnostic tools may themselves comprise one or more scripts 424, or they may comprise tools already resident in the client computer that are launched by a script 424. In general, each of the scripts 424 performs a discrete operation or set of operations when executed by the client application 400, as will be explained in the discussion set forth below.

At step 508, the various tests are performed on the client computer 108. According to one embodiment of the present invention the various test modules and other program components are executed immediately or almost immediately after they are downloaded to the client computer 108. Therefore, according to this embodiment of the present invention, the step of downloading program components (step 504) may alternate with the step of executing the test modules or commands. The results obtained from executing the test modules and any other program components are then returned from the client application 400 to the server application 224 over logical line of communication 412. The return of collected information to the server application 224 may also be carried out following the execution of each test module or individual test script 424.

According to one embodiment of the present invention, general tests may be performed, and additional tests may be performed after responses to questions presented to the user have been elicited. Accordingly, the present invention may provide an interactive problem solving method.

The server application 224 stores the returned results in a record or records 420 maintained on the database 212. According to one embodiment of the present invention, a record 420 is provided for each major category of information relating to the client computer 108. For example, the records 420 may include individual records for information concerning the user, monitor, ports, printers, storage devices, system settings, video adaptor, performance, software, audio devices, component manufacturers and disposition. Additional or fewer types of records may be used. In general, the records 420 containing information concerning a particular client computer or device 108 are identified by the identifier assigned to that client computer 108 by the server application 224 when the user registered with the server application 224. In addition, the records 420 may include records containing general information concerning particular problems and associated dispositions, including scripts 424 to perform procedures, including repair procedures, information regarding potential fixes, and contact information for automated transport to sources of additional support regarding particular devices or problems. Where automated transport is provided, the communications interface 404 may be automatically directed to a Web page, such as a Web page maintained by the manufacturer of a problematic device or program, that contains relevant information. The database 212 may also store the scripts 424 to perform maintenance procedures and software patches, or links to such scripts 424 and software patches.

At step 512, a rules-based determination of the disposition of the client computer 108 is conducted. In general, information obtained from the execution of the test modules or commands and other software components is analyzed, and a disposition concerning the client computer 108 is arrived at. The rules-based analysis is, according to one embodiment of the invention, adaptive in that the disposition returned to a client computer 108 in response to a particular problem may change as additional or alternative dispositions are added to the database. For example, the disposition may include a suggestion to install a software patch, to run a maintenance procedure, to perform a repair procedure, to perform a specific further test (e.g., to check that power or signal cables are properly connected), to change a system setting, or to obtain additional information from another source.

According to one embodiment of the present invention, the rules based analysis of the disposition of the client computer 108 includes storing information returned from the execution of diagnostic tools including scripts 424 in the database 212. In particular, the information returned to the server 104 is stored in various records 420 maintained or created in the database 212. In general, the information contained in a record 420 may be limited to information concerning a particular device or type of device associated with the client computer 108. In particular, information regarding components, devices or software associated with a client computer 108 may be stored in database records 420 that contain information directed to a particular component, device or software program associated with the client computer 108. Where the user has specified a component, device or software program as problematic, the record 420 containing information concerning the identified item may be queried to determine whether the item successfully passed earlier diagnostic tests. For instance, the record 420 may be queried to determine whether the item passed or failed the earlier test. A new record 420 containing disposition information may then be created, to store information related to the item. Next, a table in the database 212 containing support information may be accessed by the server application 224. In general, the table containing support information comprises records 420 pertaining to problems and solutions for various components, devices or software associated with client computers 108. In general, a disposition stored in a record included in the disposition table directed to the same problem detected or identified in connection with the particular client computer 108 being diagnosed is returned to the client computer 108. The particular disposition returned may vary depending on whether the component, device or software program was found to have passed or to have failed earlier tests. Furthermore, it should be understood that the particular disposition may include a plurality of suggested dispositions.

The particular disposition returned initially to the client computer 108 is, according to one embodiment of the present invention, the solution that has been determined to be the most likely one to remedy the identified problem. If the initial disposition is not successful in remedying the identified problem, additional dispositions may be provided. Furthermore, the disposition returned to a client computer 108 may change from one session to another as information regarding solutions that are successful in remedying particular problems is gathered.

The disposition is then returned to the client computer 108 (step 516). Where the disposition includes a suggested maintenance procedure, repair procedure, software fix or change in system settings, that procedure may be carried out automatically. For example, the return of a disposition to the client computer 108 may include providing a script 424 for execution by the client application 400 that performs the suggested maintenance operation, repair procedure, software fix or change in system setting automatically. The operation may be an operation that can be carried out using a software application already installed on the client computer 108, in which case the script 424 simply activates that application. Alternatively, the script 424 may itself include an executable program or command for carrying out the procedure.

If the suggested remedial procedure involves a software fix, the step of returning a disposition to the client computer 108 may include providing the necessary software patch or software program. For example, if a device driver has been found to be faulty, a software patch or new driver may be downloaded to the client computer 108 and installed automatically. Additionally, if the error message indicates a missing software component such as .dll, .exe or call, the software component can be replaced or updated. In the case of a system setting that requires modification, the return of a disposition to the client computer 108 may include the provision of a script 424 that, when executed by the client application 400, is capable of making the required change to the system settings.

In the examples given above, implementation of the suggested fix maybe automatic in that the user of the client computer 108 is not required to search for the maintenance procedure, software patch or system switch, and then implement the fix. Rather, the server application 224, as part of the disposition, provides a script 424 and any additional software necessary to perform the procedure. According to one embodiment of the present invention, the user of the client computer 108 is asked to authorize implementation of a suggested remedial procedure before it is carried out, to allow the user to control the changes that are made to the client computer 108.

In other instances, the disposition may include providing the user of a client computer 108 with a suggested solution to a diagnosed problem, but may require the user to implement the solution. For instance, a peripheral device 308 associated with the client computer 108 may require a new driver. However, that driver may not be available to the server application 224 for downloading to the client computer 108. In such instances, the disposition may include automatically directing the communications interface 404 to a website or universal resource locator (URL) address from which the user may be able to obtain the necessary driver. In other instances where the automatic solution of a problem is not possible, the disposition may provide the user with information regarding how to perform a required maintenance operation, or may provide contact information. For example, information regarding a maintenance operation may include instructions to the user on how to use a software utility, or on how to check a physical data or power connection between the CPU 300 and a peripheral device 308. Contact information may include a website address or a telephone number to allow the user to obtain the necessary information, software, or other fix.

In addition, a disposition may include a combination of automatic and manual fixes to problems. For instance, if a peripheral device 308 on the client computer 108 requires a driver that is not directly available to the server application 224, the communications interface 404 maybe automatically sent to a website address from which the required driver may be available. The user may then obtain the required driver from the website. According to one embodiment of the present invention, a script 424 is then executed by the client application 400 to automatically install the driver obtained by the user.

It will be appreciated that, as used herein, a disposition may include more than one detected problem and suggested solution. For example, if a problem is detected with a printer 368 associated with a client computer 108, the user may be provided with a disposition that offers the following suggested solutions: tightening a loose communication cable, replacing a toner cartridge, and updating the printer driver. Furthermore, if multiple problems are detected on a client computer 108, the disposition returned to that client computer 108 may include a description of all of the detected problems, and a suggested solution or a source of additional information for each of the detected problems.

The operation of a client application 400, in accordance with an embodiment of the present invention is depicted in FIG. 6. The initial state of the client application 400 after it has been downloaded to the client computer or device 108 is one in which it installs itself on the client computer or device 108 (step 600). After the self-install procedure has been completed, the client application 400 proceeds to step 604 in which the identifier assigned by the server application 224 to the client computer 108 is obtained from the communications interface 404. In general, the identifier is downloaded to the communications interface 404, and is placed in the title bar of the communications interface 404. In step 604, the client application 400 reads the identifier from the title bar of the communications interface 404. The identifier is thus provided to the client application 400 from the communications interface 404 over the identifier communication path 418. According to this embodiment, apart from the communication of the identifier to the client application 400, there is no direct communication between the client application 400 and the client communications interface 404. The described method for passing the identifier to the client application 400 is believed to be more reliable than other methods of passing this information, such as using “cookies,” or methods that attempt to pass an identifier directly from the server application 224 to the client application 400. In addition, it is believed to be more reliable than using the network address of the client computer 108 as an identifier available to both the client application 400 and the communications interface 404. In particular, the described method ensures that the client application 400 and the communications interface 404 on a particular client computer or device 108 receive an identical identifier. The correct identifier is necessary in order to ensure that collected information and generated dispositions are associated with the same client computer or device 108, as will be described more fully below. Of course, other methods of transferring an identical identifier to the client application 400 and the communications interface 404 can be employed in accordance with the present invention, so long as they are reliable in operation.

At step 608, the client application 400 polls the server application 224 over a logical line of communication 412. In particular, the client application 400 polls the server application 224 to detect a “run” command in a script status field contained in a record 420 containing user information associated with the client computer or device 108. Upon detecting the value “run” in the script status field, the client application 400 downloads a next script 424 using logical line of communication 416 (step 612). At step 616, the client application 400 sets the script status field to a value “running.” Next, at step 620, the client application 400 runs the downloaded script 424. The results obtained from running the script 424 are then returned to the server application 224 (step 624). The script status field is then set to a value “done” by the client application 400 (step 628). Next, the value of the script status field is set to a value “ready” by the client application 400 (step 632). The client application 400 then returns to step 608 to await detection of a next run command. In general, the next script 424 that is downloaded by the client application 400 is specified in a next script field included in the database record 420 containing user information. The specified script 424 is downloaded upon detection of the next “run” command in the script status field.

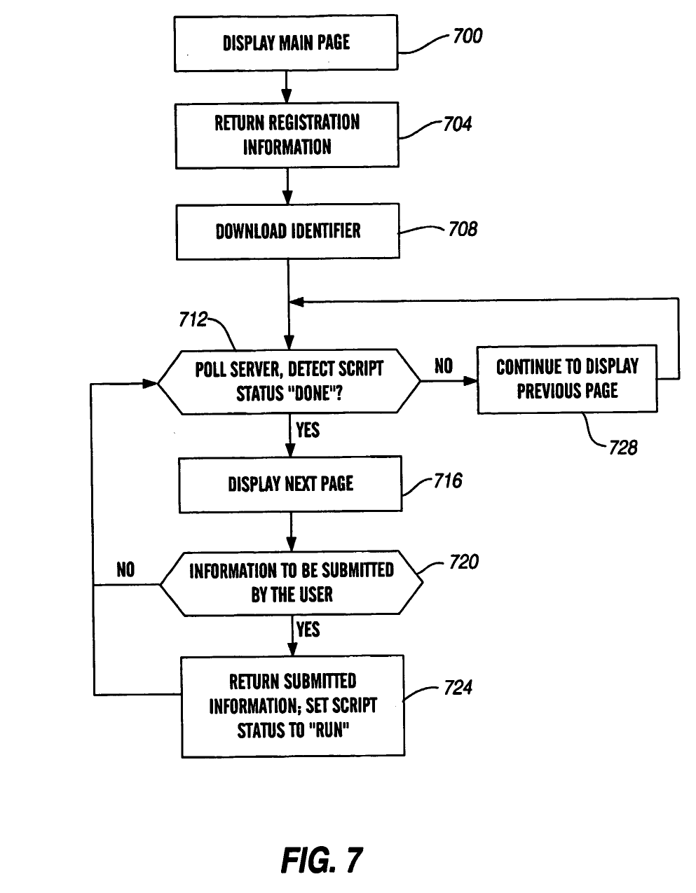

The operation of the communications interface 404 when used in connection with an embodiment of the present invention is depicted generally in FIG. 7. At step 700, the main page is displayed. The main page provides information regarding the diagnostic service, and a form for collecting identifying and billing information concerning the user. After the user has completed the registration form, the registration information is returned to the server application 224 using the first line of communication 408 (step 704). An identifier assigned by the server application 224 may then be downloaded to the communications interface 404 of the client computer 108 (step 708). Alternatively, the identifier may be assigned immediately, and passed to the communications interface 404 with the registration form. It is desirable to provide the identifier to the communications interface 404 early on in the diagnostic process, so that any information collected regarding the client computer 108 and the user can be distinguished from information collected from other client computers 108 and users.

At step 712, the communications interface 404 polls the script status field in the record 420 associated with the client computer 108. Upon detecting a “done” status in the script status field, the communications interface 404 displays the next page (step 716). The next page is indicated in a user section field of the record 420 containing user information. The next page may simply be informative, or may also serve to collect information from the user. Where the next page only provides information, the communications interface 404 returns to step 712 to poll the server to detect a “done” status. Where the next page requires input from the user, the communications interface 404 will proceed to step 720. For example, a displayed page may request authorization from the user before a script 424 is executed. After the information requested from the user has been returned to the server application 224 (step 724), the script status field is set to “run” and the communications interface 404 returns to step 712. As part of returning the client selection to the server application 224, the communications interface 404 may set the script status field to “run”, such as when the communications interface 404 has requested authorization from the user to execute a next script.

While the communications interface 404 waits for a “done” value to be detected, the previous page continues to be displayed (step 728). For example, the communications interface 404 may display the message “working” while the client application 400 is executing a script 424.

The polling procedures carried out by the client application 400 and the communications interface 404 allow the client application 400 and the communications interface 404 to be synchronized with one another. In particular, the client application 400 and the communications interface 404 use a field included as part of one of the records 420 maintained in the database 212 as a common point of contact. In this way, the operation of the client application 400 and the communications interface 404 is coordinated without requiring direct communication between the client application 400 and the communications interface 404.

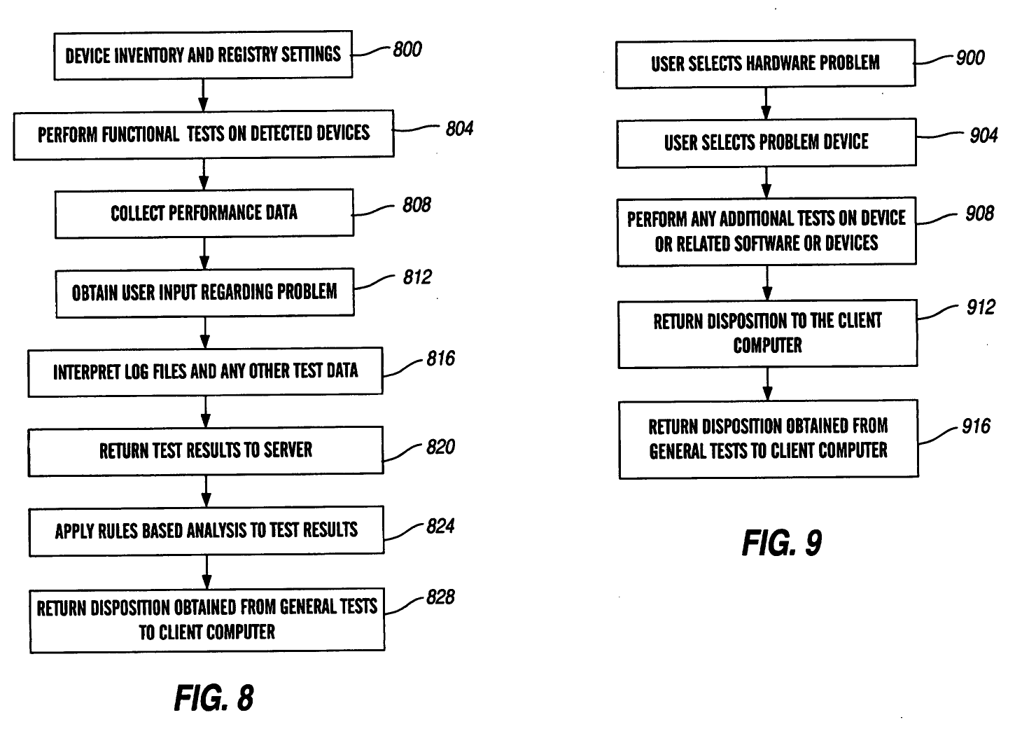

With reference now to FIG. 8, test procedures or commands that may be performed in diagnosing a client computer 108 are illustrated. Initially, an inventory of the client computer 108 devices and registry settings may be taken (step 800). The inventory may be taken by an inventory module diagnostic tool comprising one or more scripts 424. The inventory module may utilize several different methods for obtaining an inventory of the devices installed in the client computer 108 and the client computer's 108 registry settings. For instance, the inventory module may search a registry of installed devices and parse out from current and prior registry entries information concerning those devices. The inventory module may also obtain information from system utilities included as part of the operating system of the client computer 108. Additionally, the inventory module may obtain information from the basic input/output system (BIOS) of the client computer 108. In general, the inventory module may gather information from any file or software setting contained in the client computer 108 pertaining to devices currently or previously installed on the client computer 108. Furthermore, the inventory module may collect information regarding general system resource and performance settings of the client computer 108.

The inventory module may also collect information concerning the client computer 108 from the user. For example, the inventory module may include activating the communications interface 404 to ask the user to enter the name of the last program installed and the last program or file downloaded. The information gathered by the execution of the inventory module may be returned by the client application 400 to the server application 224 for storage in the database 212 as a part of a device inventory record 420 associated with the client computer using the identifier assigned to that client computer 108. Alternatively, the information concerning inventoried items is stored in a plurality of tables or records 420. For instance, a first record 420 may be provided for storing information concerning a hard disk drive, a second record 420 may be provided for storing information regarding a video adaptor, a third record 420 may be provided for storing information regarding a CD ROM drive, etc. In general, records 420 may be provided for each desired division of information concerning devices and settings related to the client computer 108.

At step 804, functional tests of detected devices are performed. These functional tests may be implemented by executing a script 424 comprising a functional test module. The diagnostic tools run as part of the functional tests confirm that devices detected by the inventory module are functioning. For example, the functional test module may address each of the detected devices to request a response from those devices to ascertain whether those devices are in fact installed in the client computer 108. The functional test module may also determine whether devices are operating properly. For example, the user may be instructed to insert media into devices such as floppy disk drives 340, CD ROM drives 344, tape drives 348, and other devices having removable media, and to put paper in the printer 368, etc. The functional test module may then test the ability of such devices to operate properly, such as to perform read and/or write operations, to print, etc.

At step 808, performance or system data is collected. The performance data may include information on resource utilization, such as how much memory 332 is being used and how much space is available on the hard disk drive 340. Performance data may also include the actual speed at which the processor 312 is running. The collection of performance data may be performed by a performance data module comprising one or more scripts 424.

User input regarding the problem or problems to be diagnosed may be obtained at step 812. According to one embodiment of the present invention, the user provides input by selecting from a drop down menu displayed by the communications interface 404. For instance, the user may indicate the type of problem by choosing a menu item labeled “hardware,” “software,” “performance,” or “don't know”. Action taken in response to the selected user input will be described in greater detail below.

Regardless of the type of problem selected, any additional test applications or maintenance procedures that may be indicated are run at step 816. Other test applications may comprise diagnostic tools that include specific utilities that may be downloaded to the client computer 108 when it is determined that such additional utilities or tests may be useful in diagnosing a problem on the client computer 108. The log files created by the tests or maintenance programs are examined, and all or selected portions of the log files may be stored in the database as part of one or more records. Log files may be generated by executing functional tests and/or maintenance programs that may include but are not limited to diagnostic tools such as the “scan disk” and “disk defragmentation” utilities.

Although it is preferred that the describe inventory module, test modules and test applications be used, it should be appreciated that less than all may be used. For example, it may be appropriate to use only one test module during a particular session.

The results obtained from executing the various test modules and test applications are returned to the server at step 820. According to alternative embodiments of the present invention, not all of the test results need be returned to the server as part of one batch of results. For instance, results may be returned to the server application 224 following execution of each complete test module, or following execution of each individual script 424.

At step 824, a rules based analysis is applied to the test results to obtain a disposition. Finally, at step 828, the disposition may be returned from the server application 224 to the client computer 108.

With reference now to FIG. 9, the operation of an embodiment of the present invention in response to a user's indication that the problem to be diagnosed is a hardware problem is illustrated. Initially, at step 900, the user selects the menu item relating to a hardware problem. At step 904, the user selects from a list of devices to further specify the problematic hardware component. According to one embodiment of the present invention, the list of devices comprises the devices detected by the execution of the inventory module. According to a further embodiment of the present invention, the list of devices includes hardware devices in addition to the hardware devices detected by the inventory module, in order to allow the user to indicate a problem with a device that was not detected by the inventory module. According to still another embodiment of the present invention, the user may be allowed to specify a problematic device by entering the name of the problematic device or a description of that device.

After receiving the user information regarding the problematic device, additional tests on the device itself or on related software may be performed (step 908). For example, additional test scripts may be downloaded to the client application 400 and executed. Also, device drivers, software versions, revision levels or hardware revisions associated with the identified device may be analyzed to determine whether patches or updates are available. In some cases, identifiable recall data or other pertinent manufacturer information may be relayed. The results of the additional tests and/or software analysis is returned to the server application 224, and a rules based analysis of those results is performed.

At step 912, the disposition arrived at as a result of the tests and analysis of test results performed at step 908 is returned to the client computer 108. In addition, the disposition obtained from the execution of the general test modules, as described in connection with FIG. 8, is returned to the client computer (step 916).

From the above description of the operation of an embodiment of the present invention, it can be appreciated that allowing a user to specify a hardware problem is advantageous. In particular, it allows a disposition addressing the specified device to be returned to the user, even when the general test modules do not detect such a device. For instance, a disposition returned at step 912 might include a suggestion that the user verify the proper connection of power and data cables to a device identified by a user as problematic, but that was not detected by the general test modules.

As part of the general test performed regarding the client computer 108, general system parameters and conditions may be analyzed. For example, the remaining space in the hard disk drive 336, fragmentation of the hard disk drive 336, the amount of hard disk drive 336 space occupied by discarded files, and the amount of memory 332 being used may be considered. Results regarding such general system parameters and conditions may be analyzed and a disposition returned to the client computer 108. The dispositions returned may include information for the user, a suggestion to perform a maintenance procedure or system setting, or a script 424 may be provided to the client application 400 to automatically perform or run a maintenance procedure or to automatically change a system setting. The disposition may also include a combination of disposition types. For example, the user may be provided with a disposition indicating that the hard disk drive 336 is fragmented, and a script may be provided to the client application 400 to automatically invoke a disk defragmentation utility already resident in the client computer 108.

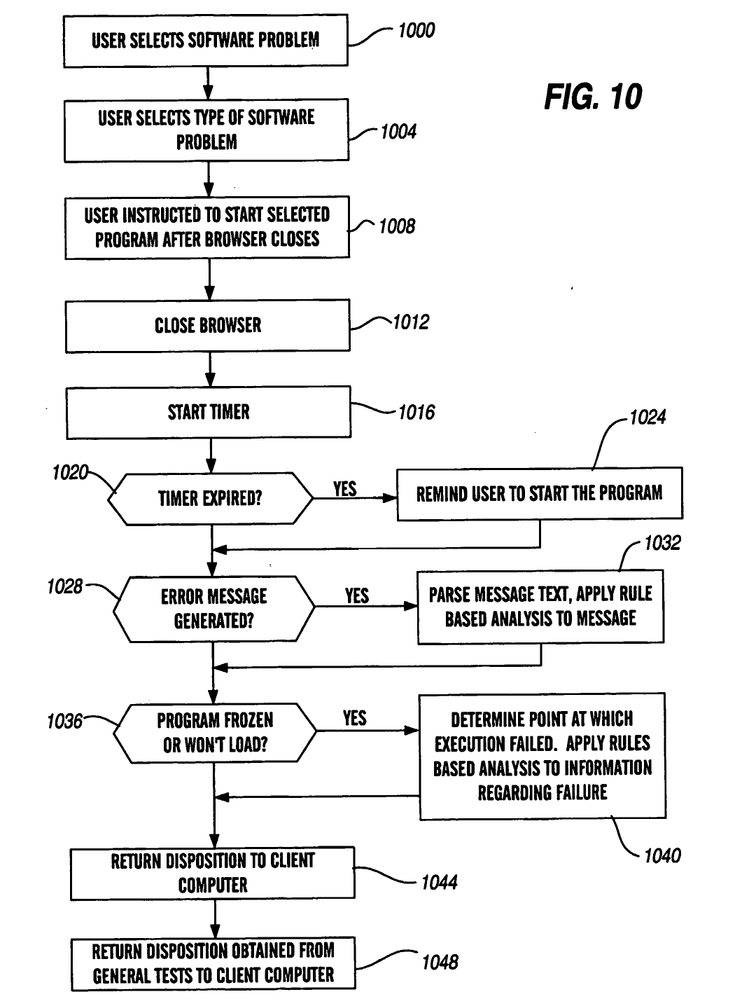

With reference now to FIG. 10, operation of an embodiment of the present invention in response to a user's selection of a software problem (step 1000) is illustrated. At step 1004, the user is asked to select the type of software problem that is being experienced. For example, according to one embodiment of the present invention, the user may select from the following choices:

1. My program gives me an error message before it shows on my screen;

2. My program starts, but when I try to use it, it gives me an error message;

3. My program runs, but it does not act right when I use it;

4. My program looks like it does not start at all; and

5. My program clears my screen to blue and gives me an error message.

Of course, additional or alternative menu choices maybe provided. According to one embodiment of the present invention, additional menu items may be added as the number of problems having associated dispositions in the database increases. In general, after the user has specified the type of software problem, the user is instructed to start the problematic program after the communications interface 404 closes (step 1008). At step 1012, the communications interface 404 is closed, while the client application 400 continues to run on the client computer 108. At step 1016, a timer is started in order to ascertain how much time is required for the client computer 108 to load the problematic program. At step 1020, it is determined whether the timer has expired. If the timer has expired, the user is reminded to start the program if the user has not already attempted to do so (step 1024).

At step 1028, it is determined whether an error message has been generated in connection with the user's attempt to start the problematic program. If an error message has been generated, the text of the message is parsed and returned to the server application 224 for a rules based analysis of that message (step 1032).

At step 1036, it is determined whether the program is frozen or will not load. If the program is frozen or will not load, the point at which execution failed is determined (step 1040). In particular, the executable program, .dll file, or other file causing the software to hang-up or fail to load is determined. The information regarding the point at which execution failed is returned to the server application 224 for rules based analysis.

The disposition obtained as a result of the rules based analysis or analyses conducted as a result of the user's selection of a software problem is then returned to the client computer (step 1044). In addition, the disposition obtained from a rules based analysis of the general test results is also returned to the client computer 1008 (step 1048).

From the above description of the operation of an embodiment of the present invention, it can be appreciated that the present invention is capable of precisely identifying the nature of a software problem. In particular, the present invention can determine whether a problem with software is due to the operating system, a conflict with other programs or shared components or the problematic software itself. This is achieved without requiring the user to do anything more than attempt to load the problematic program. In addition, it does not require a trained technician to analyze the problem. Instead, the results of the various tests are returned to the server application 224 and a rules based analysis of those results is performed by the server 104.

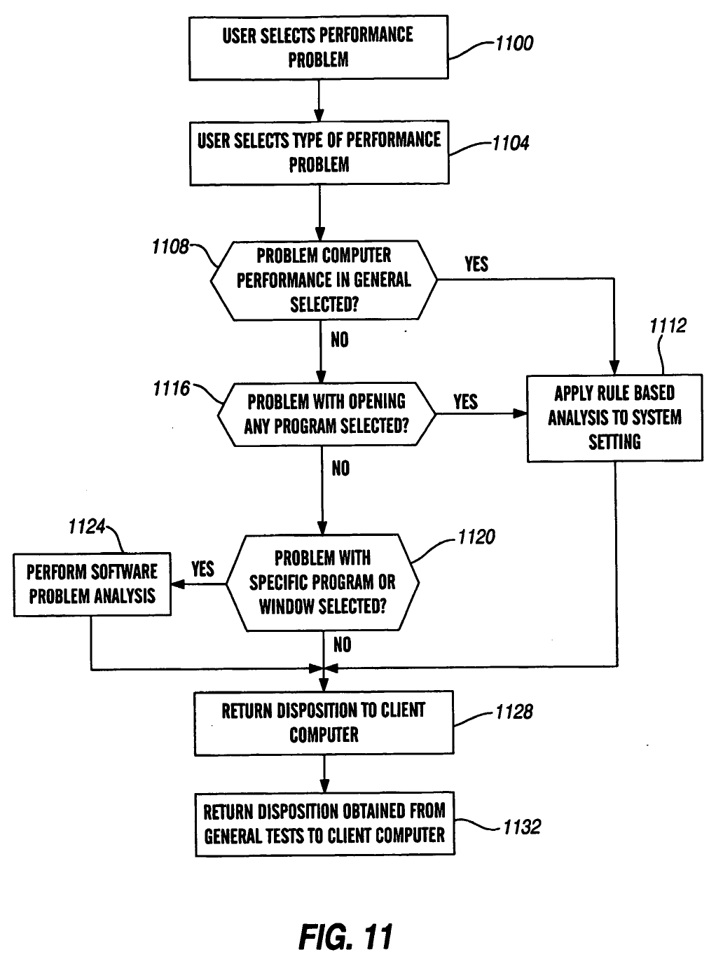

FIG. 11 illustrates the operation of an embodiment of the present invention in response to the selection of a performance problem by the user (step 1100). At step 1104, the user selects the particular type of performance problem that is being experienced. For instance, according to an embodiment of the present invention, the user may select from the following general types of performance problems:

1. My computer's performance in general is slow;

2. My computer has difficulty opening any selected program; and

3. My computer has a problem with a particular program or window.

At step 1108, it is determined whether the user has selected a problem with performance in general. If a general performance problem has been selected, a rules based analysis of the system settings is performed (step 1112). As will be appreciated by those of ordinary skill in the art, system settings may include the speed of the processor 312, the amount of free RAM 332, space allocated to virtual RAM on the hard disk drive 336, etc. In addition, a rules based analysis of the time required to open an application commonly found on client computers 108, the number of files on the hard disk drive 336, and the number of programs always running in the background may be performed.

At step 1116, it is determined whether a user has indicated a problem with the opening or operation of any selected program. If a problem with the opening or operation of any selected program has been selected, a rules based analysis of system settings (step 1112) is performed. In addition, a check for conflicts may be performed.

At step 1120, it is determined whether the user has selected a problem with a specific program or window. If yes, the software problem analysis procedure described above with respect to FIG. 10 is performed (step 1124). As described with respect to FIG. 10, the software problem analysis may include a rules based analysis of information returned to the server application 224 as a result of performing the software problem analysis.

From the description set forth above it can be appreciated that, in general, information concerning the type of problem specified is returned to the server application 224 and a rules based analysis of that information is performed. The analysis may further comprise an adaptive rules based analysis. After application of the rules based analysis of the returned information, regardless of the particular performance problem specified, a disposition is returned to the client computer 108 (step 1128). In addition, at step 1132, the disposition obtained from performance of the general test modules is returned to the client computer 108.

From the description set forth above of an embodiment of the present invention, it can also be appreciated that the specification of a performance problem may result in the performance of tests in addition to those performed during execution of the general test modules. In addition, from the example given above, it is evident that the procedure otherwise carried out in response to the specification of a software problem may also be performed in response to the specification of a performance problem. The above-described configuration of an embodiment of the present invention enables a user who perceives a performance problem on the client computer 108 to obtain a diagnosis of the problem without needing to identify the nature of that problem with particularity. Accordingly, the present invention may allow a user to identify and fix a performance problem even if the user is not an experienced computer user.

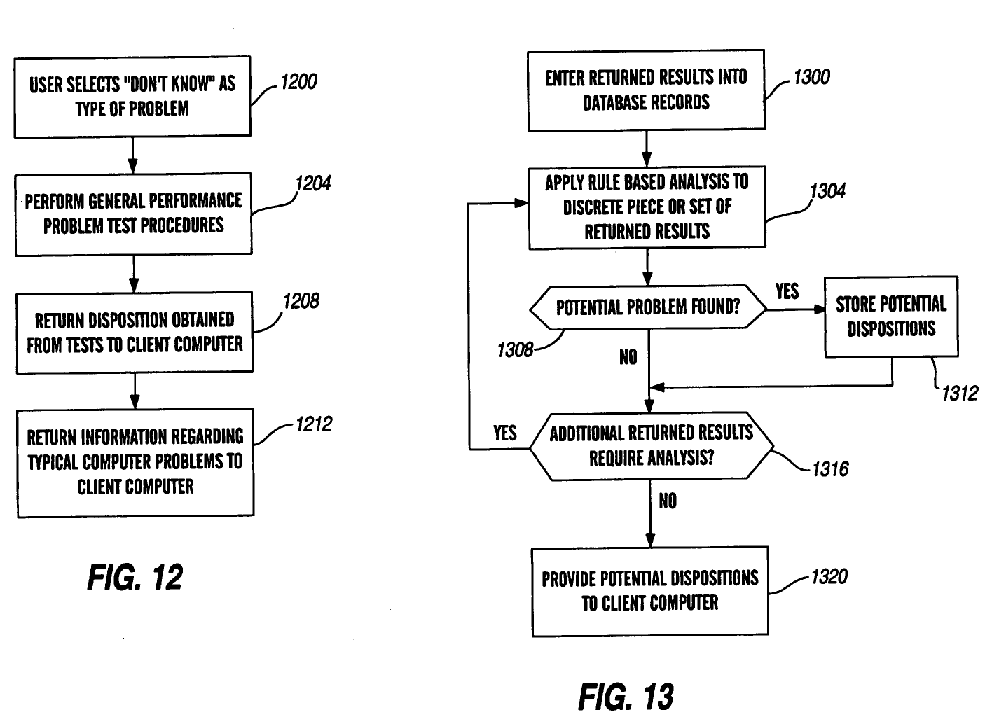

FIG. 12 illustrates the operation of an embodiment of the present invention in response to a selection by the user indicating that the user does not know the nature of the problem (step 1200). In particular, a menu selection to indicate that the user does not know the nature of the problem allows a diagnosis to proceed even if the user is unable to ascertain whether the particular problem involves the hardware, software, or performance of the client computer 108.

In response to the selection of “don't know” as the type of problem in step 1200, according to one embodiment of the present invention, certain of the tests and analyses conducted in response to the selection of a performance problem may be conducted. In particular, the system settings and operating system settings maybe subjected to a rules based analysis (step 1204). In general, any test procedure associated with any specified problem type may be conducted in response to the selection of “don't know” at step 1200. In particular, any test procedure that does not require the user to take any additional action, such as specifying a hardware device or software program causing problems, may be performed.

At step 1208, a disposition obtained from the specific and general tests performed concerning the client computer 108 is returned to the client computer (step 1208). In addition, information may be returned to the client computer 108 regarding common computer problems and how to fix such problems.

From the description of the operation of an embodiment of the present invention in response to an indication by the user that the specific type of problem is not known, it can be appreciated that any test can be performed on the client computer 108, so long as specific information from the user is not required. Of course, according to other embodiments of the present invention, tests that do not require additional input from the user may be performed regardless of the input regarding the particular type of problem selected by the user. The performance of such tests may provide a more accurate diagnosis of the problem or problems on the client computer 108. However, it may be desirable to limit the number of tests that are performed automatically, such as where the user has opted for only a basic diagnostic service, or where it is important to limit the time required to return a diagnosis.

According to another embodiment of the present invention, in response to a selection of “don't know”, no additional tests are performed. Results obtained from test modules that have been executed are then subjected to a rules based analysis. In this way, any test results that indicate or that may indicate a problem with the client computer 108 can be identified. A disposition may be returned to the client computer 108 with respect to each identified problem.

According to still another embodiment of the present invention, in response to the selection of “don't know”, the user may be presented with an additional question or questions, in an attempt to more particularly identify the problem. For instance, the user may be asked under what circumstances problems are encountered. Based on the user's answers, areas of potential problems can be identified. For example, such questions may be successful in narrowing the potential problem to a hardware problem, and test results concerning devices associated with the client computer 108 can be subjected to a rules based analysis.

With reference now to FIG. 13, the operation of an embodiment of the present invention in returning a disposition to the client computer 108 is illustrated. Initially, at step 1300, the results returned to the server application 224 as a result of the performance of tests on and gathering of information from the client computer 108 are entered into records 420. In general, at least one record 420 associated with the client computer 108 from which the results were obtained is created in the database 212. According to an alternative embodiment of the present invention, a plurality of records 420 associated with a particular client computer 108 are created. The creation of multiple records allows the results to be categorized, thereby simplifying the analysis and retrieval of stored information. Multiple records in a single category may be created where, for example, there are multiple devices in that category. For instance, a record 420 in the category of “storage devices” may be provided for a first hard disk drive 336, a floppy drive 340, and a second hard disk drive 336 detected in a single client computer 108. In general, all of the records 420 associated with a particular client computer 108 include a field containing the identifier assigned to that client computer 108, so that the stored information can be associated with the correct client computer 108.

At step 1304, a rules based analysis of the information stored in the database records 420 is performed. According to one embodiment of the present invention, the information is analyzed as discrete pieces or sets. For example, a rules based analysis may first be performed concerning a hard disk drive 336 installed on the client computer 108. More particularly, the rules based analysis may obtain information from a record or records 420 containing only information concerning a hard drive 336, or only information concerning the hard drive 336 may be taken from a record or records 420 containing other information, for analysis. A second rules based analysis may then be performed concerning another detected device or aspect of the client computer 108, such as a CD ROM 344 or printer 368. In general, it can be appreciated that a series of rules based analyses may be performed as required or indicated by the detected devices, software and parameters concerning the client computer 108, or as indicated by the type of problem specified by the user.

As described more fully above, the rules based analysis of information may comprise reviewing the collected information to determine whether an anomaly or potential conflict is present.

At step 1308, it is determined whether a potential problem is indicated as a result of the rules based analysis. If a potential problem is found, any potential dispositions associated with the indicated problem are stored (step 1312). For example, a record 420 may be provided for storing any such potential dispositions. As with other records 420 associated with a particular client computer 108, the record or records 420 may be associated with the client computer 108 to which the disposition pertains by assigning the identifier used to identify the client computer 108 to the record or records 420.

At step 1316, it is determined whether any additional test results or information returned from the client computer 108 require analysis. Accordingly, where the returned results are analyzed as discrete sets of information, the system will cycle through steps 1304, 1308, 1316 and if a problem is found, step 1312, until no results or information requiring analysis remain. The potential disposition or dispositions are returned to the client computer 108 at step 1320.

The disposition returned to the client computer 108 may comprise a suggested action to remedy a detected problem, may provide information regarding a source of further information regarding the detected or potential problem, or may send the user to a site containing relevant information. For instance, a returned disposition may comprise a suggestion that the user execute a particular utility program or perform a physical check of a device. In addition or as an alternative to suggesting a particular procedure, the disposition may provide information, such as an Internet address (e.g., a Universal Resource Locator) or telephone number of a source of further information, such as the manufacturer of a problem device or program. The disposition may also comprise an inventory of installed devices or software, and may include information regarding the status of the devices or software.

The disposition may also include provisions to automatically initiate remedial action. For example, the user may be asked to authorize the performance of the suggested maintenance procedure. Upon receiving the requested authorization, a script 424 may be provided to the client application 400 for execution. The script 424 may itself comprise a utility application, or may comprise the programming code necessary to initiate operation of a utility program stored on the client computer 108. In either event, the procedure may be performed without requiring the user to do anything more than authorize execution of the procedure. It should be noted that scripts 424 run during the diagnostic procedure prior to the return of a disposition to the client computer 108 may have remedied the problem or problems that caused the user to seek a diagnosis and solution. For instance, according to one embodiment of the present invention, disk maintenance utilities provided as part of a script or scripts 424 may automatically be run during diagnosis of the client computer 108. These utilities may be effective in remedying the problem with the client computer 108, without requiring further repair. In such instances, the disposition returned to the client computer 108 may comprise notice to the user that a problem with a component (e.g. the hard disk drive 336) was detected, but was fixed when a provided disk maintenance utility was executed (e.g., SCAN DISK). The utilities may be generally available programs, such as SCAN DISK, or they may be specifically developed for use in connection with the present invention.

If a problem with a particular piece of software is detected, the disposition may include the provision of a software patch, missing component, or replacement of the software to remedy the problem. Accordingly, the disposition may be provided with a request that the user authorize replacement of the faulty software. In response to receiving such authorization, the software patch or replacement may be downloaded to the client computer 108 for installation. The software patch or replacement may be automatically installed by the client application 400. If the required software patch or replacement is not available from the server 104, the communications interface 404 may be directed to a website where the required software is available. The user may then download the required software to the client computer 108. According to one embodiment of the present invention, the downloaded software may be automatically installed by the client application 404.

It should be appreciated that multiple dispositions may be returned to the client computer 108. For example, a suggestion to perform a maintenance procedure to improve the performance of a hard disk drive 336 installed on the client computer 108 as a first disposition may be accompanied by a suggestion to replace a device driver for that disk drive 336. In addition, dispositions may concern more than one device or piece of software associated with a client computer 108.

The operation of an embodiment of the present invention will now be illustrated in the context of an example. Initially, the user contacts the server 104 over the computer network 112 using the communications interface 404 of the client computer 108, such as an Internet browser (step 500). The user is presented with a browser page describing the diagnostic service. If the user decides to continue, a registration form is presented to the user by the communications interface 404. The registration form or page allows the user to submit general and billing information. For example, the user is asked to enter his name, address, and billing information such as a credit card number and card expiration date. The user may choose to submit the registration form after entries have been made in all of the required fields of that form. The information submitted is stored in a record 420 containing user information.

The record 420 containing user information includes a field for storing an identifier that is unique to the particular client computer 108 that will be diagnosed. The identifier is assigned by the server application 224 when the user submits information from the registration form. In general, all communications and records 420 with respect to a particular client computer 108 are identified by the same identifier. In this way, information passed between the server 104 and the client computer 108, or stored in the database 212, can be properly associated with the correct client computer 108.

Following registration, the communications interface 404 displays a next page to the user. The signal to display a next page is communicated to the communications interface 404 by setting a script status field included in the record 420 containing user information to a value “done” upon completion of the collection and/or verification of registration information. The identity or address of the next page to display is contained in a next page field included in the record 420 containing user information. In general, the communications interface 404 may detect a change to the script status field by polling the server application 224 (step 712). The next page displayed (step 716) is, according to the present example, a page informing the user that components of the client executable package 220 will next be downloaded and installed on the client computer 108, and request authorization from the user to commence with the download and installation. Upon receiving the required authorization, here signaled by having the user click on a button displayed by the communications interface 404, the client application 400 is downloaded to and installed on the client computer 108 (step 504).

After it has been downloaded, the client application 400 self installs itself on the client computer 108 (step 600). In order to ensure that information returned to the server application 224 is associated with the relevant client computer 104, the client application 400 must be provided with the identifier that has been assigned to the client computer 108. According to the present example, the identifier is provided to the communications interface 404, and displayed in the title bar of the communications interface 404 window. Thus, upon completing installation, the client application 400 reads the identifier from the title bar of the communications interface 404. In this way, the identifier is reliably communicated to the client application 400. According to the embodiment of the present example, the reading of the identifier from the title bar of the communications interface 404 is the only direct communication between the client application 400 and the communications interface 404.

The client application 400 then polls the server application 224. In particular, the server application 400 polls the server application 224 to detect a “run” value in the script status field of the record 420 containing user information. Because the client application 400 has been provided with the identifier for the client computer 108 on which it is installed, the client application 400 monitors only the record 420 having user information concerning the relevant client computer 108 (step 608). Upon detection of the “run” command, the client application 400 downloads an application script 424 (step 612). After the download of the script 424 is complete, the client application 400 sets the script status field in the record 420 containing user information to “running” (step 616) and executes that script (step 620).

According to the present example, the first script 424 conducts an inventory of devices installed on the client computer 108 and the registry settings in the client computer 108. In general, the information regarding installed devices and registry settings may be collected by queries made to the operating system of the client computer 108, such as by querying standard system settings and device information, and by extracting information from files concerning installed devices and registry information using programming designed to parse such information from such files. Additional information may be obtained by querying the system basic input/output system (BIOS). Execution of the device inventory and registry setting module may comprise the execution of one or a plurality of scripts 424.

Following the execution of the device inventory and registry settings test module, the results obtained are returned to the server application 224. The server application 224 stores the returned information in database records 420. According to the present example, a separate database record 420 is provided for storing information related to various devices, manufacturers, and system settings. For example, a separate database record 420 may be provided for each of the following categories of information: monitor information; port information; printer information; storage device information; system information; video adaptor information; performance information; software information; and audio information.

Multiple records 420 of a particular type may be provided in connection with a particular client computer 108. For instance, a client computer 108 having three active communication ports will have three records 320 for containing port information.

Following execution and the return of information to the server application 224, the client application 400 sets the script status field in the record 420 containing user information to “done” (step 628). The communications interface 404 detects the change of the script status field to “done” because it has been polling that field (step 712) while the client application 400 has been executing the script 424. The communications interface 404 then displays a next page (step 716) to the user. According to the present invention, a plurality of scripts 424 comprise the device inventory and registry settings test module. Accordingly, the server application 224 may change the script status field to “run” immediately after the client 400 has indicated that it is ready to execute a next script 424 by changing the script status field to “ready” (step 632). Thus, the process of downloading a script 424 and executing that script 424 continues until all of the scripts 424 needed to be run in connection with the device inventory and registry settings module have been executed.

Next, functional tests are performed on the detected devices. According to the present example, the client computer 108 includes a hard disk drive 336. Accordingly, one of the functional tests that will be performed includes a hard disk drive diagnostic program. In addition, the client computer 108 according to the present example includes a floppy disk drive 340. Accordingly, one of the functional tests that will be carried out on this client computer 108 includes a test of the operation of the floppy disk drive 340. Because a more complete test can be performed on storage devices having removable media, such as floppy disk drives 340, if the media is installed, the user is asked to insert media into all installed drives at step 716. After the user has done so, the user signals this to the server application 224 by clicking a button displayed by the communications interface 404 to indicate that functional testing may commence (step 720). The user's indication is returned to the server application 224 (step 724), at which point the script status field is changed to “run.”

As described above, the client application 400 detects the “run” value in the script status field, downloads the next script 424 (step 612), sets the script status field to “running” (step 616), runs the script (step 620), returns results from the execution of the script to the server application 424 (step 624), sets the script status field to “done” (step 628), and then changes the script status field to “ready” (step 632). The information collected by execution of the scripts that comprise the functional test module is, according to the present example, returned to the server application 224 after the execution of each script 424. The information is stored in the records 420 created for the previously detected devices and registry settings. Accordingly, the information returned to the server 104 as the result of the execution of the functional test module may be stored as entries in records 420 that have previously been created.

According to the present example, performance data is next collected. The execution of the scripts 424 comprising the performance data test module, and the return of information thus collected to the server 104 proceeds essentially as described above with respect to the execution of the device inventory and registry settings module and the functional test module. As before, the performance data information may be stored in one or more records 420 that were created earlier for storing information concerning the client computer 108.

An inventory is displayed of all devices and settings as well as software executables (.exe). The user is next asked to provide information regarding what the user perceives to be the problem requiring diagnosis (step 812). For example, the user may be asked which program last loaded, last Internet download, etc. According to the present example, the user indicates that the client computer 108 has a hardware problem (step 900). The user is then presented with a list of devices detected in the client computer 108 (step 904). The user is also presented with a list of devices typically found in a client computer 108. For purposes of the present example, we will assume that the user indicates that the CD ROM drive 344 is problematic. We will further assume that the CD ROM drive 344 was not detected by the device inventory and registry settings test module. Because the CD ROM 344 was not detected, no additional tests are performed relating to such a device (step 816 and 908).

Next, any information concerning the client computer 108 remaining to be returned to the server 104 is provided to the server application 224 (steps 820 and 912).

The server application 224 then applies a rules based analysis to the information stored in the records 420 concerning the client computer 108. For purposes of the present example, we will assume that no problems regarding devices detected as being installed or detected registry settings are considered to be problematic. However, the user's indication of a problem with a CD ROM drive 344 does require diagnosis. According to the present example, no CD ROM 344 was detected as installed on the client computer 108. This suggests that the CD ROM 344 is not properly connected to the client computer. Therefore, the disposition returned to the client computer 108 (steps 828, 912, and 916) may suggest that the user ensure that the signal and power cables between the client computer 108 and the CD ROM 344 are intact and properly connected.

From the above example, it can be appreciated that the user was provided with a diagnosis of the problem on the client computer 108, without requiring the assistance of a human technician. Furthermore, although in the present example the user provided information concerning the perceived problem, the user was not required to describe the problem with any particularity. In addition, the fully automated test procedure, in combination with the user input, provides a more narrowly focused disposition than might otherwise be available. For instance, without the automatic device inventory and review of system settings, suggested remedial measures would necessarily be broader. For instance, a system that did not prepare an automatic inventory might instruct the user to update the driver for the CD ROM 344, or ask the manufacturer of the drive for assistance. However, the present invention, as illustrated in the foregoing example, is capable of providing a narrowly focused suggestion for remedying the problem. Accordingly, the present invention is capable of streamlining the process of diagnosing and remedying problems on a client computer 108.

The operation of the present invention will now be described in the context of a second example. According to this second example, the operation of the present invention proceeds as described above in the previous example. However, according to this example, the user selects a performance problem (steps 812 and 1100). Next, the user selects the particular type of performance problem being experienced (step 1104). According to the present example, the user indicates that there is a problem with a particular program (step 1120).

Because the user has indicated a problem with a particular program, a software performance analysis is begun (step 1128). In particular, the user is instructed to attempt to start the problematic program after the communications interface 404 has closed (step 1008). Next, the communications interface 404 automatically closes (step 1012) and a timer is started (step 1016).

The user then clicks on the problematic program or otherwise attempts to load it. According to the present example, we will assume that the program freezes while it is loading (step 1036). At step 1040, it is determined at which point loading of the program failed. In the present example, it is determined that the program freezes when a particular file is being loaded. Information concerning this file is returned to the server application 224 and a rules based analysis is performed (step 824).

The disposition returned to the client computer 108 (step 828 and 1044) may inform the user of the name of the file or component being loaded when the program freezes, and may request authorization from the user to replace that file or component. The application server 224 may then retrieve a copy of the affected file, for example, from a website operated by the software producer. The system 100 may then automatically install the patch or replacement file in the client computer 108.

As illustrated by this second example, the present invention is capable of precisely determining the problem being experienced by a user in connection with a particular piece of software. Furthermore, the present invention is capable of providing the user information regarding the problem, and of remedying the problem. It is further apparent that the present invention is capable of diagnosing a problem even where the user is unable to describe the problem with specificity.

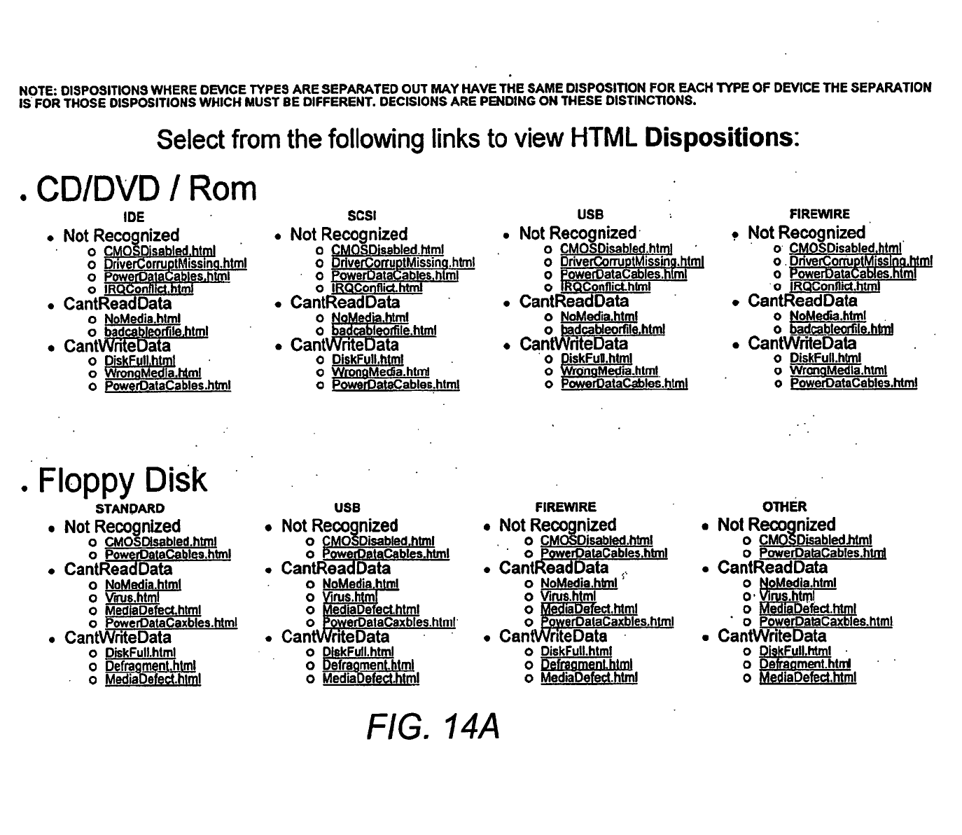

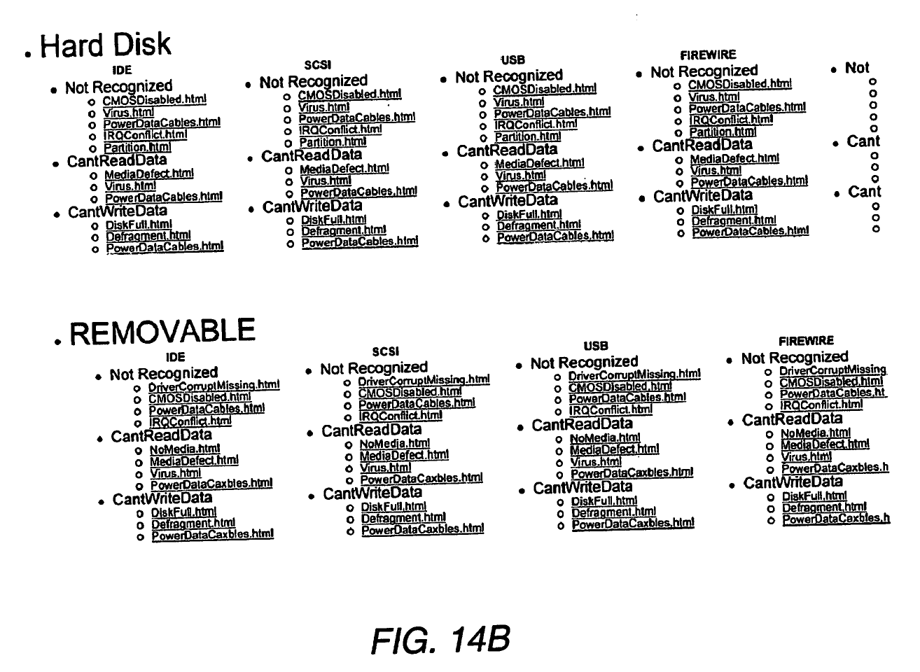

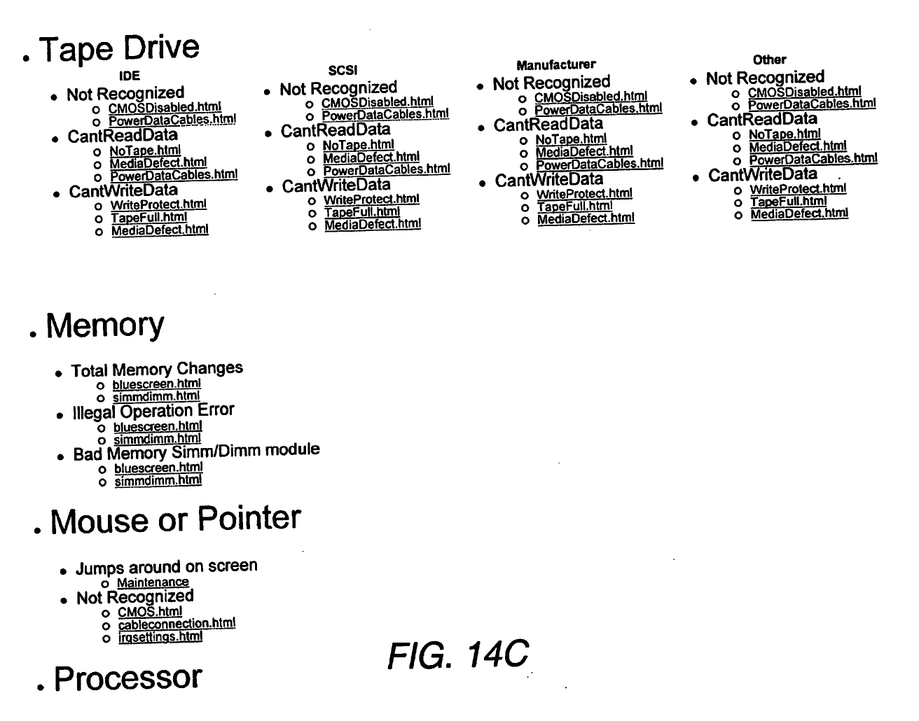

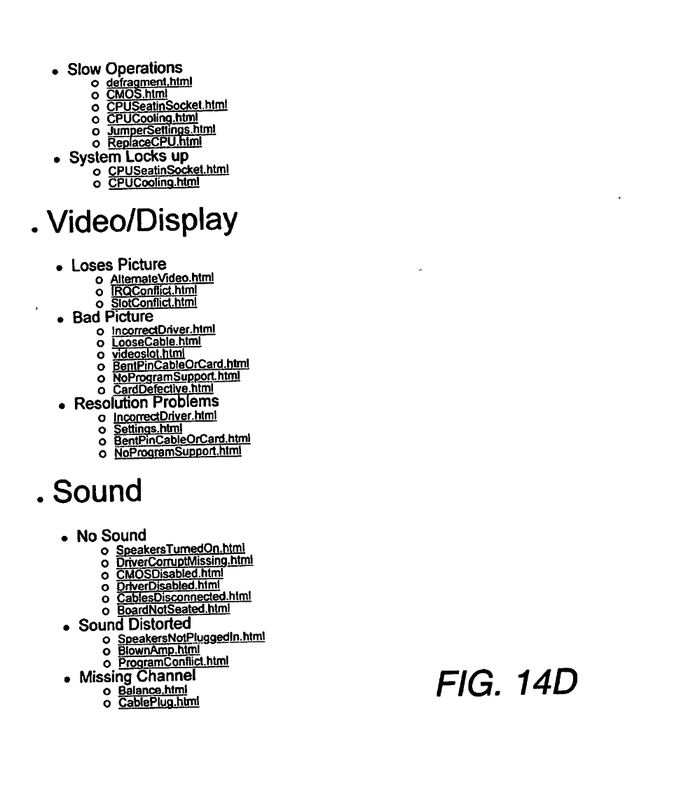

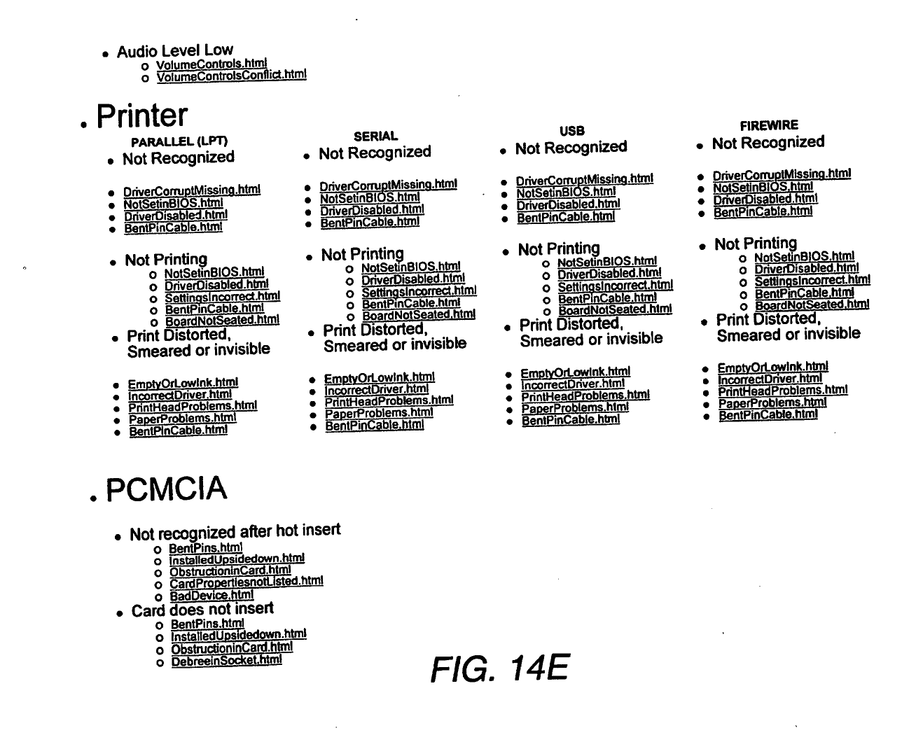

In connection with a particular problem device or software application, the disposition returned to the client computer 108 may include self-help tutorials for consideration by the user. A listing of devices and software applications that may have associated self-help tutorials available in accordance with an embodiment of the present invention is shown in FIG. 14. As shown in FIG. 14, different entries may be provided for different device types. For example, a first set of self-help tutorials may be provided for IDE CD-ROM drives, a second set for SCSI CD-ROM drives, a third set for USB CD-ROM drives, and fourth set for FireWire CD-ROM drives. Of course, a greater or lesser variety of devices and software applications may be associated with available self-help tutorials.

According to one embodiment of the present invention, potential dispositions are considered sequentially to determine whether they are relevant. For example, for each potential problem device or software application that is or may be associated with a client computer 108, a determination is made as to whether a problem has been indicated. A problem may be indicated either by the detection of anomalous test results obtained in connection with the client computer 108, or by the user. As an example of anomalous test results indicating a problem, a CD-ROM drive may be found to be incapable of reading data. As an example of a user indicated problem, the user may indicate manually that a floppy drive 340 is inoperative. A determination is then made as to whether a sub-problem associated with the problem device or software application has been indicated. For each indicated subproblem, a disposition containing a self-help tutorial may be returned to the client computer 108 for consideration by the user. If no problem is indicated with respect to a particular device or software application, the next device or software application is considered. For example, if no problem with a floppy drive 340 is indicated, no self-help tutorial regarding such a device is returned to the user. The server 104 then continues to determine whether problems have been indicated with a next device or software application. For example, with reference to FIG. 14, after a determination is made as to whether self-help tutorials regarding a hard disk drive should be provided, whether problems with a hard disk drive 336 have been indicated is considered.

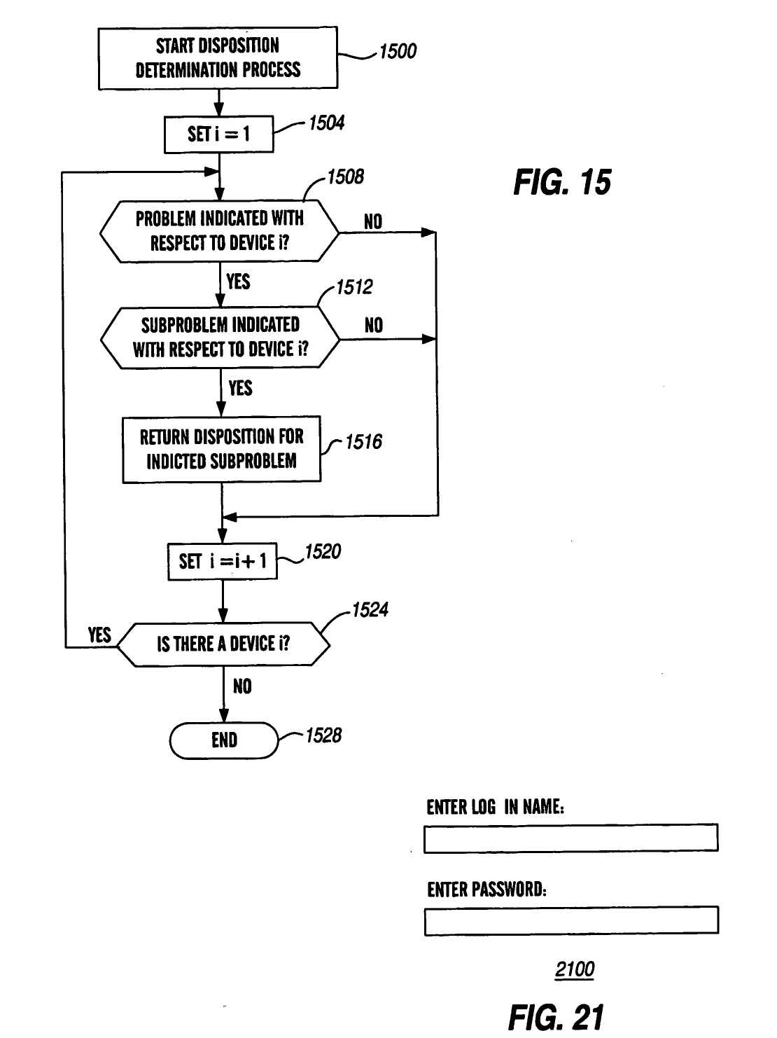

With reference now to FIG. 15, a flow chart depicting a process of considering potential dispositions in accordance with an embodiment of the present invention is illustrated. At step 1500, the disposition determination process starts. A counter i is set equal to 1 at step 1504. In general, a unique value i may be sequentially assigned to each device or software application heading included in the possible dispositions associated with the invention. At step 1508, a determination is made as to whether a problem has been indicated with respect to device i. If a problem is indicated with device i, the system proceeds to determine whether a subproblem is indicated with respect to device i (step 1512). If a problem is indicated, the disposition for the indicated subproblem is returned to the user (step 1516). Next, at step 1520, i is set equal to i+1. The value i is also set equal to i+1 (step 1520) if at step 1508 no problem has been indicated, or if at step 1512 no subproblem has been indicated. At step 1524, a determination is made as to whether there is a device corresponding to the value for i. If there is an i^{th} device then the system returns to step 1508. If there is no such device (i.e. all devices having associated dispositions have been considered), the procedure ends (step 1528).

From the above description, it can be appreciated that the system proceeds to consider whether a problem is indicated with each hardware device or software application, and returns a disposition addressing any indicated problems and subproblems. As noted above, each such disposition may include self-help tutorials. In addition or alternatively, each such disposition may include automated fixes and/or referrals to other sources of information.

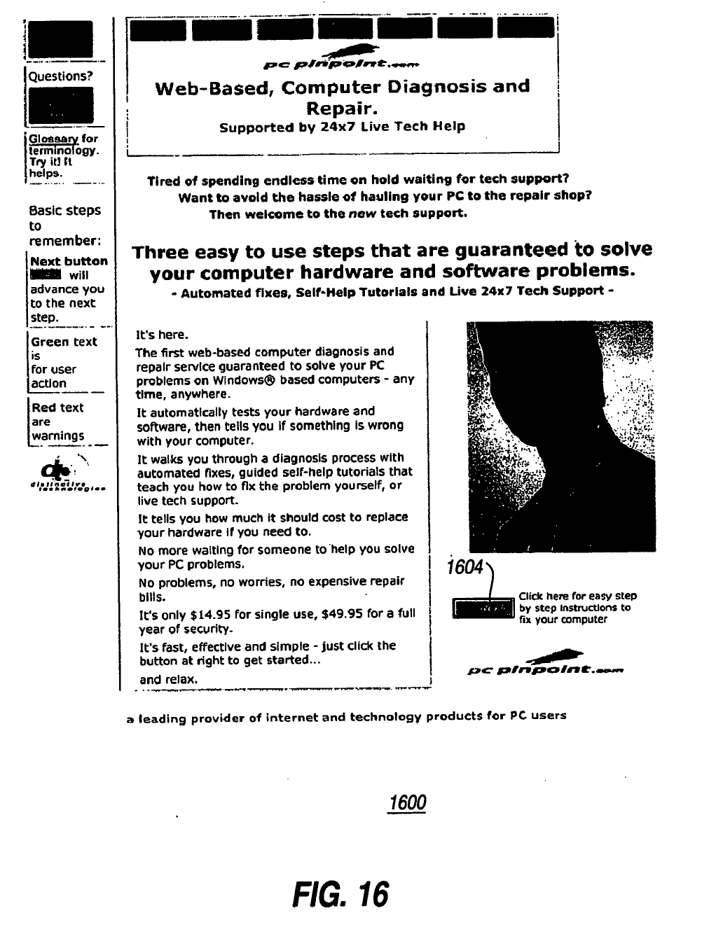

An example of the steps taken and information received by a user of a client computer 108 in connection with diagnosing the client computer 108 in accordance with an embodiment of the present invention will now be given. Initially, the user directs a communications interface (e.g., an internet browser) 404 associated with the client computer 108 to a diagnosing resource (e.g., a web site) associated with the server 104 over a computer network (e.g., the Internet) 112. The user is then presented with a welcome screen 1600 describing the diagnostic service (see FIG. 16). From the welcome screen 1600, the user may choose to proceed with obtaining a diagnosis by selecting a next button 1604.

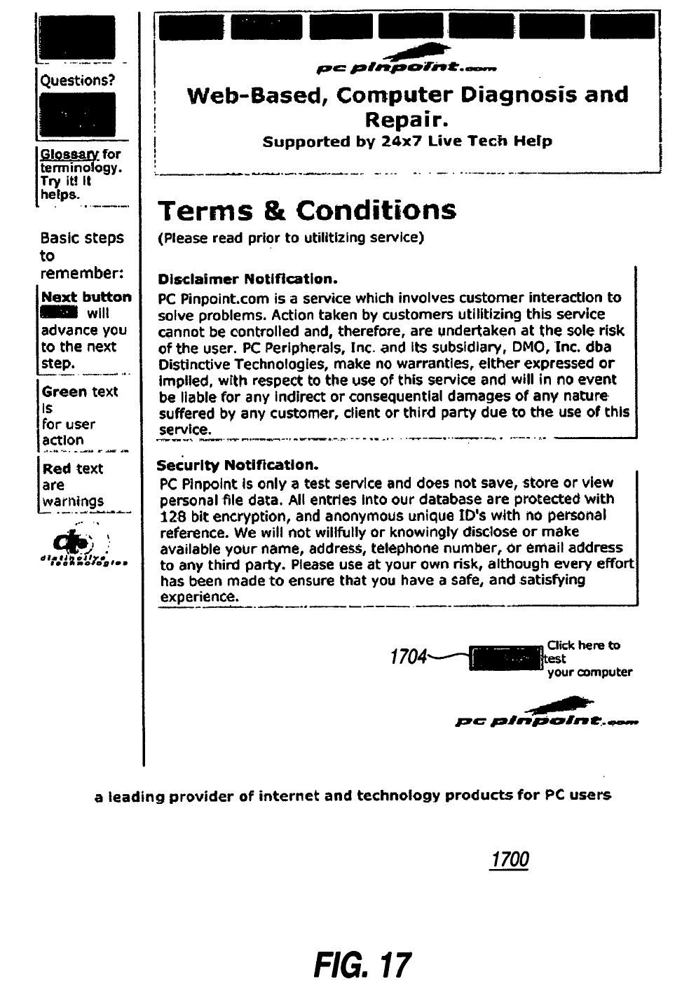

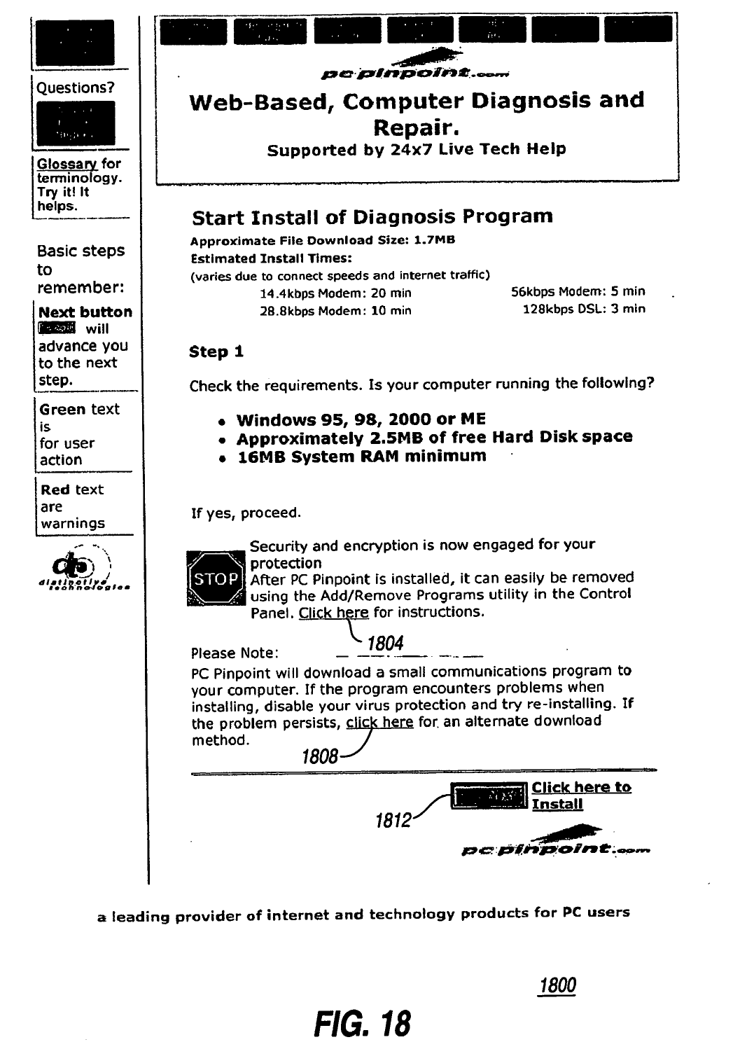

After a user selects the next button 1604, the user is presented with a disclaimer and a security notification page 1700 (see FIG. 17). If the user agrees to the terms of the service, a next button 1704 may be selected, and the user is then presented with a minimum systems requirement page 1800 (see FIG. 18). The minimum systems requirements page 1800 may provide hypertext links 1804, 1808 that the user may select for additional instructions and alternative download methods. A next button 1812 is provided to allow the user to choose to continue with installation of the client application 400.

Upon selection of the next button 1812, and before the client application 400 is downloaded to the client computer 108, the user may be presented with an authenticity certificate. The authenticity certificate may include verification of the identity of the software publisher by a third party provider, such as VeriSign Commercial Software Publishers CA™. If the user wishes to continue with the download and installation of the client application 400, the user may select a next button provided in connection with the authenticity certificate. Upon selecting the next button, the progress of the installation process is presented to the user by a window in both bar graph and percentage forms.

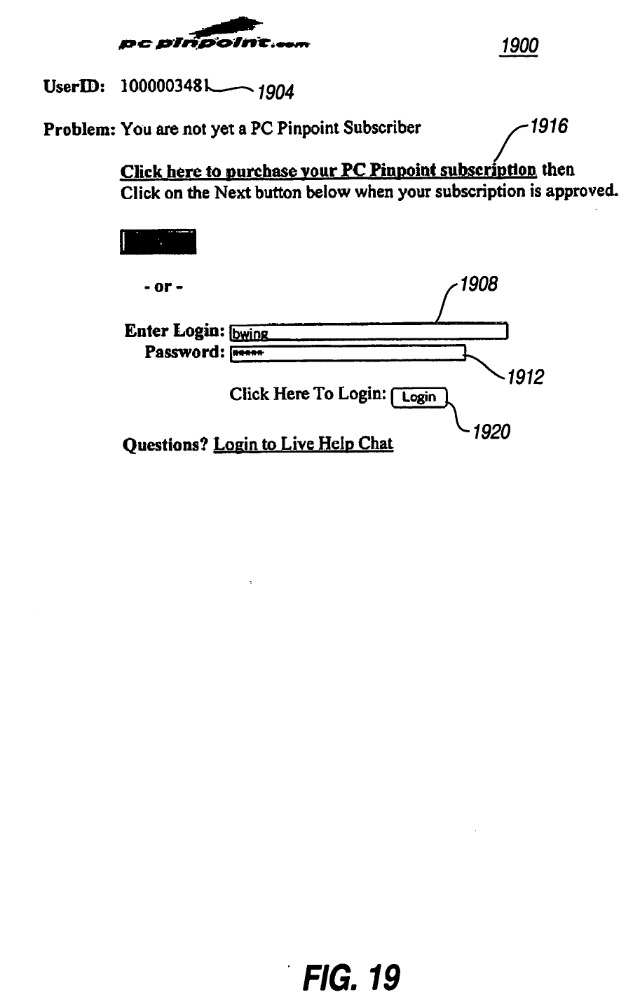

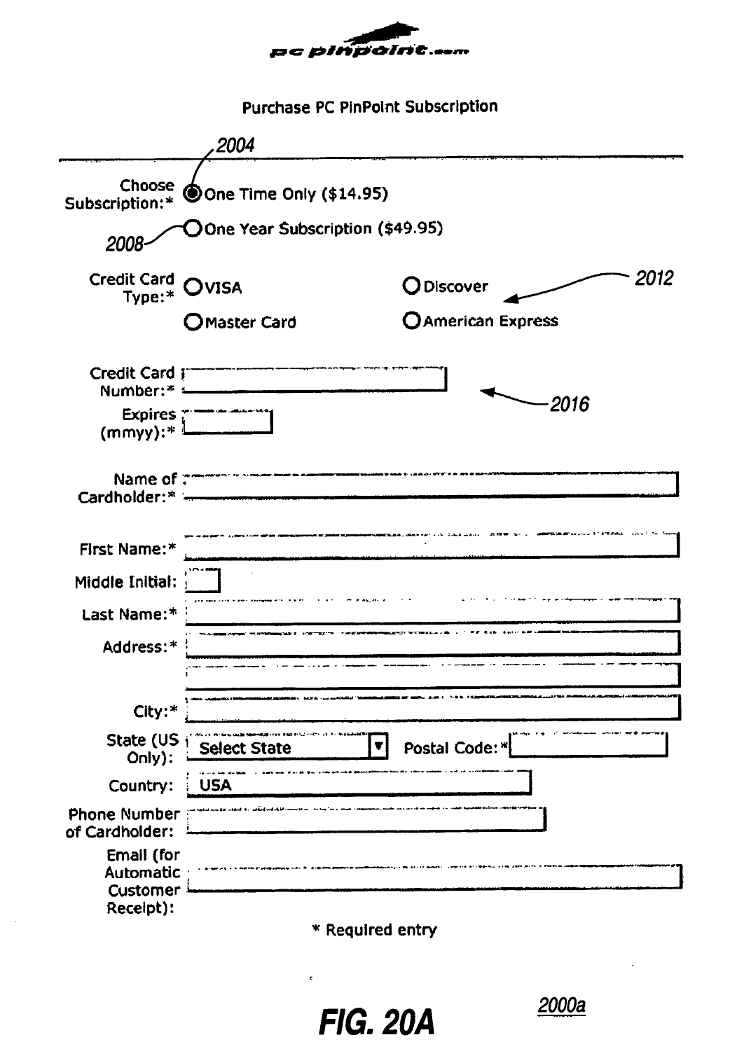

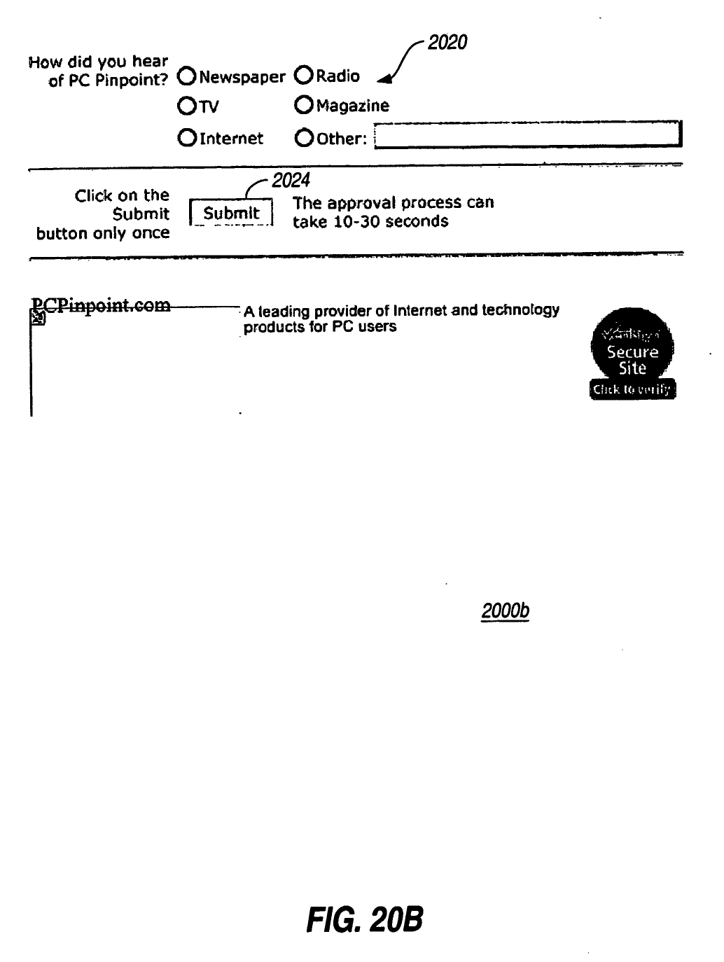

After the client application 400 has been downloaded and installed, the user is presented with a log-in page 1900 that includes a window 1904 showing the user ID (i.e. the identifier) that has been assigned to the client computer 108 (see FIG. 19). The user ID is unique to the client computer 108, and is maintained for that client computer 108 such that the same user ID is assigned to a client computer 108 each time the diagnostic service is utilized by that client computer 108. The screen may further provide a log-in name window 1908, and a password window 1912. If the user does not yet have an assigned log-in name and password, a button or hypertext link 1916 is provided to allow the user to purchase a subscription for the service. Upon clicking on the link 1916, the user is presented with a subscription purchase page 2000 (see FIGS. 20A and 20B).

The subscription purchase page 2000 may be generated in connection with the communications interface 404. Therefore, it can be appreciated that the communications interface 404 remains in communication with the server 104, and that the communications interface 404 may be used for communicating general information between the server 104 and the client computer 108, even when the client application 400 is in communication with the server 104. The subscription purchase page 2000 allows the user to choose from a variety of subscription levels, such as a one-time diagnosis 2004, or a one-year subscription 2008, by selecting the appropriate button. The user may also be presented with various payment options 2012, together with windows 2016 for entering information required for the selected payment options. In addition, buttons 2020 may be provided for collecting additional information from the user. A submit button 2024 is provided to allow the user to submit the entered information for approval.

Following approval, the user is allowed to select a log-in name and password from a log-in name and password selection page 2100 (see FIG. 21). The user may then select a continue button 2104 to return to the log-in page 1900 (see FIG. 19). The user may then select the log-in button 1920 to proceed with obtaining a diagnosis of the client computer 108. It should be noted that the particular client computer 108 in contact with the server 104 is diagnosed during a typical session. Furthermore, a unique user I.D. is assigned to each client computer 108 that has initiated diagnosis procedures. However, a single log-in name and password may be used in connection with the diagnosis of different client computers 108. Accordingly, a company or household may use a single log-in name and password to diagnose all of its client computers 108.

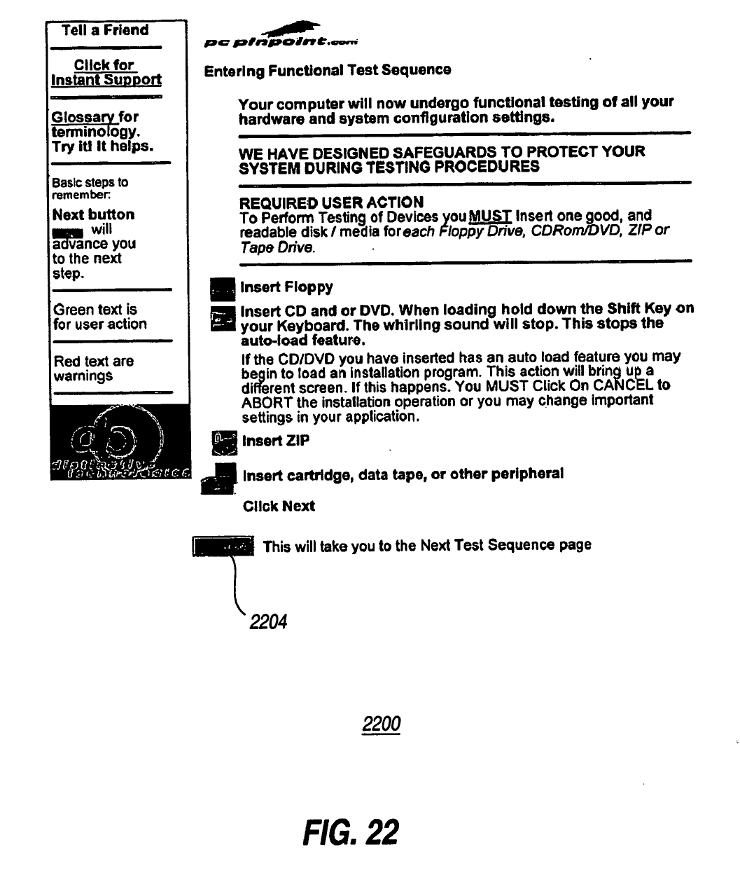

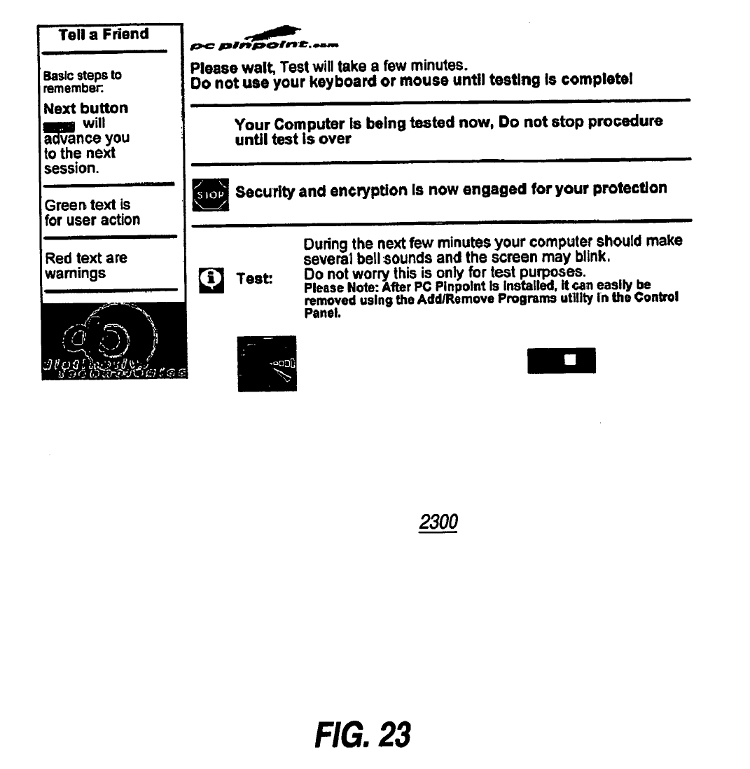

After selection of the log-in button 1920, the user is presented with a functional test sequence welcome page 2200 (see FIG. 22) which provides the user with information regarding steps that should be taken to ensure an accurate diagnosis of the client computer 108. For instance, the user may be instructed to insert media into all storage devices having removable media. For example, the user may be instructed to insert a disk into the floppy drive 340, a zip cartridge into a zip drive 350, or a cartridge or a tape into another storage device 348 or 350 having removable media. By selecting a next button 2204, the user is presented with a test in progress page 2300 (see FIG. 23).

The test in progress page 2300 informs the user that the client computer 108 is being tested, and warns the user not to stop the procedure until the testing has been completed. The user may also be provided with information concerning what to expect while testing is being conducted. For example, the user may be informed that the client computer 108 can be expected to make various sounds and that the screen of the monitor 352 may blink.

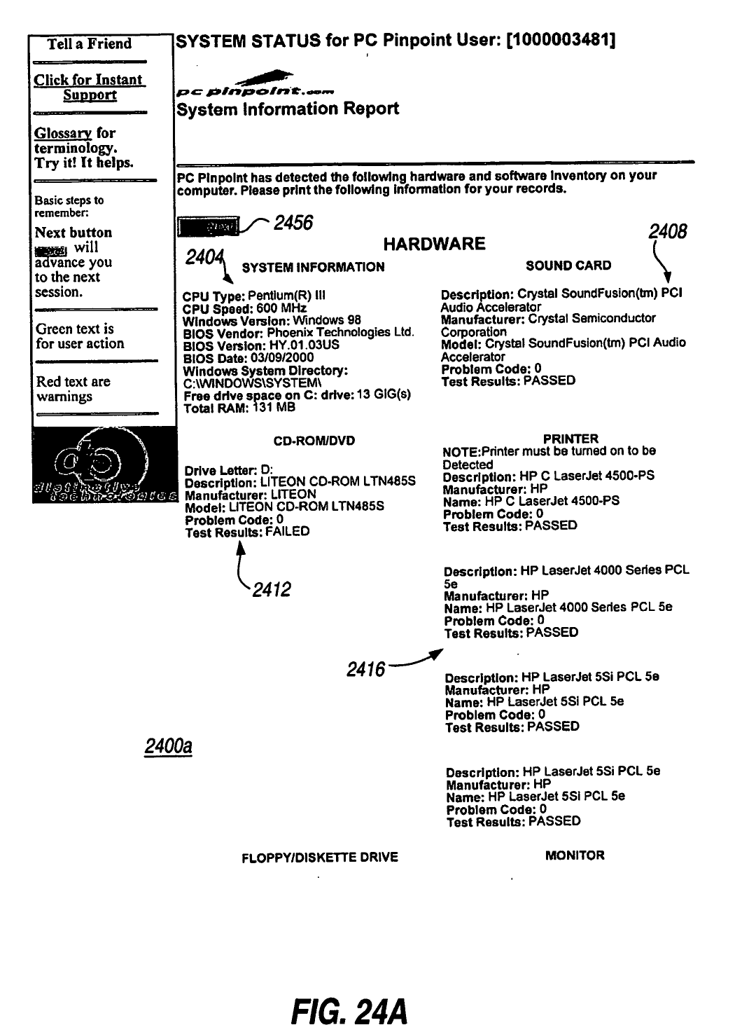

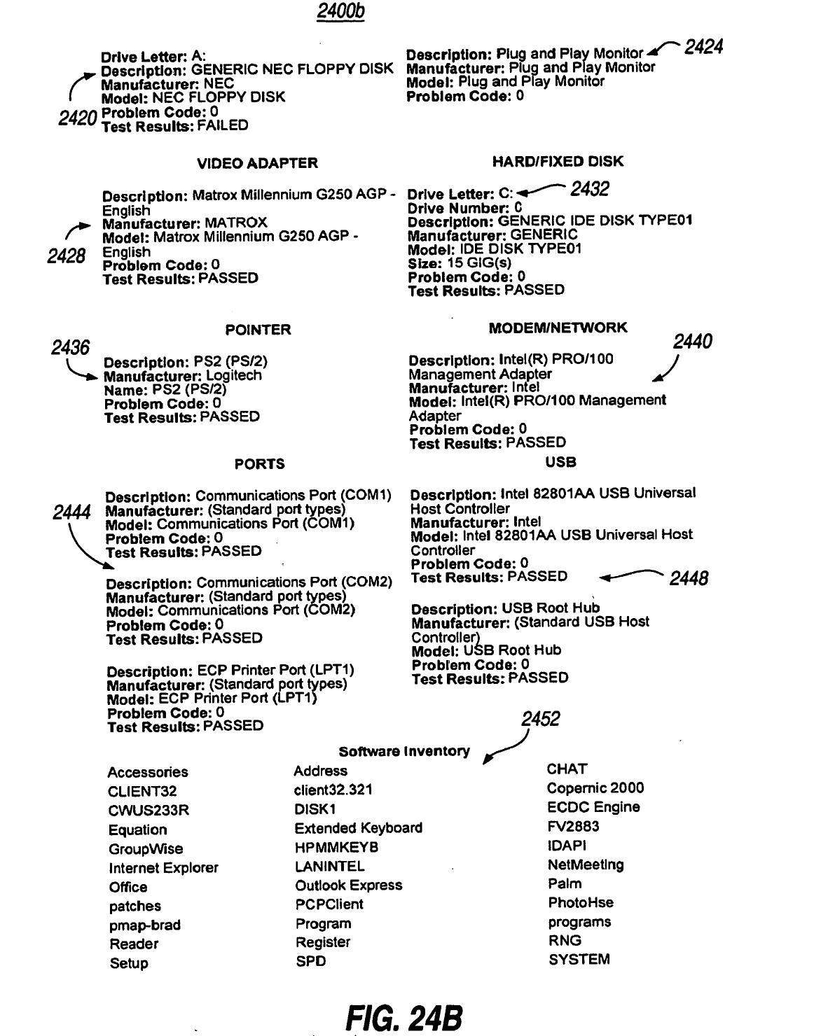

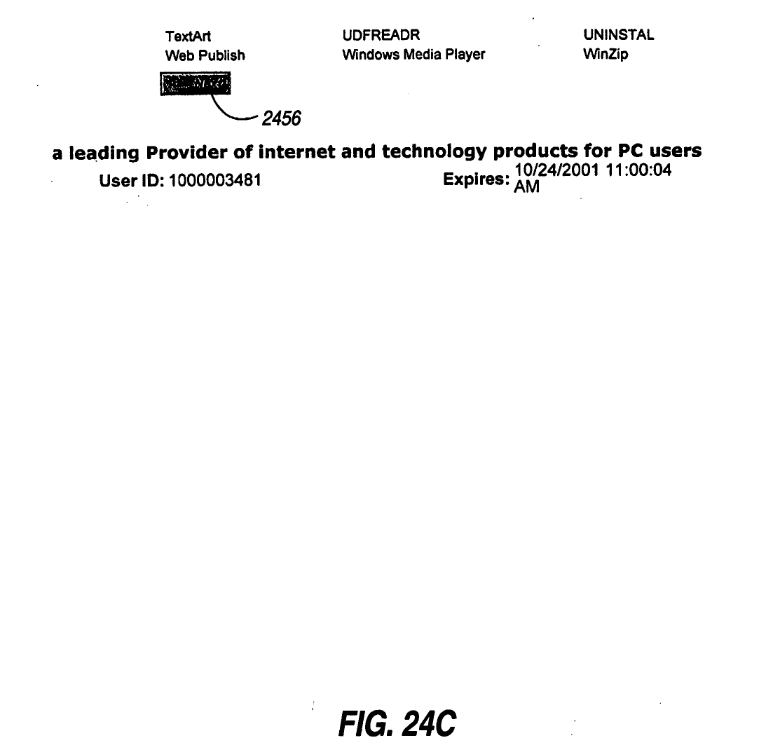

After testing has been completed, the user is presented with a system information report page (see FIGS. 24A-C). The system information report page 2400 may include general system information 2404, such as information regarding the CPU 312, the operating system software 380, the BIOS, available space on the hard disk drive 336, and the total amount of memory 332 available on the client computer 108.

In addition, the system information report 2400 may include information regarding various peripheral devices. For example, information 2408 may be provided regarding input/output devices 364, such as a sound card. The sound card information 2408 may include a description of the sound card 364, the manufacturer, model, and any problem codes. In addition, test results may be indicated. With respect to the system information report 2400, the test results for various devices may be indicated as passed or failed.

Other peripheral devices, such as storage devices, for which information may be provided include a CD ROM 344. The information 2412 concerning the CD ROM may include the assigned drive letter, a description of the device, the manufacturer, model, problem codes, and test results.

Test results for installed printers 368 may also be provided by the system information report 2400. The information 2416 regarding installed printers 368 may include a description, manufacturer, model name, problem codes, and test results. The printer test results 2416 also illustrate the use of messages in the system information report 2400 particular to certain devices. For example, the system information 2416 regarding the printers 368 notes that a printer must be turned on in order to be detected. In this way, the user may be notified of conditions that may cause unexpected test results.

Information 2420 regarding a floppy drive 340 may also be provided. Such information 2420 may include the assigned drive letter, description of the device, manufacturer, model, problem code, and test results.

The system information report 2400 may also provide information 2424 regarding detected user interface devices, including the monitor 352. The information 2424 regarding the monitor may include a description, manufacturer, model and problem code.

Information 2428 regarding devices related to user interface devices may also be provided by the system information report. For example, video adaptor information 2428 concerning the video card 324 may be provided, and may include a description, manufacturer, model, problem code, and test results.

Test results for detected hard disk drives 336 may also be included in the system information report 2400. The hard disk drive information 2432 may include the assigned drive letter, the assigned drive number, a description of the device, the manufacturer, model, storage size, problem codes and test results.

Information 2436 regarding user input devices, such as pointing devices 360 may include a description of the device, manufacturer, name, problem code and test results.

The test results shown in the system information report 24 0 may include information 2440 concerning network or modem connections (i.e. network interfaces) 320. This information 2440 may include a description of the modem or network, manufacturer, model, problem code, and test results.

Information 2444 regarding ports provided as part of the client computer 108 may also be displayed as part of the system information report 2400. This information 2444 may include a description of the port, the manufacturer, if any, the model, problem code, and test results.

Information 2448 regarding a universal serial bus included with the client computer 108 may be provided separately from information 2444 regarding other ports. This information 2448 may include a description, manufacturer, model, problem code, and test results.

A software inventory 2452 may also be presented to the user as part of the system information report 2400. The software inventory 2452, according to an embodiment of the present invention, lists all software applications 384 that are registered with the operating system software 380 running on the client computer 108.

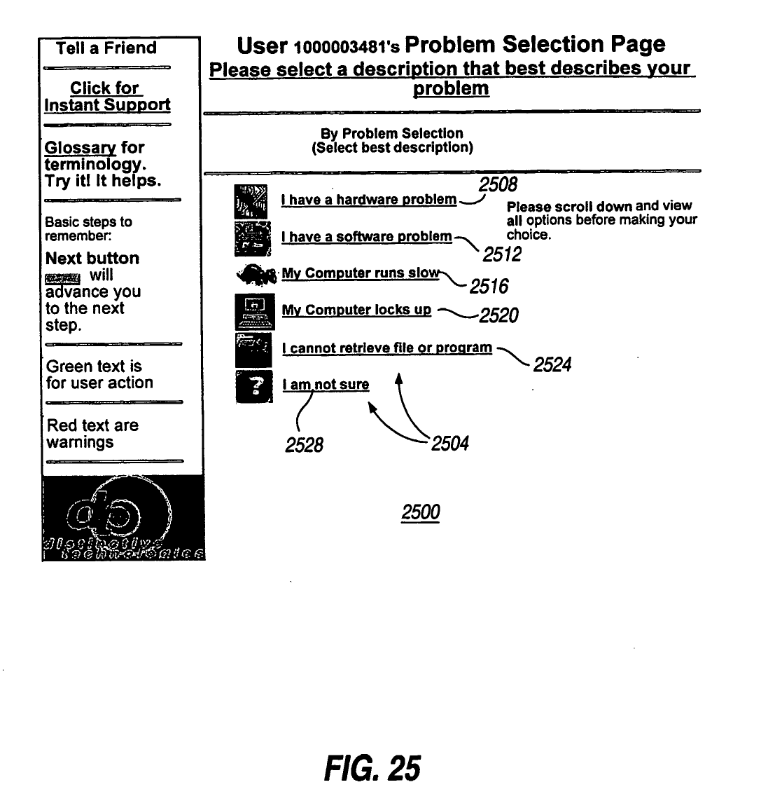

The system information report 2400 may be provided with a next button 2456. Upon selecting the next button 2456, the user is presented with a problem selection page 2500 (see FIG. 25).

The problem selection page 2500 allows the user to select from one of a variety of problem types 2504. For example, the user may select a hardware problem 2508, or a software problem 2512. In addition, the user may indicate that the client computer 108 runs slowly 2516, that the client computer 108 locks up 2520, that the user cannot retrieve a file or program 2524, or that the user is not sure of the nature of the problem 2528. Accordingly, the problem selection page 2500 allows a user to describe a problem in general terms. In particular, the problem selection page 2500 does not require that the user describe the problem in technical terms, or with any great specificity. Therefore, the present invention can be used even by users with little or no technical experience.

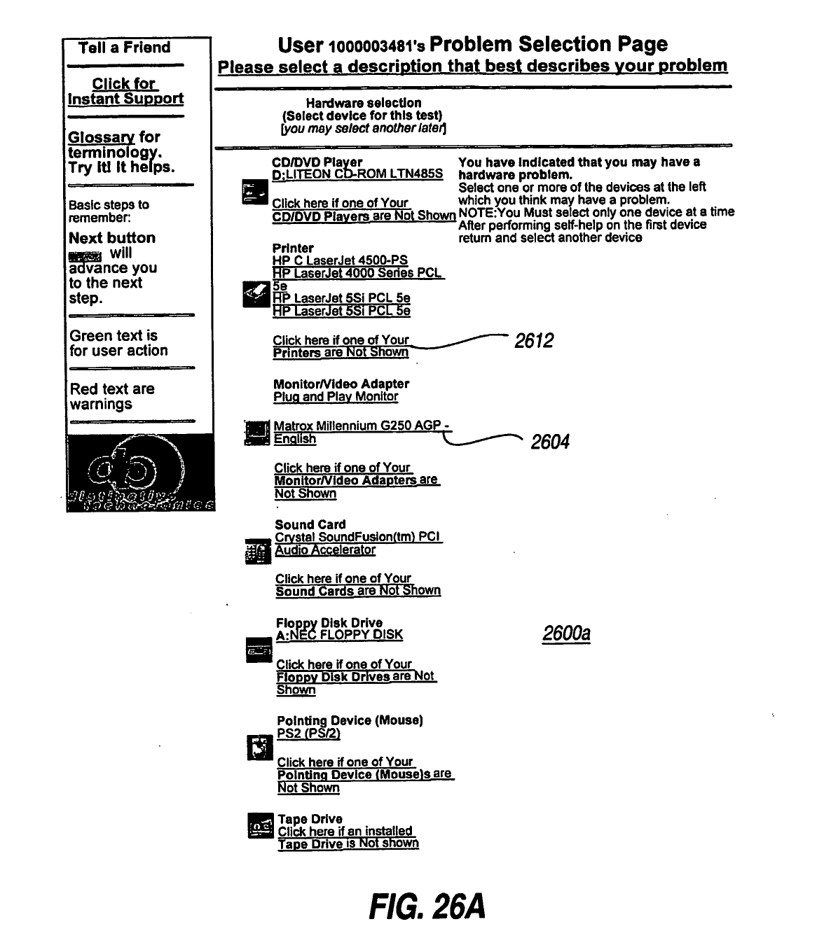

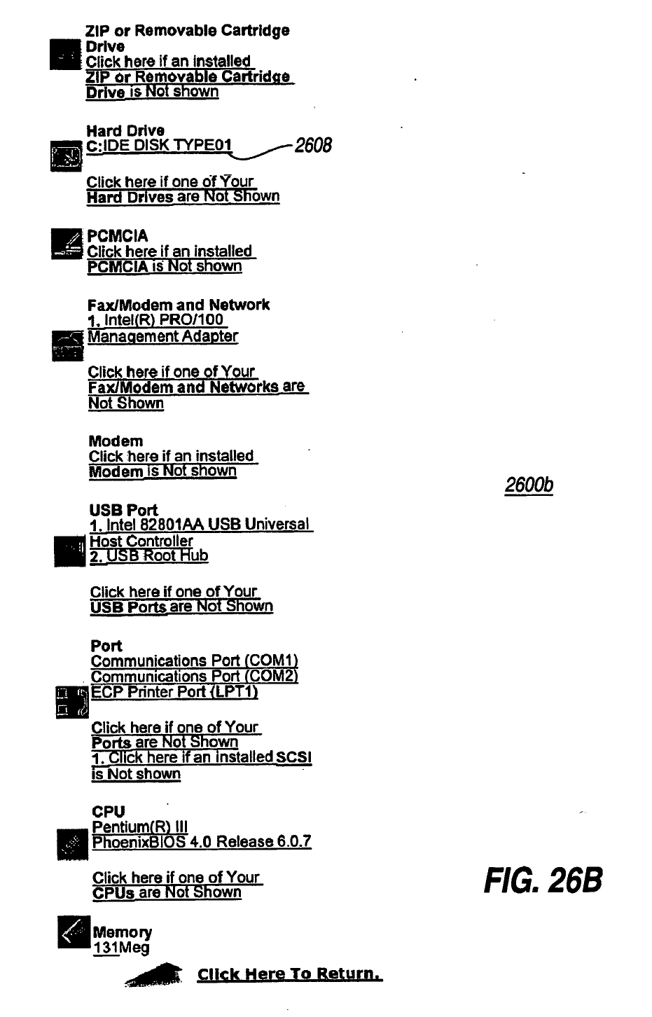

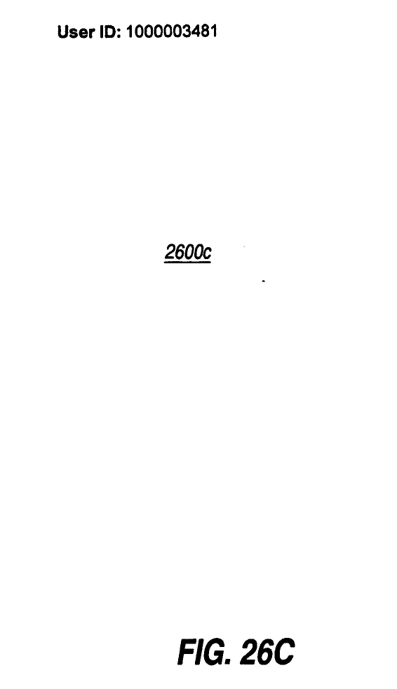

In response to the selection of a hardware problem 2508, the user is presented with a hardware problem selection page 2600 (see FIGS. 26A-C). The hardware problem selection page 2600 enumerates the various hardware devices detected during testing of the client computer 108. That is, the user is presented with a list of hardware devices that have been detected. By clicking on a link describing the hardware device, the user may specify the selected device as having a suspected problem.

In addition, links are provided to allow the user to indicate that a hardware device that the user believes is associated with the client computer 108 has not been detected. It will also be noted that for devices that were not detected, for example a tape device in the example hardware problem section page 2600, only a link for indicating that a tape drive is not shown is provided. Accordingly, the user can indicate problems, and therefore receive a disposition, with respect to devices that were not automatically detected.

As an example of how the hardware problem selection page 2600 may be used to diagnose a problem and assist the user in correcting the problem, it will be assumed that the user is experiencing problems with the monitor or video display 352. To indicate a problem with the monitor 352, the user need only select a hardware problem from the problem selection page 2500, and select the link 264 associated with the detected monitor 352.

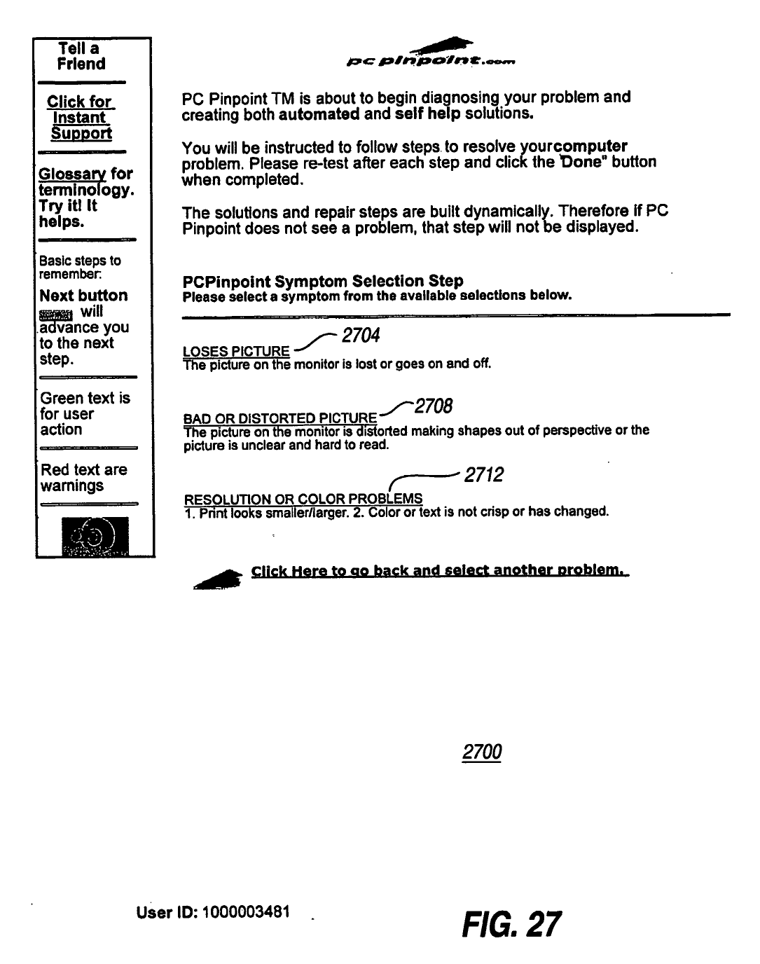

In response to the selection of the monitor 2604 link, the user is presented with a monitor problem solution page 2700 (see FIG. 27). The monitor problem solution page 2700 allows the user to select from particular problems that the user may be experiencing with the monitor 352. For example, the user may select a “loses picture” link 2704 if the picture on the monitor 352 is lost or goes on and off. A “bad or distorted picture” link 2708 may be selected if the picture on the monitor 352 is distorted, making shapes out of perspective, or the picture is unclear or hard to read. A “resolution or color problems” link 2712 may be provided if print looks smaller/larger or color or text is not crisp or has changed.

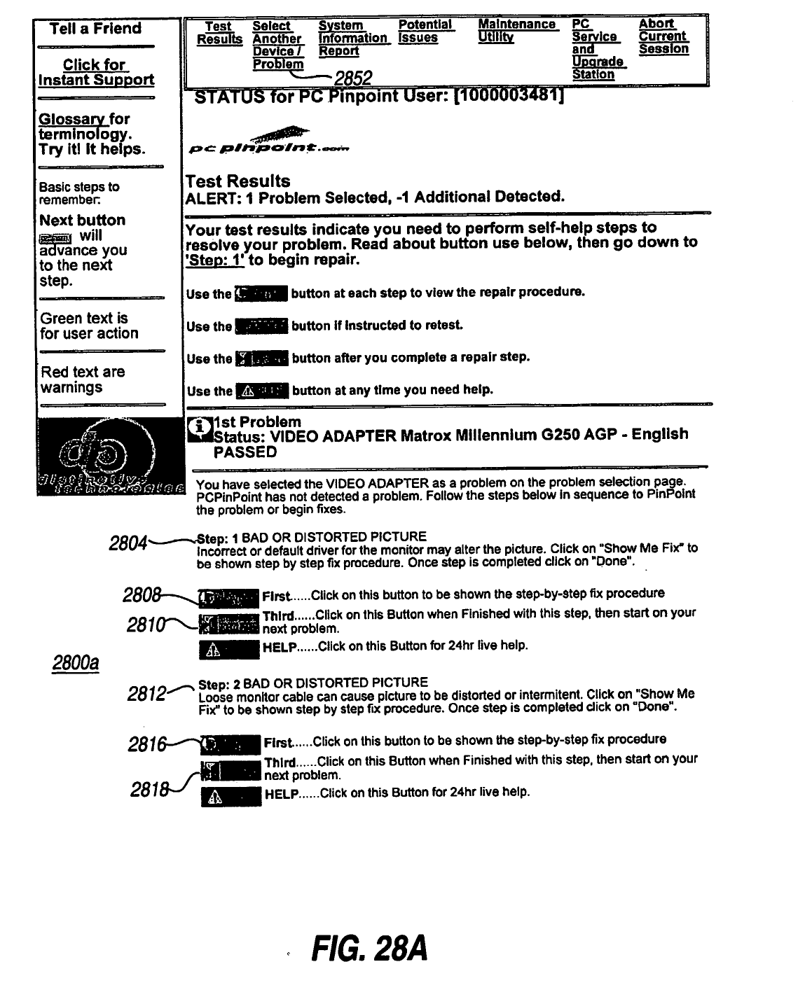

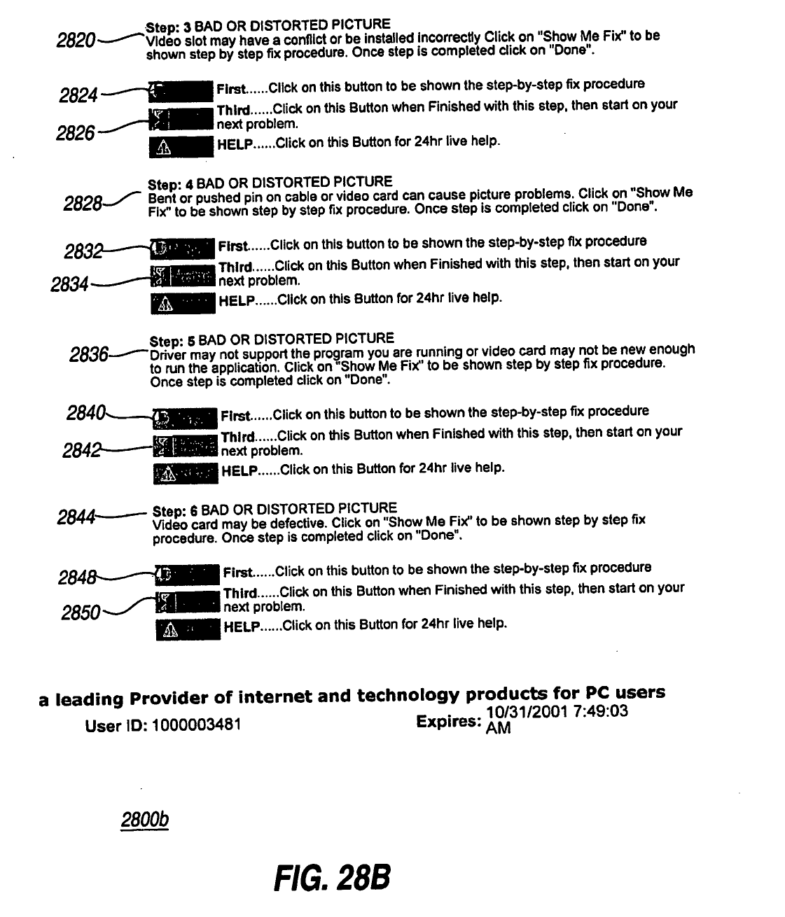

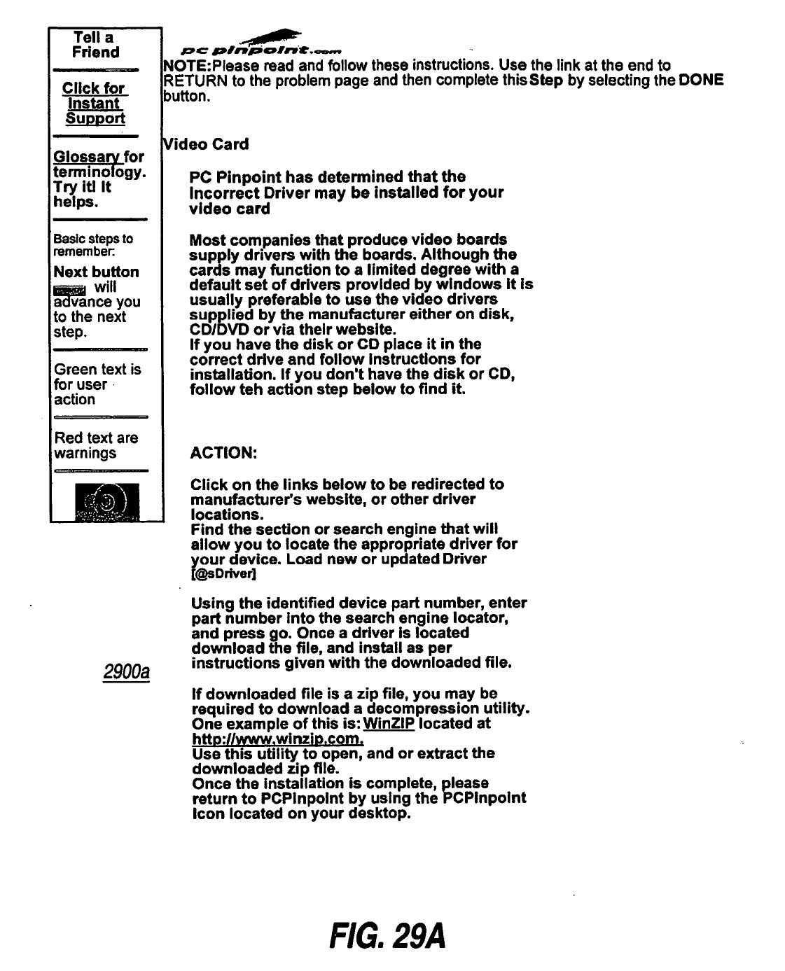

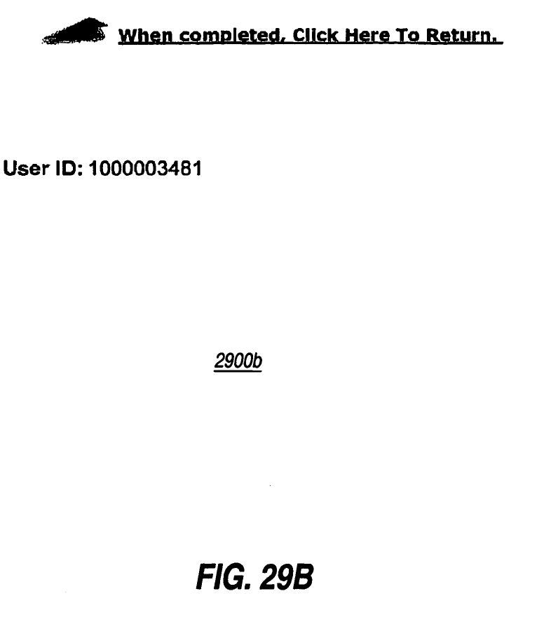

For purposes of the present example, it will be assumed that the user selects the link 2708 indicating that the monitor 352 has a bad or distorted picture. In response, a bad or distorted picture solution page 2800 (see FIGS. 28A-B) is presented to the user. The bad or distorted picture solution page 2800 presents a number of steps that the user can follow in an attempt to correct the indicated problem. A first step 2804 involves checking the driver software for the monitor 352. By selecting a “show me fix” button 2808, the user can access step by step procedures for determining whether an incorrect driver has been installed. In particular, in response to a selection of the “show me fix” button 2808, the user is presented with a video driver problem solution page 2900 (see FIGS. 29A-B).

The video driver problem solution page 2900 is an example of a self-help tutorial disposition, and provides the user with information regarding problems that can be experienced if an incorrect video driver is used in connection with a monitor 352, and in particular with the client computer's 108 video card 324. In addition, the user is provided with instructions for updating the video driver. For instance, the user is instructed to insert a disk or CD provided by the manufacturer of the video card 324 to install the correct driver. In addition, the user may be provided with instructions for locating an appropriate driver on the web site of the manufacturer of the video card 324. According to an embodiment of the present invention, a link (e.g., a Universal Resource Locator) is provided by the server 104 to the client computer 108 that may be selected by the user to enable the user to conveniently access the manufacturer's web site using the communications interface 404. After the indicated procedures have been completed, the user may select a link 2904 to return to the bad or distorted picture solution page 2800. Upon returning to the bad or distorted picture solution page 2800, the user may select the buttons 2810 indicating that step 1 2804 has been completed. Step 1 2804 is then removed from the bad or distorted picture solution page 2800.

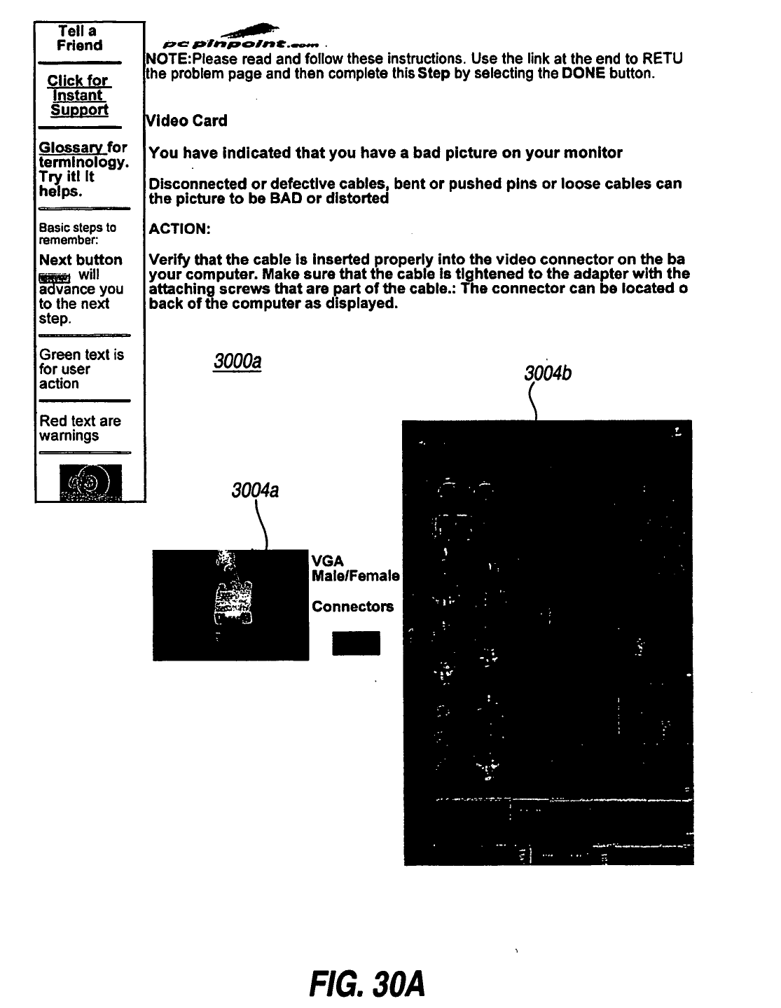

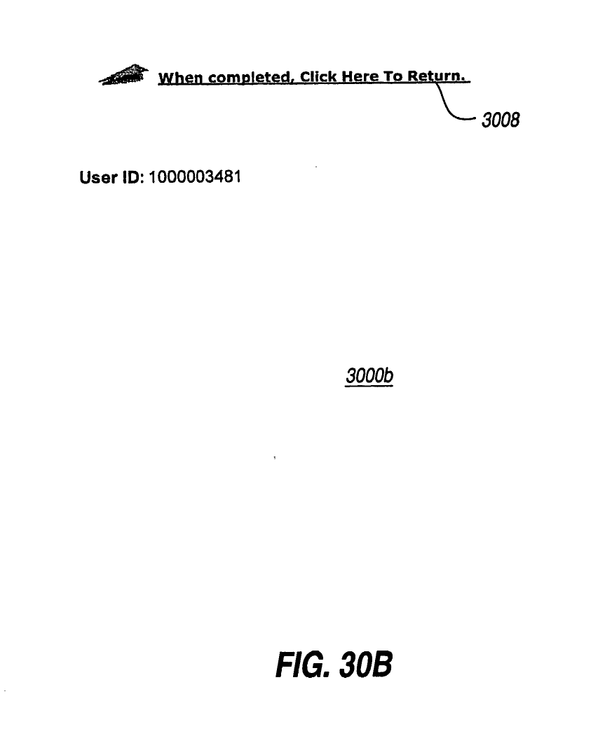

If step 1 2804 is unsuccessful in correcting the observed problem, the user may proceed to step 2 2812, which is directed to correcting a bad or distorted picture in the monitor 352 as a result of loose cables. For specific information, the user can select the “show me fix” button 2816. Upon selection of the “show me fix” button 2816, the user is presented with a video connector problem solution page 3000 (see FIGS. 30A-B).

The video connector problem solution page 3000 is another example of a self-help tutorial disposition, and explains to the user that disconnected or defective cables, or damaged connector pins, can cause the picture displayed by the monitor 352 to be of poor quality, or to be distorted. In addition, the video connector problem solution page 3000 can describe to the user actions that the user can take to ensure that the connections have been properly made. For example, the user can be instructed to verify that the cable is inserted properly into the provided connector on the back of the computer, and that the cable is tightened to the video card 324 with the attaching screws provided as part of the cable. Photographs 3004 may be provided to illustrate for the user the physical configuration of the cables and connectors that the user is to check. Upon completion of the indicated procedures, the user may select a link 3008 to return to the bad or distorted picture solution page 2800. From the bad or distorted picture solution page 2800, the user may indicate that step 2 2812 has been completed by selecting the “done” button 2818. Step 2 is then removed from the bad or distorted picture solution page 2800.

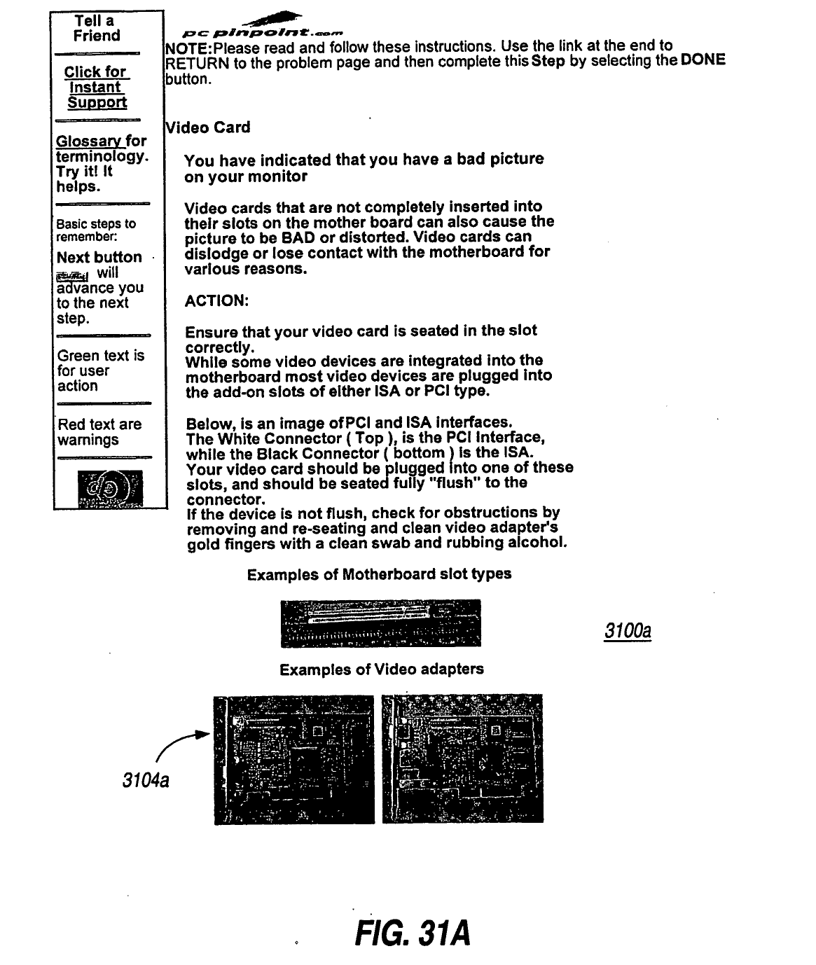

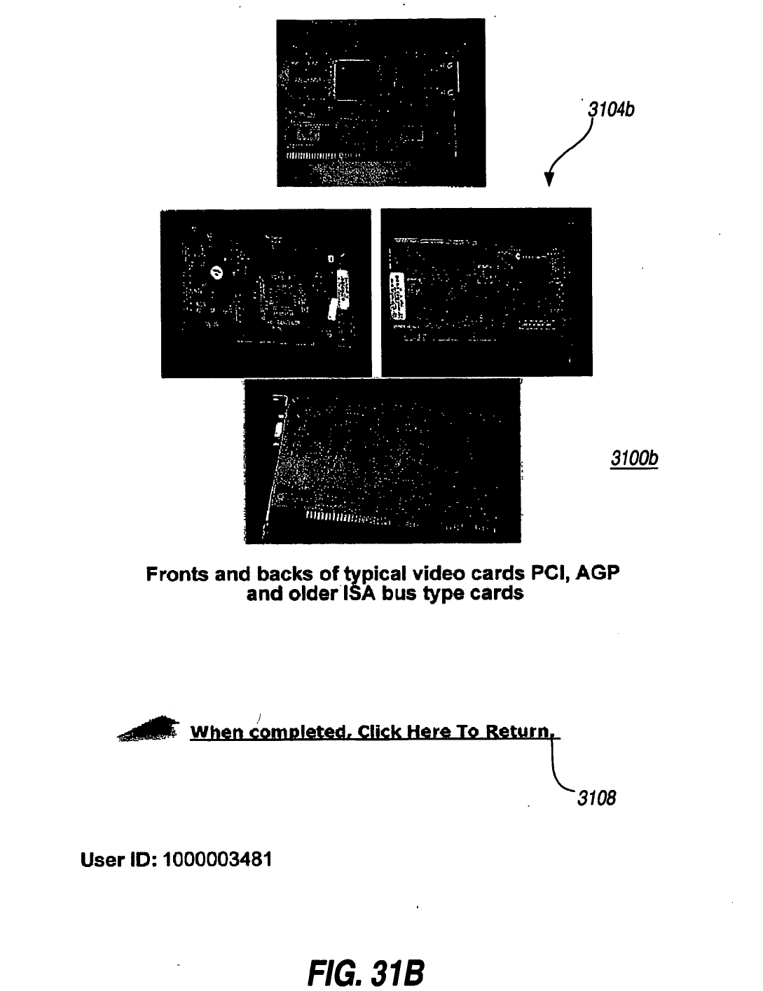

With continued reference to FIG. 28, the user may proceed to step 3 2820, for example if the previous steps have been unsuccessful in solving the indicated problem. Step 3 2820 is directed to a video slot that has a conflict or is not properly installed. By selecting the “show me fix” button 2824, the user is presented with a video card connection problem solution page 3100 (see FIGS. 31A-B). The video card connection problem solution page 3100 is yet another example of a self-help tutorial disposition, and describes the symptoms of a video card 324 that is not completely inserted into the corresponding slot or connector provided by the client computer 108. In addition, the steps that the user may take to ensure that the video card 324 is properly connected is described. Photographs 3104 may be provided to illustrate for the user the video card 324 and the slots for receiving the video card 324. After the described procedures have been performed, the user may select a link 3108 to return to the bad or distorted picture solution page 2800. The “done” button 2826 associated with step 3 2820 may then be selected to remove step 3 2820 from the bad or distorted picture solution page 2800.

Step 4 2824 addresses fixes for a bad or distorted picture caused by a bent pin on the cable or video card 324. By selecting the “show me fix” button 2832, the user is presented with the video connector problem solution page 3000 (see FIG. 30). Therefore, it can be appreciated that certain of the actions that may be performed by a user as self help may be repeated. In a typical repair scenario, the user will not perform all of the fixes that can be accessed from a problem solution page. Thus, in the present example, the user need not access all of the potential fixes available from the bad or distorted picture solution page 2800 (FIG. 28). This is because a user will likely have fixed the problem that can be solved by a particular fix, and therefore any symptoms associated with such a problem will have disappeared by the time the user arrives at the second instance of a particular solution. In addition, a user may not have all of the symptoms that may be associated with a particular solution. Again, the user is therefore unlikely to happen upon a repeat of a previously suggested fix during a problem solution session. Upon returning to the bad or distorted picture solution page 2800 by selecting the completed link 3008, the user may remove step 4 2824 by selecting the “done” button 2834.

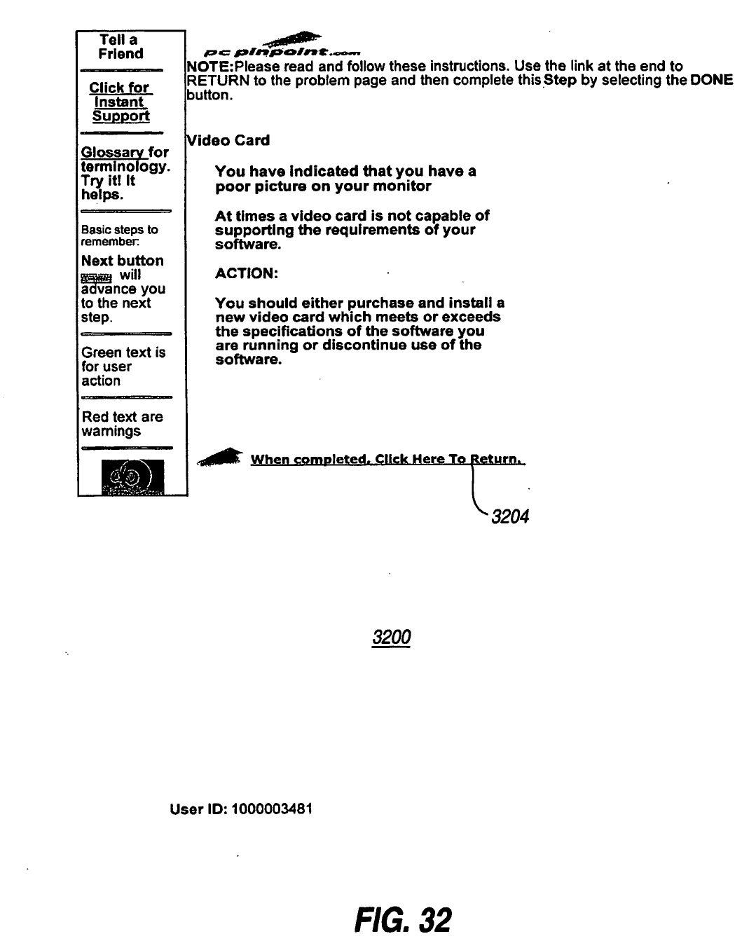

If the previous steps have been unsuccessful at solving the problem or problems being experienced in connection with the client monitor 352, the user may select step 5 2836, directed to a video driver that may not support a particular application program, or a video card 324 that may not be new enough to run that application. By selecting the “show me fix” button 2840, the user is presented with a video card capability problem solution page 3200 (see FIG. 32). The video card capability problem solution page 3200 is still another example of a self-help tutorial disposition, and may explain that certain video cards 324 are not capable of supporting all software applications 384. Accordingly, the video card capability problem solution page 3200 may suggest that the user purchase and install a new video card 324 that meets or exceeds the specifications of the application software 384. The user may select the link 3204 indicating that the user has finished the steps and/or finished reviewing the information to be returned to the bad or distorted picture solution page 2800. The user may then remove step 5 2836 from the list of steps by selecting the “done” button 2842.

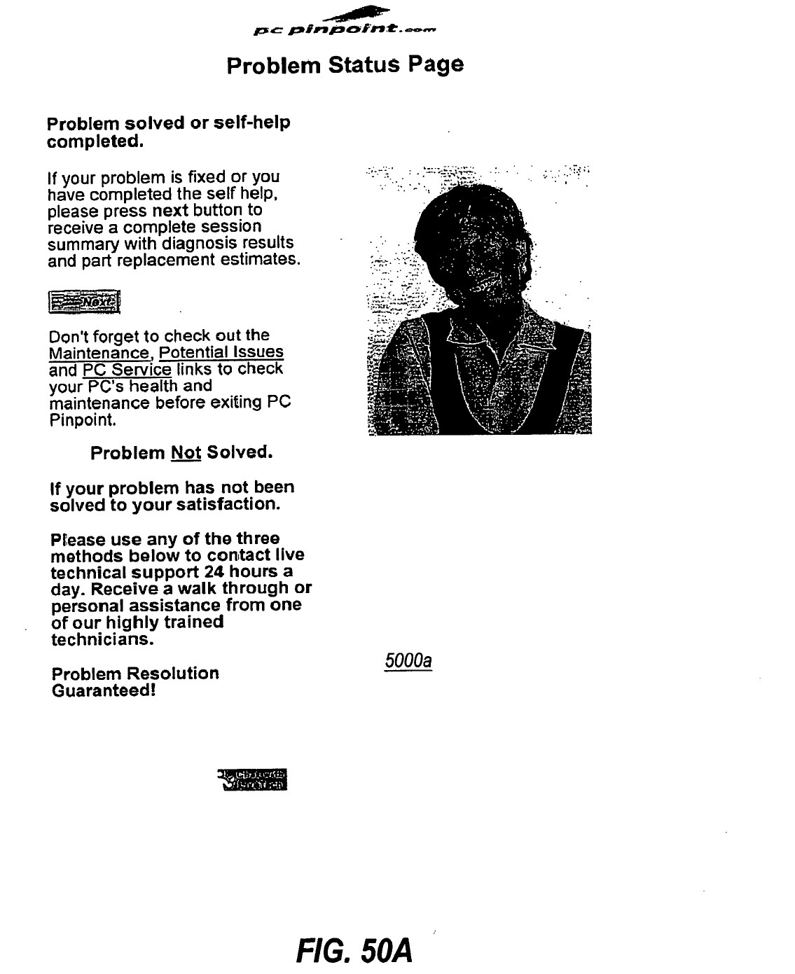

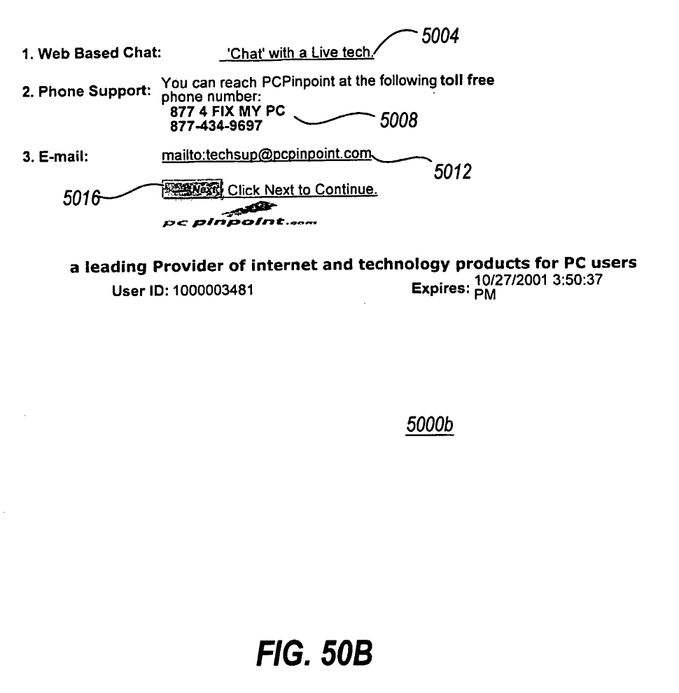

If the previous steps have been unsuccessful in solving the problem, the user may select step 6 2844, which is directed to a defective video card. By selecting the “show me fix” button 2848, the user may be presented with the video card connection problem solution page 3100, which describes procedures that the user may perform to ensure that the video card 324 is properly interconnected to corresponding slots in the motherboard of the client computer 108. The user may return to the bad or distorted picture solution page 2800 by selecting the link 3108 indicating that the procedures have been completed. Step 6 2844 may be removed from the list of steps by selecting the “done” button 2850. If all of the steps have been completed, hitting a last “done” button (e.g., button 2850) will cause a problem status page 5000 (see FIG. 50) to be displayed.

It should be appreciated that the user need not proceed through the various steps presented to the user in response to the selection of a particular problem in order. For example, if the user is certain that the correct video driver is being used, step 1 2808 of the bad or distorted picture solution page 2800 need not be completed, and the user can proceed to step 2 2812, or any other step. Furthermore, it should be appreciated that all of the steps need not be completed, and that the user may exit a particular problem solution page at any time. For instance, if the user completes the procedures associated with step 2 2812, and the problem is solved, the user may click on the select another device/problem link 2852 to be returned to the problem selection page 2500.

It should also be appreciated that not all of the possible self-help steps associated with an indicated problem need to be presented to the user. For example, in accordance with an embodiment of the present invention, steps concerning items that are known to be okay, either through automated testing or comparisons, are not included in the self-help tutorial dispositions. For instance, in the example above concerning the selection by the user of a problem with the monitor 352, the first step 2804 concerning an incorrect driver will not be included in the provided steps if a comparison indicates that the video driver is correct. The comparison may comprise comparing the file name and file size of the video driver detected on the client computer to the file name and file size of the most current video driver available for the video card 324. As yet another example, steps concerning confirming that hardware is properly connected to the client computer 108 will not be included in the self-help tutorial dispositions if automatic testing confirms that such devices are properly connected. Accordingly, it should be appreciated that the dispositions provided in accordance with the present invention are adaptive, and that the particular set of dispositions presented to a user are built dynamically, in response to the results of comparisons and testing concerning the client computer 108.

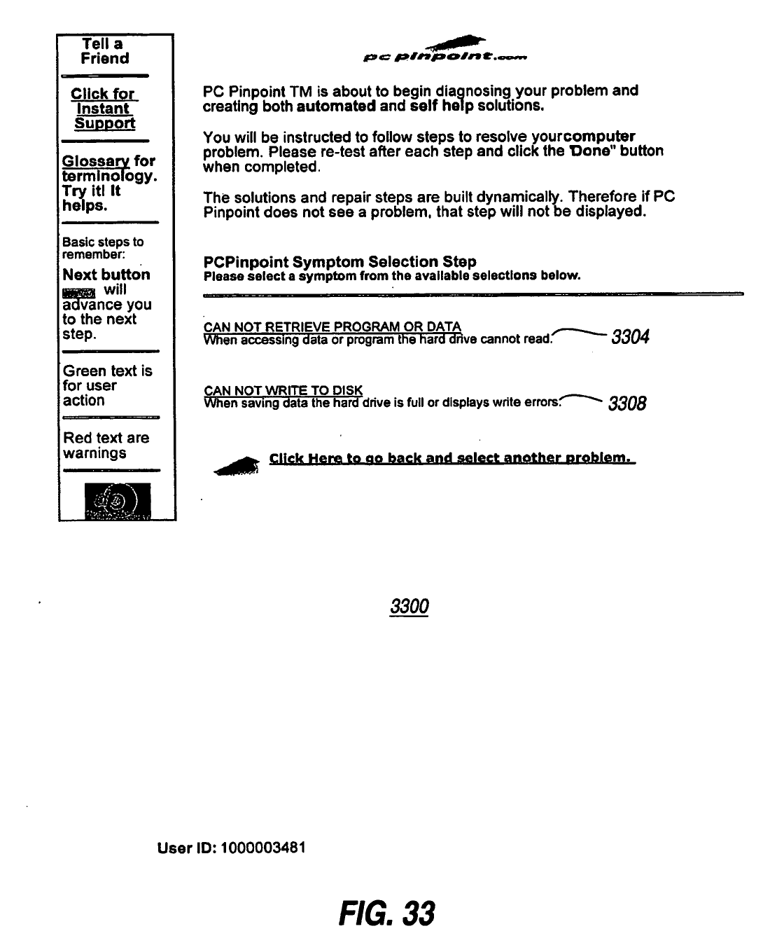

As a further example of the steps that may be taken in connection with resolving a problem designated or selected by a user, the user may again select a hardware problem 2508 from the problem selection page. The user may then select the hard disk 336 as a problem device by selecting the hard drive link 2608 from the hardware problem selection page 2600 (see FIG. 26). Upon selection of the hard disk link 2608, the user is presented with a hard disk drive problem solution page 3300 (see FIG. 33).

The hard disk drive problem solution page 3300 may provide links to solutions for problems detected during testing of the client computer 108. Alternatively or in addition, links may be provided to solutions for typical hard disk drive 336 problems. For example, a first link 3304 may be directed to problems involving the retrieval of programs or data from the hard disk drive 336. In addition, a second link 3308 directed to problems involving writing data to the hard disk drive 336 may be provided. According to an embodiment of the present invention, the link to problems involving retrieving programs or data 3304, and the link concerning problems writing data to disk 3308 may be provided whether or not testing of the client computer 108 has resulted in the detection of problems with the hard disk 336 (i.e. they may be provided in response to selection of the hard disk link 2608 by the user). In addition, upon the selection of a particular device or program, such as the hard disk 336, additional testing may be performed automatically.

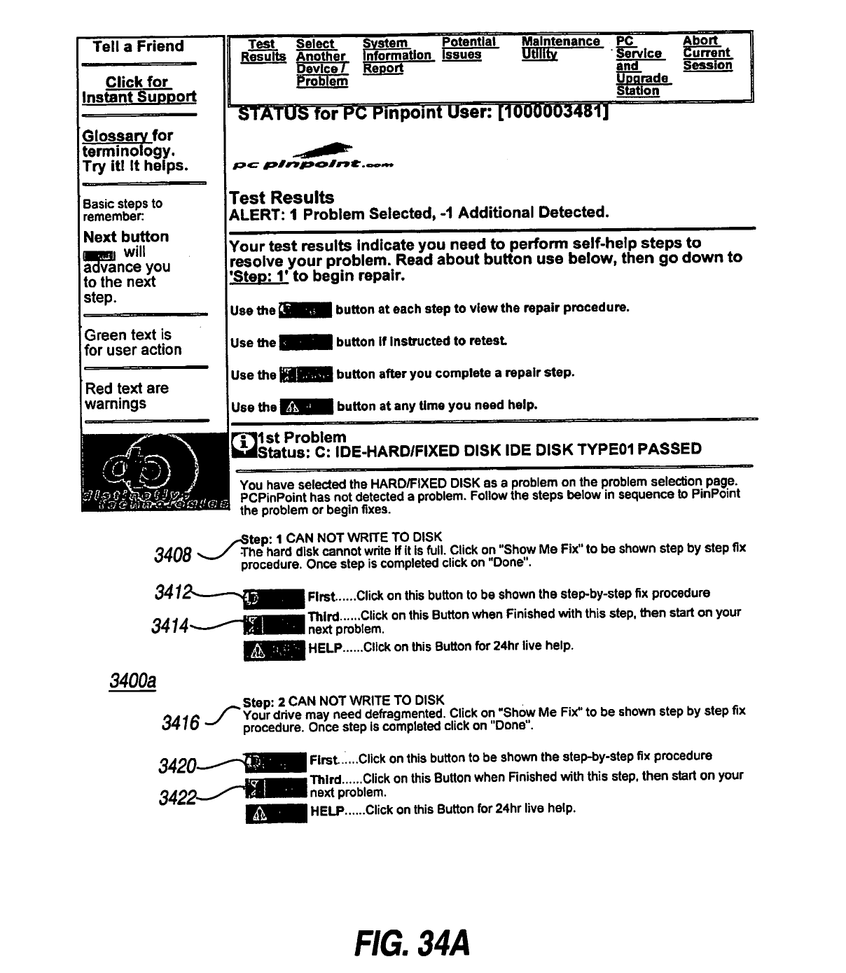

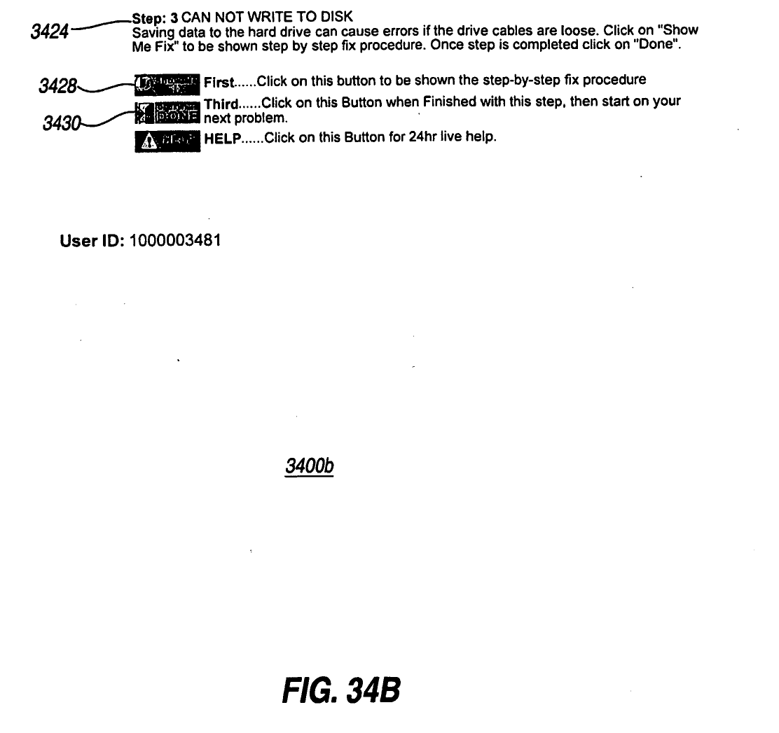

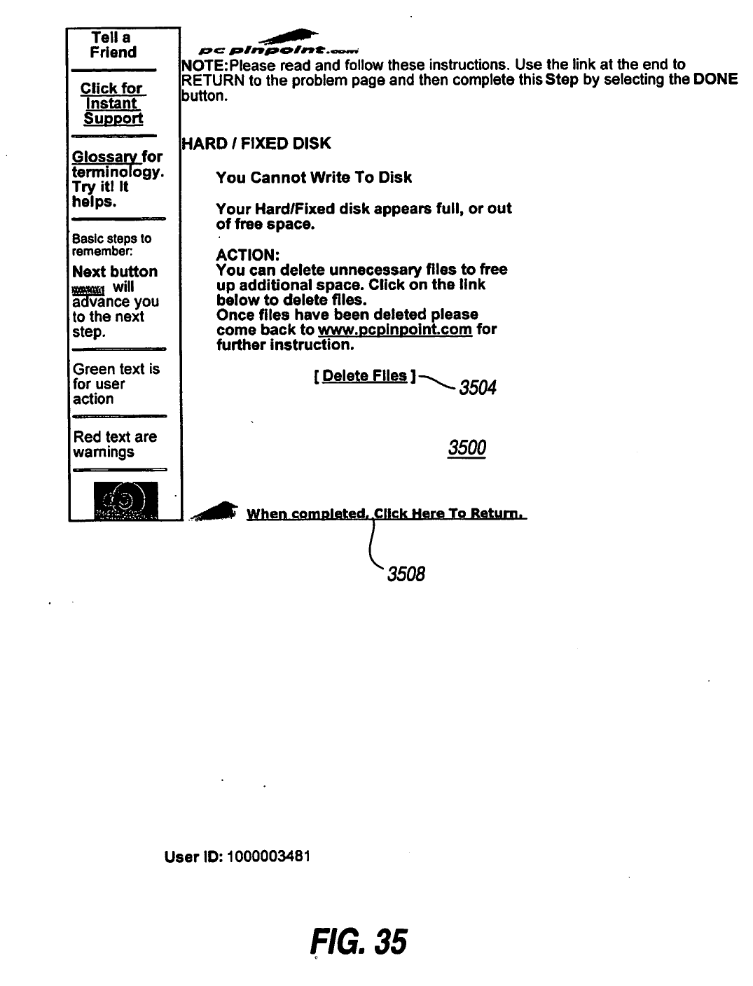

If the user selects the link directed to problems involving writing data 3308, the user is presented with a hard disk drive write problem solution page 3400 (FIG. 34). A first step 3408 may be directed to write problems caused by a hard disk 336 that is full. By selecting the “show me fix” button 3412, the user is presented with a full hard disk drive problem solution page 3500 (see FIG. 35).

The full hard disk drive problem solution page 3500 is an example of a self-help tutorial disposition available from the server 104, and may describe actions that the user may take to free up space on the hard drive 336. In addition, a link 3504 may be provided to automatically initiate a program that can be used to delete unnecessary files. The deletion of unnecessary files may be semiautomated, in that files likely to be unnecessary may be presented in a list to the user. The user may then choose to delete those files by selecting them. Therefore, the full hard disk drive problem solution page 3500 is also an example of an automated fix or maintenance disposition. An example of files that are likely unnecessary is temporary Internet files maintained to speed up navigation over the Internet. The user may return to the hard disk drive write problem solution page 3400 by selecting the link 3508 to indicate that the procedures have been completed. The user may then remove step 1 3408 from the list of steps on the hard disk drive write problem solution page 3400 by selecting the done button 3414.

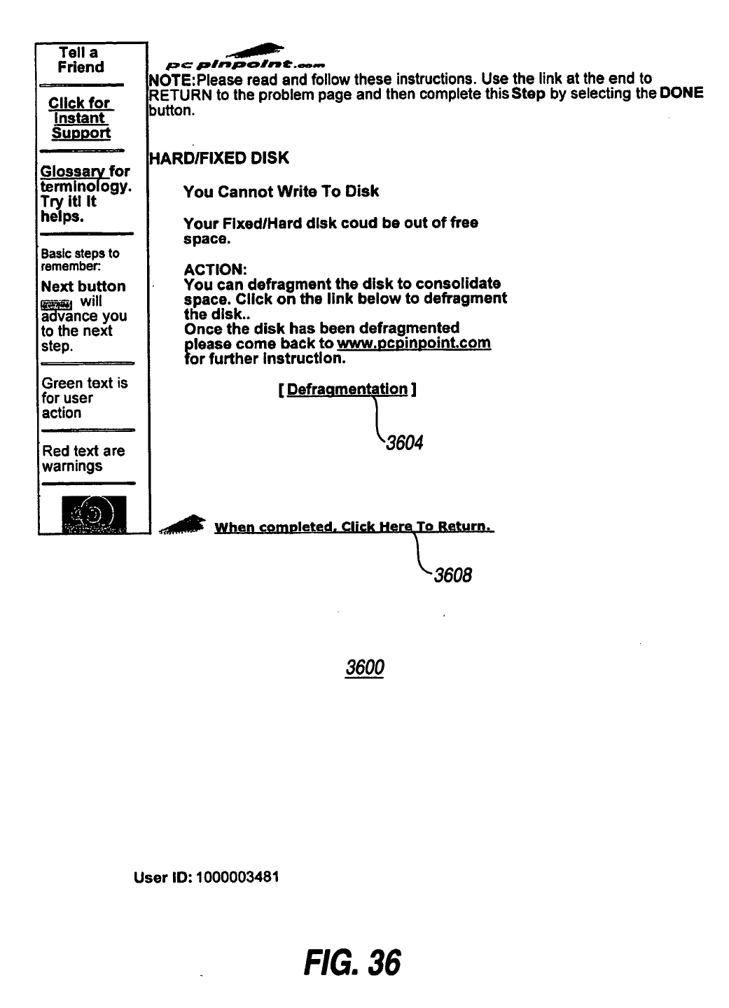

Step 2 3416 of the hard disk drive write problem solution page 3400 is directed to write problems due to the fragmentation of data stored on the disk drive 336. By selecting the “show me fix” button 3420, the user may be presented with a fragmented hard disk drive problem solution page 3600 (see FIG. 36). The fragmented hard disk drive problem solution page 3600 is another example of a self-help tutorial disposition provided in accordance with an embodiment of the present invention, and may provide a description of the types of problems caused by fragmented hard drives 336. In addition, a link 3604 may be provided to allow the user to automatically initiate a defragmentation utility. Therefore, a user may defragment a hard disk drive 336 simply be selecting the appropriate link (e.g., defragmentation link 3604) without needing to locate a program capable of defragmenting the hard disk drive 336. Alternatively, in response to selection of the defragmentation link 3604, a defragmentation script or utility may be downloaded from the server 104 to the client computer 108 to allow defragmentation of the disk drive 336 to be performed. Accordingly, the fragmented hard disk drive problem solution page 3600 is also an example of an automated fix or maintenance disposition. After completion of the defragmentation procedures, the user may automatically be returned to the hard disk drive write problem solution page 3400, or the user may choose to return to the hard disk drive write problem solution page 3400 by selecting the completed link 3608.

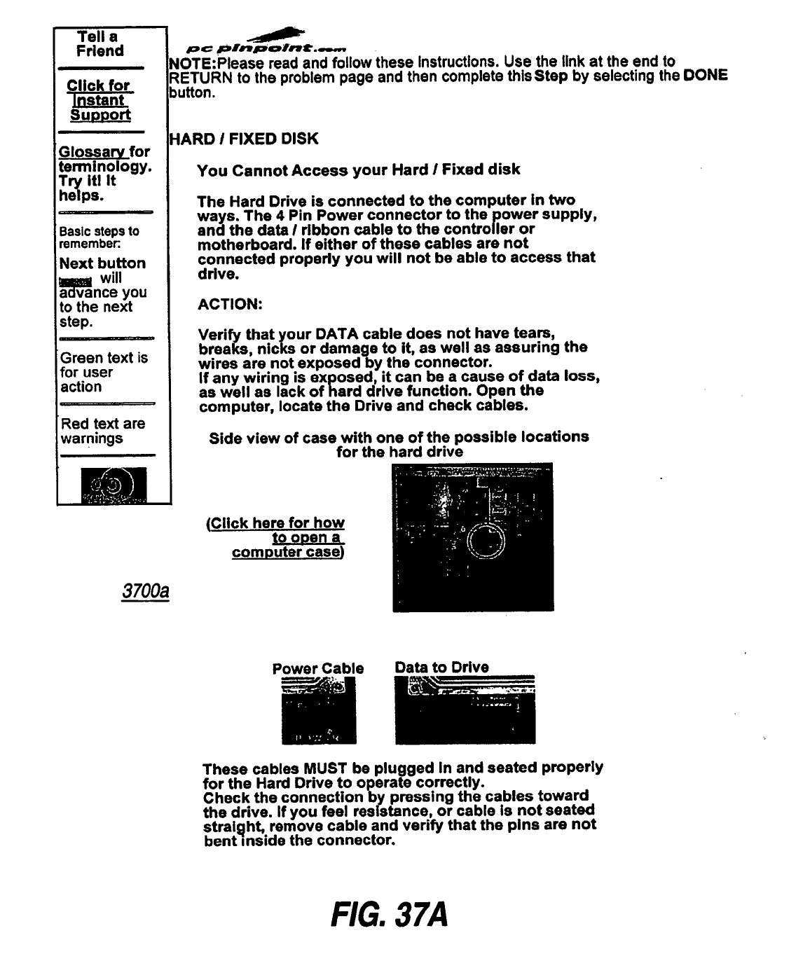

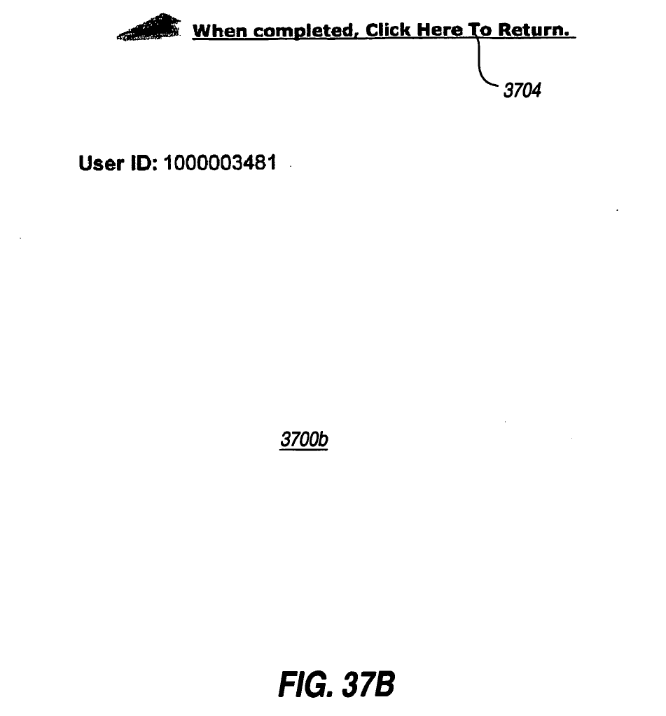

With continued reference to FIG. 34, step 3 3424 is directed to problems writing to the disk drive 336 caused by loose connector cables. By selecting the “show me fix” button 3428, the user is presented with a hard disk drive connector solution page 3700 (see FIG. 37). The hard disk drive connector solution page 3700 is still another example of a self-help tutorial disposition, and may describe the types of cables interconnected to the hard drive 336, and regarding damage to the data cable that the user should check for to determine whether such damage has caused the indicated problem. In addition, the user may be instructed to ensure that the cables are properly seated, and that there are no bent pins in the associated connectors. After the procedures have been completed, or if the user does not wish to complete the described procedures, the user may select the link 3704 indicating that the procedures have been completed to be returned to the hard disk drive write problem solutions page 3400. Upon selection of a last remaining “done” button (e.g., “done” button 3430), the user is presented with a problem status page 5000 (see FIG. 50).

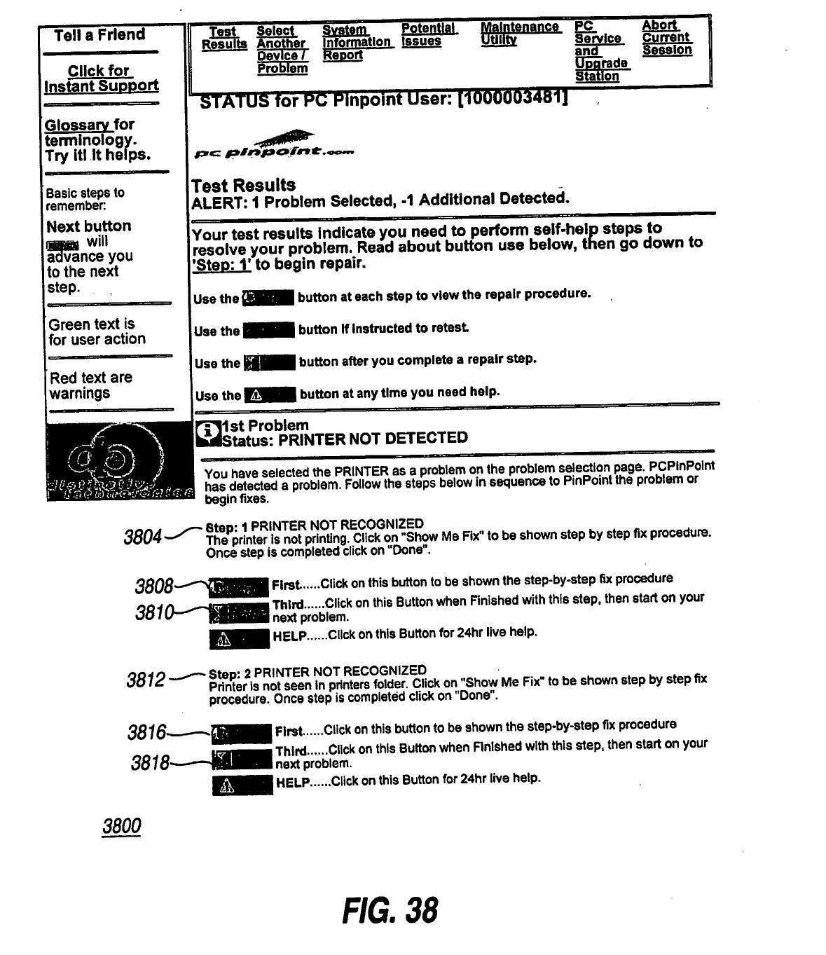

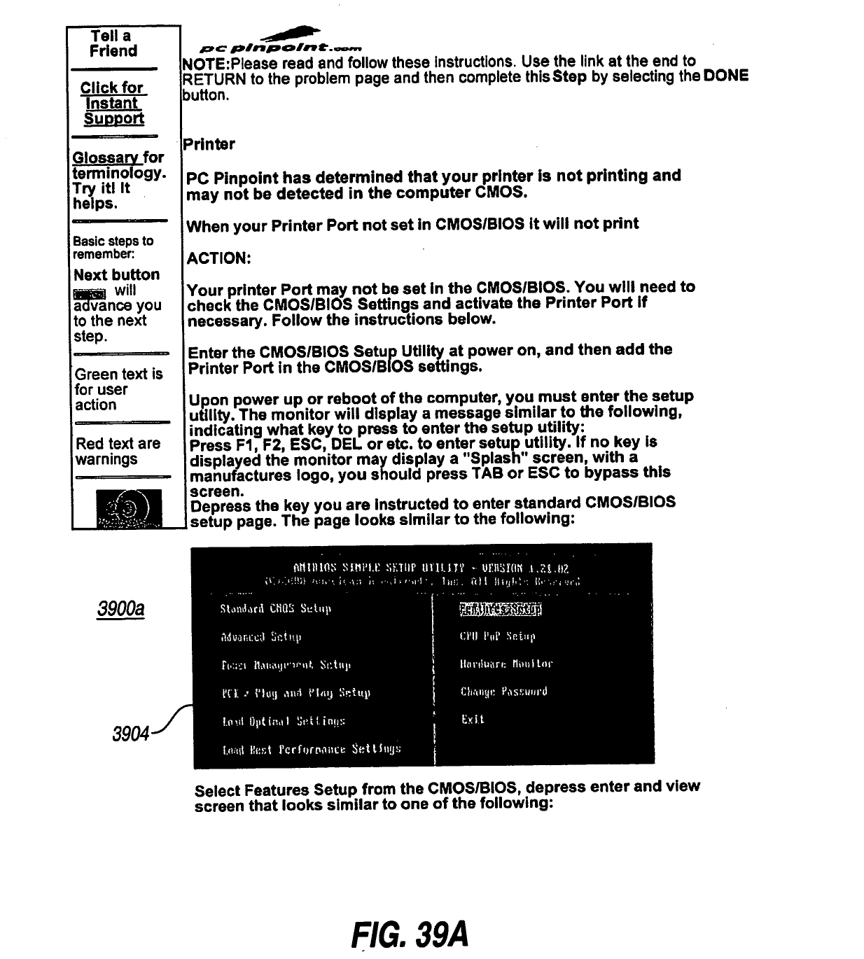

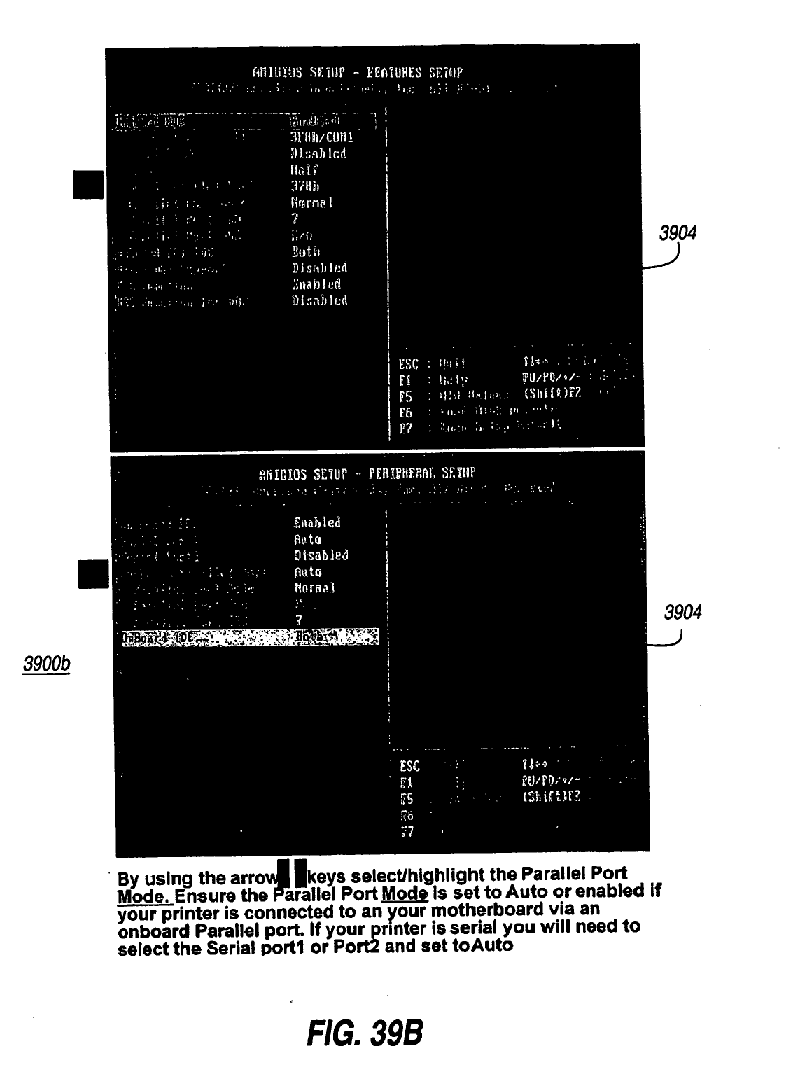

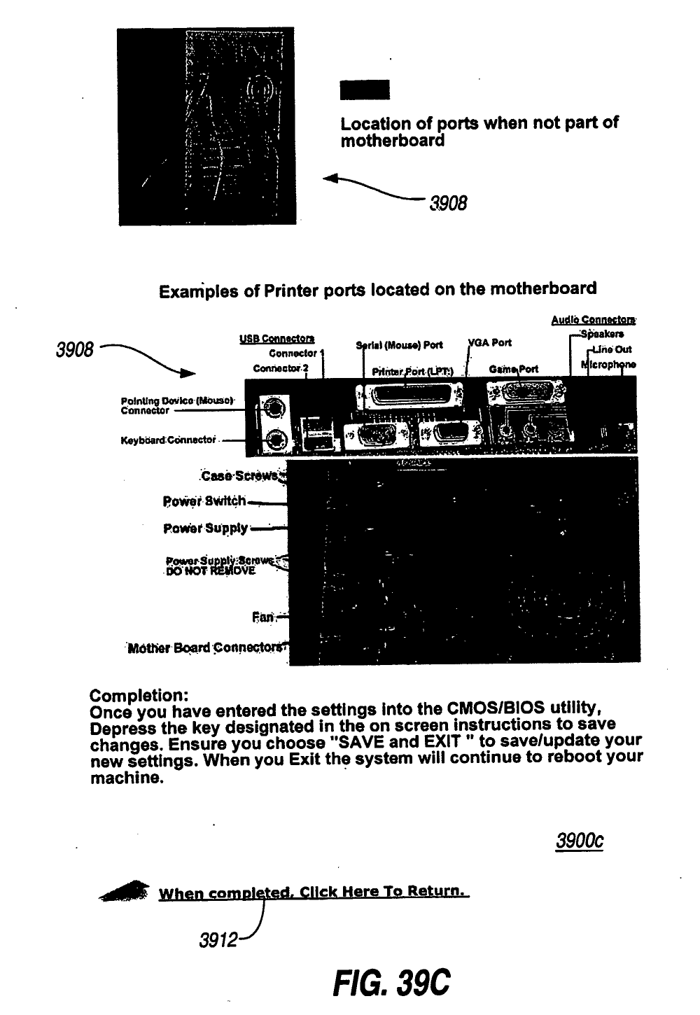

As a further example, and with continued reference to FIG. 26, the user may select a link 2612 to indicate that a printer 368 has not been detected. In response to the selection of the link 2612 indicating that a printer 368 is not shown in the list of hardware, the user is presented with a printer not detected solution page 3800 (see FIG. 38). In a first step 3804, a fix directed to a printer that does print is provided. By selecting the “show me fix” button 3808, the user is presented with a printer CMOS entry problem solution page 3900 (see FIGS. 39A-C).

The printer CMOS entry problem solution page 3900 is another example of a self-help tutorial disposition, and describes the steps that the user must take in order to verify that the CMOS entry for the printer is properly configured. In addition, illustrations or screen shots 3904 of a utility commonly used in connection with the setting of CMOS entries may be provided. In addition, illustrations 3908 of different port types may be provided to assist the user in determining what type of port the printer 368 is connected to. After the procedures set forth in the CMOS entry problem solution page 3900, or if the user for any reason wishes to exit that page, the user is again presented with the printer not detected solution page 3800 following selection of the “completed” link 3912. Step 1 may be removed from the printer not detected solution page 3800 by selecting the corresponding the corresponding “done” button 3810.

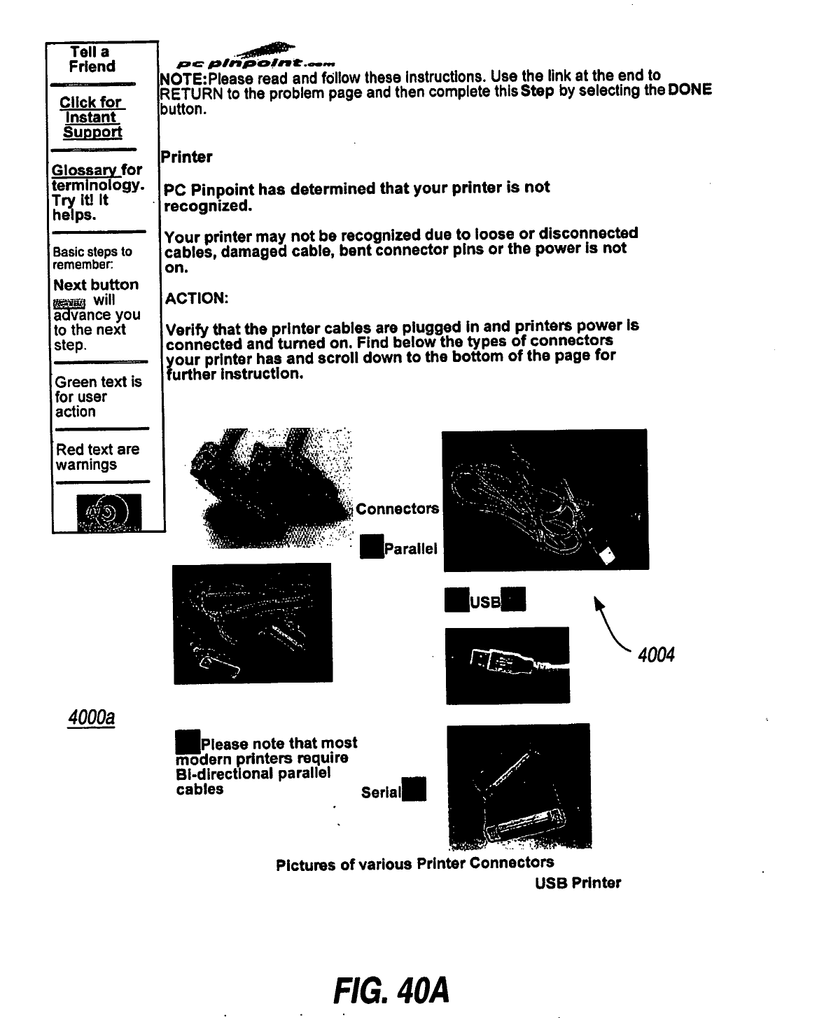

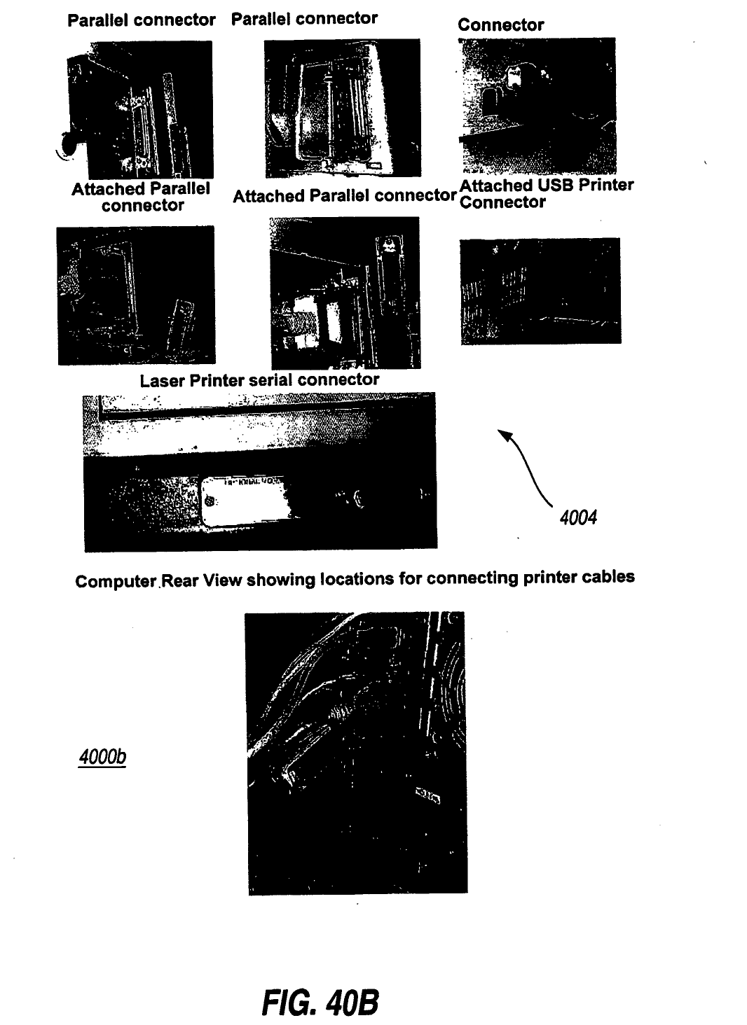

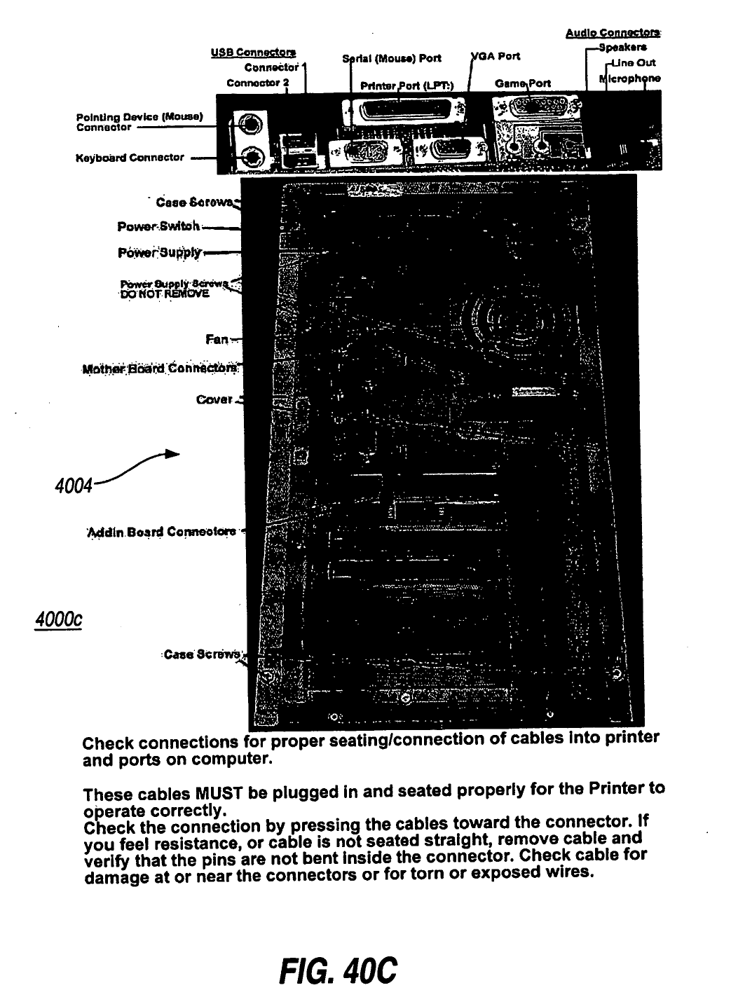

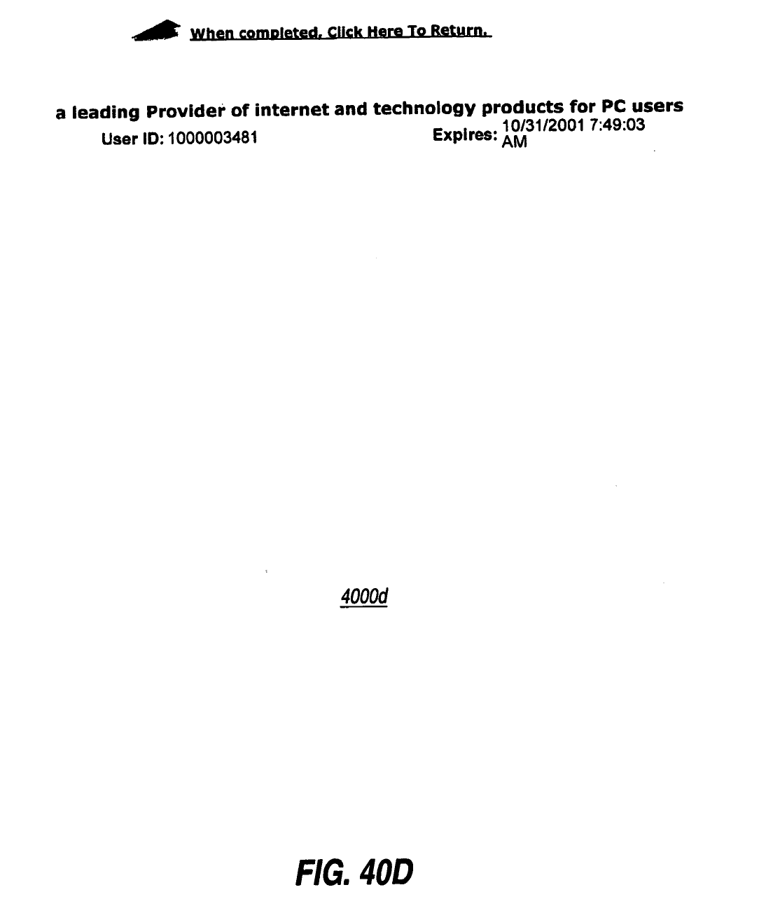

With reference again to FIG. 38, step 2 3812 is directed to a printer 368 that is not listed in the program's folder of the operating software 380. By selecting the “show me fix” button 3816, the user is presented with a printer connection problem solution page 4000 (see FIGS. 40A-D). The printer connection problem solution page 4000 is still another example of a self-help tutorial disposition, and may include information regarding the connections that are required for proper printer operation. Photographs 4004 may be included to assist the user in identifying relevant connectors. When the indicated procedures have been completed, or when the user wishes to exit the page, the user may select a link 4008 to return to the printer not detected solution page 3800. A problem status page 5000 (see FIG. 50) is presented if the user then selects the “done” button 3818 associated with step 2 3812.

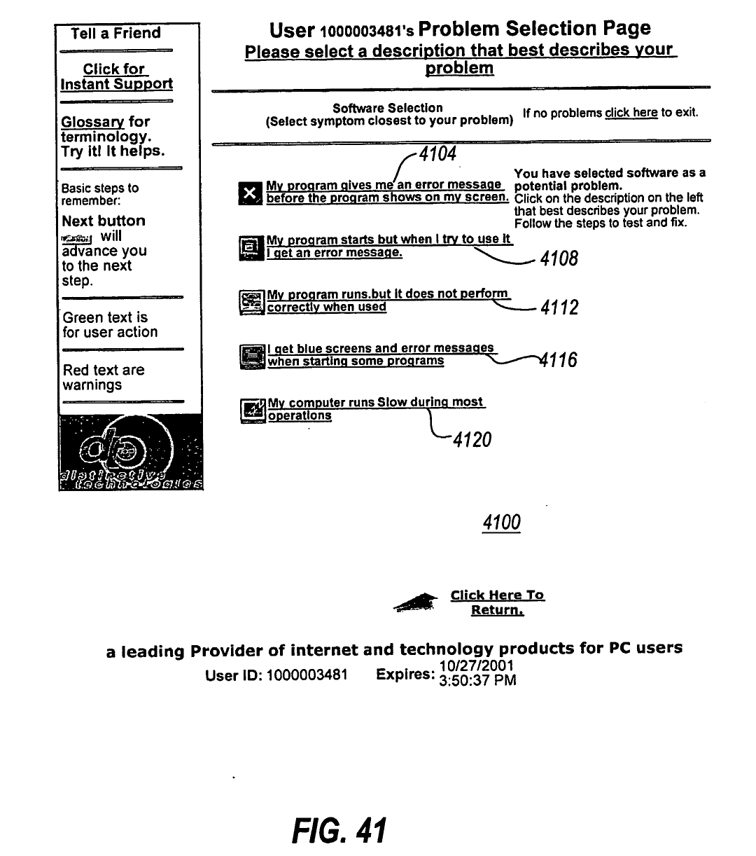

As yet another example, a user who indicates that a problem involving software is being experienced is presented with a software problem selection page 4100 (see FIG. 41). The software problem selection page 4100 includes several descriptions of particular types of software problems. For example, the user may select from “my program gives me an error message before the program shows on my screen” 4104; “my program starts but when I try to use it I get an error message” 4108; “my program runs but it does not perform correctly when used” 4112; “I get blue screens and error messages when starting some programs” 4116; and “my computer runs slowly during most operations” 4120. Accordingly, the present invention allows a user to describe a problem that is being experienced in non-technical language.

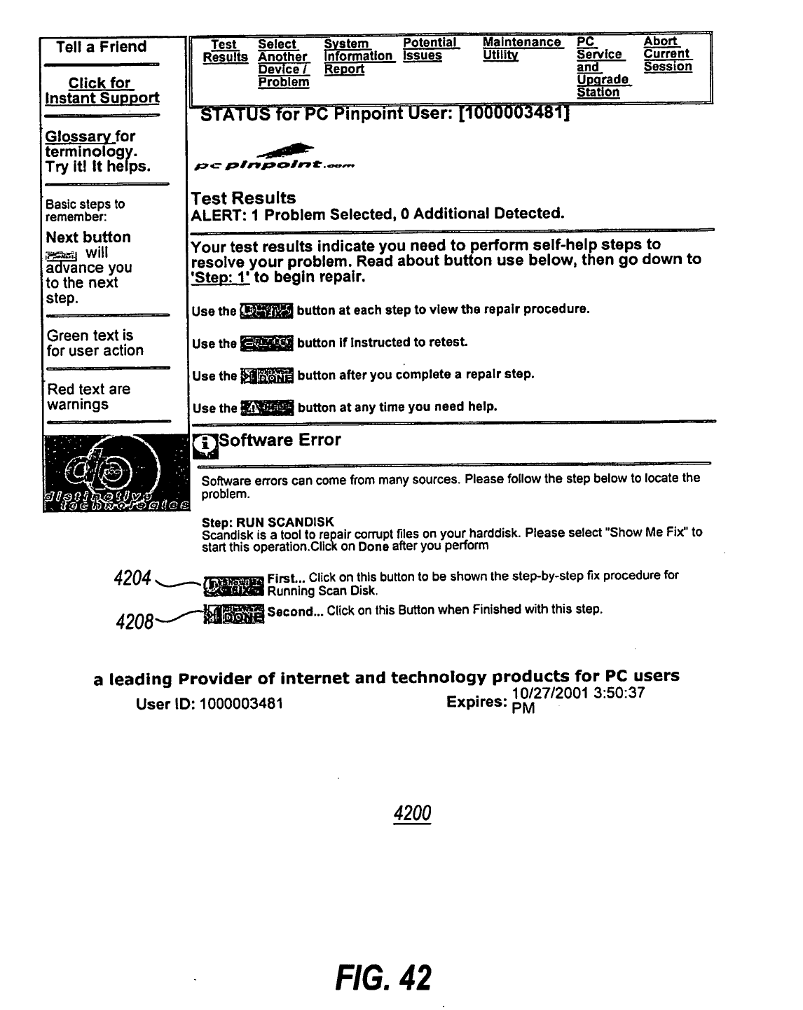

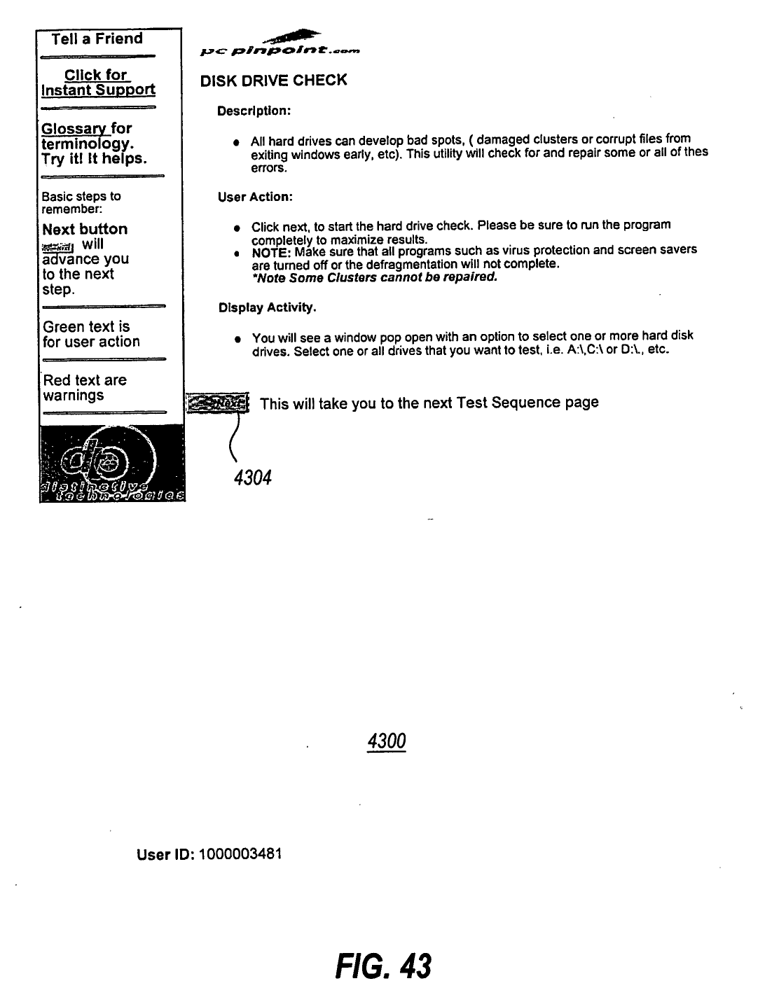

In response to a selection of the description “my program gives me an error message before the program shows on my page” 4104, the user is presented with a software error disposition page 4200 (see FIG. 42). The software error disposition page 4200 provides suggested solutions to the indicated problem. In particular, the page 4200 may suggest that the user run a utility program, such as scan disk, to repair corrupt files. In addition, a “show me fix” 4204 button is provided. By selecting the “show me fix” 4204 button, the user can access further information regarding the suggested repair. For example, the user may be presented with a scan disk information page 4300 (see FIG. 43) that describes the scan disk process. The scan disk information page 4300 may also include a run or next button 4304 that allows the user to initiate execution of the scan disk program. Accordingly, the present invention provides a mechanism by which the user can be informed of suggested maintenance or repair procedures, and allows the user to initiate those procedures from the client application 400, without requiring that the user have advanced technical skills. After the scan disk utility has executed, the user may again select the next button 4304 to proceed to the next test sequence page. The user is then returned to the software error disposition screen 4200, and the user may select the “done” button 4208 to indicate that the previous step has been completed.

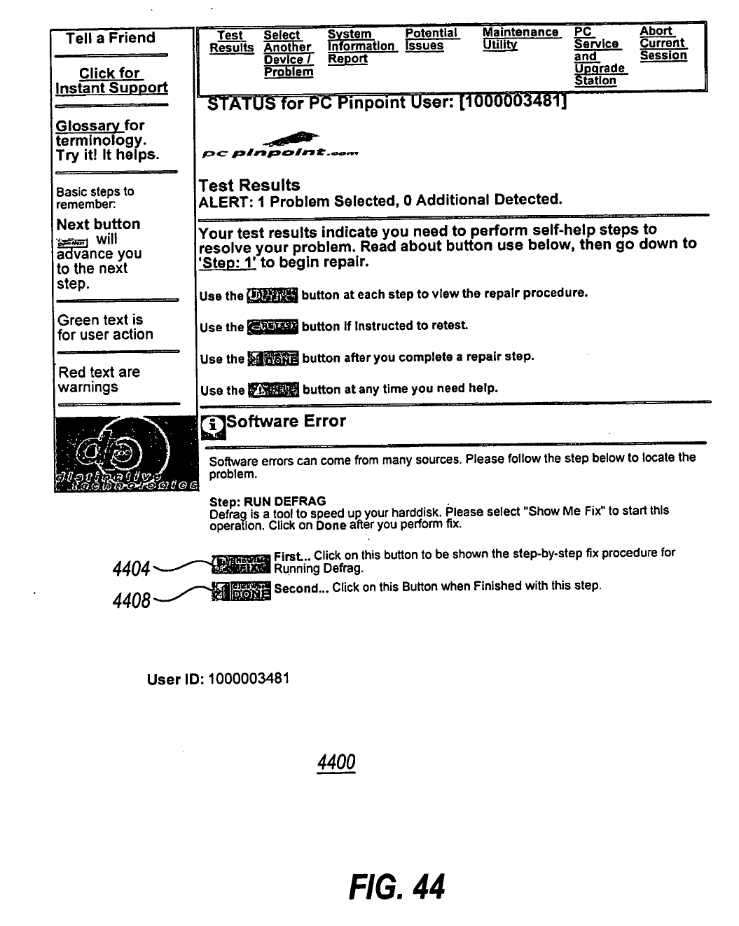

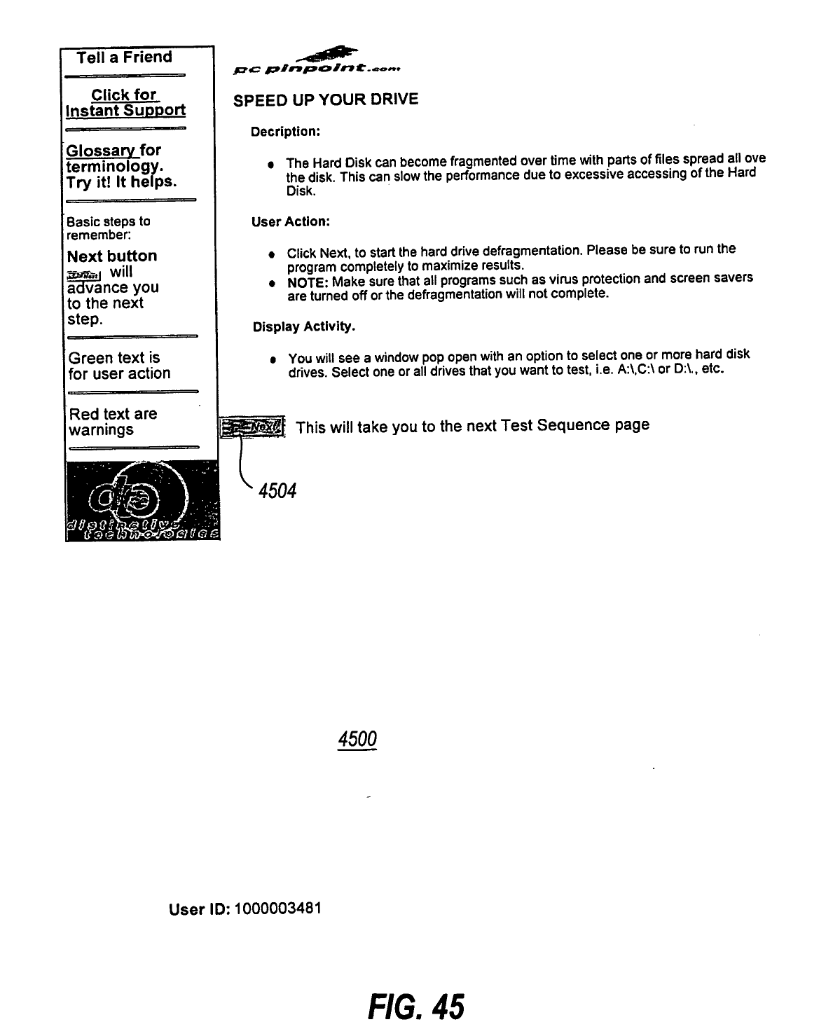

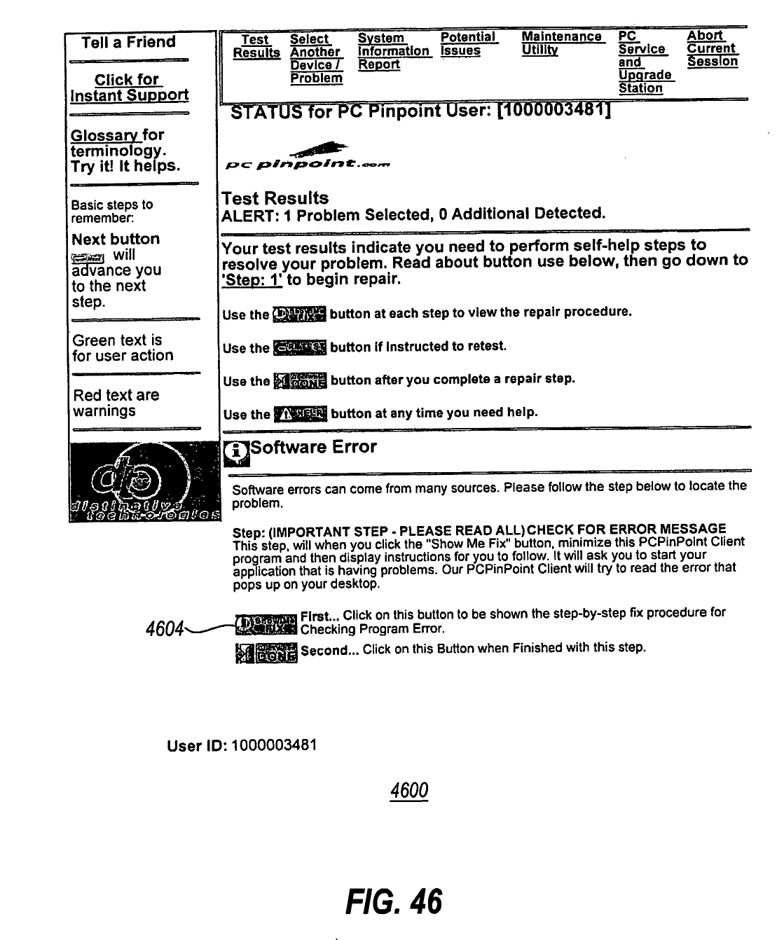

The user may then be presented with a software error, defragmentation disposition screen 4400 (see FIG. 44). The defragmentation disposition screen 4400 includes a “show me fix” button 4404 that can be selected by the user to view the step by step procedure for running the defragmentation program. Upon selection of the “show me fix” button 4404, the user is presented with a defragmentation information screen 4500 (see FIG. 45). The defragmentation information page 4500 includes a “next” button 4504 that allows the user to select execution of the defragmentation program. Following completion of the defragmentation program operations, the user is returned to the software error, defragmentation disposition screen 4400. Upon selection of the “done” button 4408, the user is presented with software error, check for error message disposition screen 4600 (see FIG. 46).

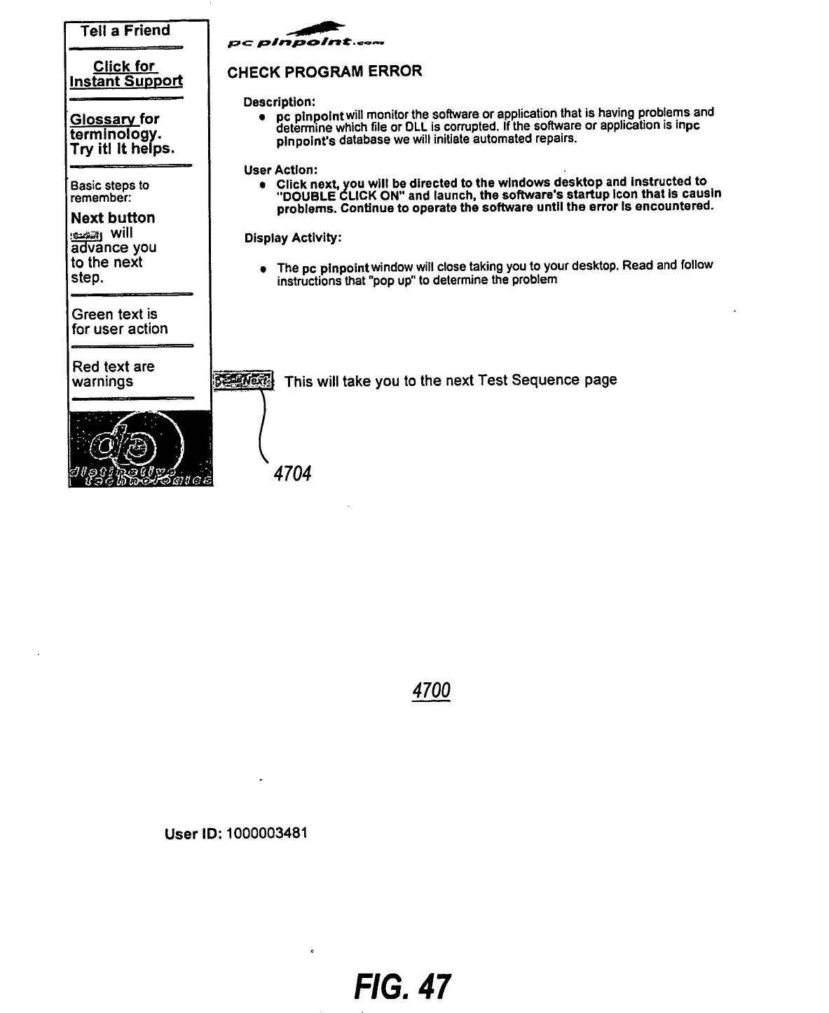

The software error, check for error message disposition page 4600 includes a “show me fix” button 4604 that takes the user to a check program error information page 4700 (see FIG. 47). The check program error information page 4700 describes the steps that will occur automatically and the steps that the user must take after the clicking the “next” button 4704 to proceed with the check. In particular, the client may be instructed to double click on the start-up icon associated with the software that the user believes is problematic.

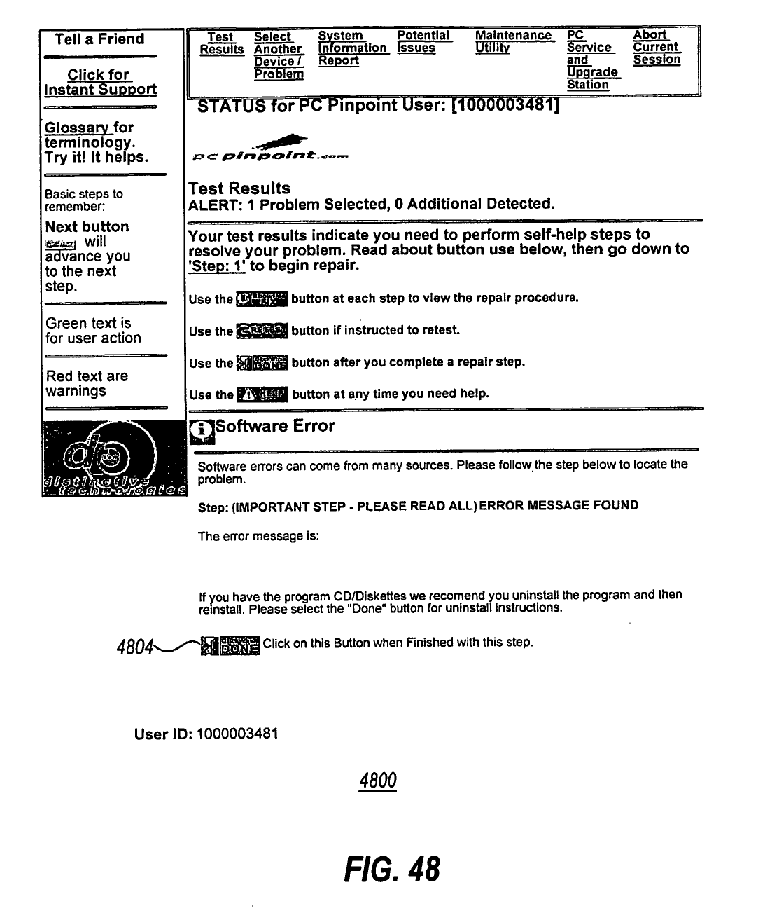

With reference now to FIG. 48, a found error message page 4800 is illustrated. The found error message page 4800 presents to the user the particular error message generated by the program started by the user, and recommends further action. For example, the user may be told to uninstall and then reinstall the program if program disks are available. A “done” button 4804 is provided to allow the user to exit the error message found page 4800 when the user is finished reading the information on that page.

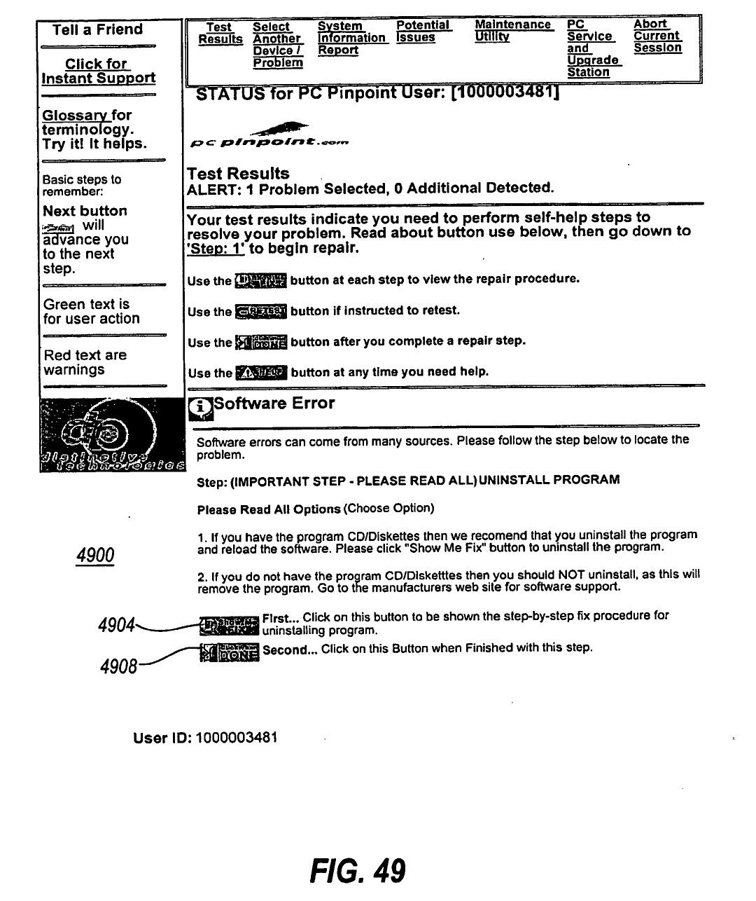

Following selection of the “done” button 4804, the user is presented with an uninstall program information page 4900 (see FIG. 49). From the uninstall program information page 4900, the user can choose to select a “show me fix” 4904 to receive instructions on how to uninstall the program. The user may then be presented with a list of programs to select from. By selecting the problematic program and indicating a desire to proceed by clicking on a provided button, the user may initiate the uninstall process. When the uninstall process has completed, the user may select the “done” button 4908.

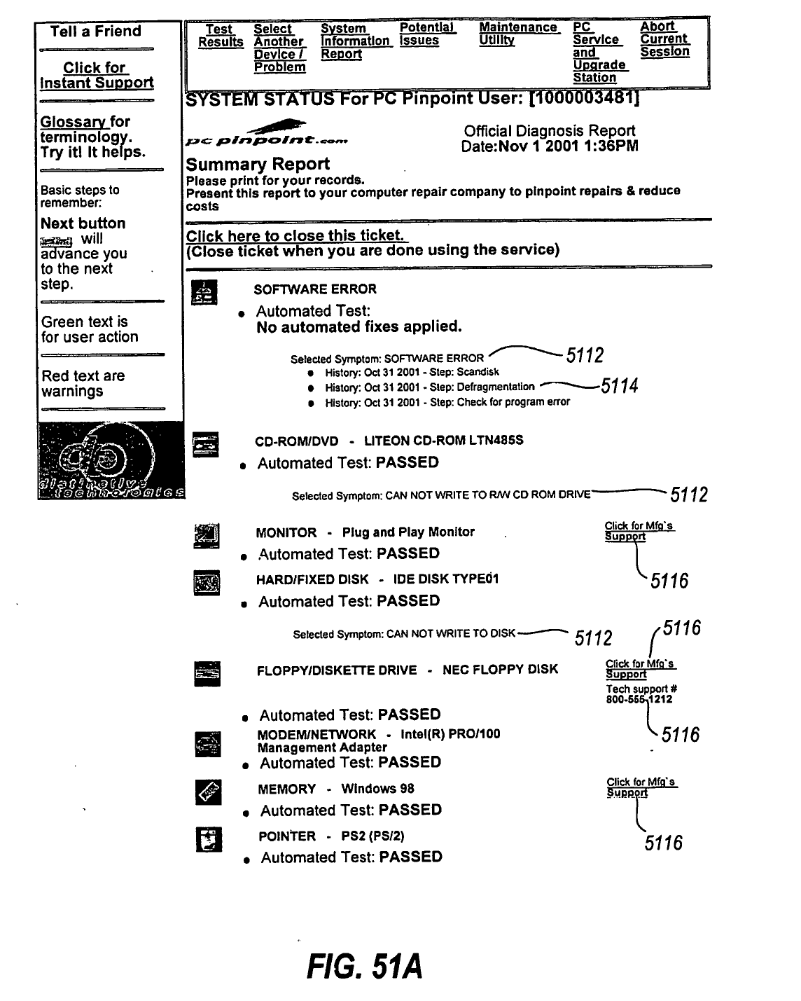

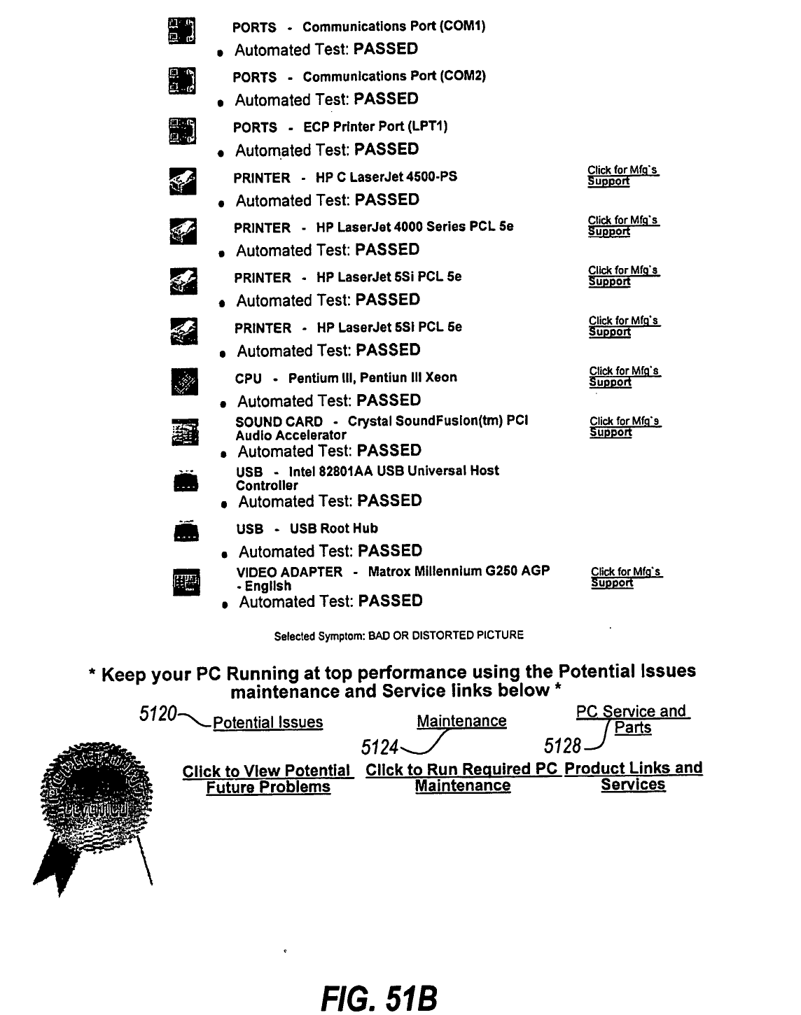

A problem status page 5000 (see FIG. 50) is presented to the user after all of the procedures associated with an indicated problem have been completed. The problem status page 5000 allows the user to select to receive a session summary, and provides various additional sources of assistance for use if the procedures followed have not resulted in resolution of the indicated problem or problems. For example, the user may select a chat link 5004 to commence a chat session with a live service technician. In addition, a telephone number 5008 may be provided to allow the user to speak with a service technician by telephone. In addition, an e-mail address 5012 may be provided to allow the user to correspond with service technicians by e-mail. A “next” button 5016 presents the user with a summary report 5100 (see FIGS. 51A-B).

The summary report 5100 provides a list 5104 of each device detected in connection with the client computer 108. For each such device, the results of automated testing 5108 are presented in a passed/failed format. With respect to devices that the user indicated were problematic, the symptom identified by the user 5112 is presented. Accordingly, the summary report 5100 provides the status of devices associated with the client computer 108, including the results of testing and symptoms that were being experienced by the user. In addition, a record of maintenance procedures or fixes performed 5114 maybe included.

With respect to all or certain of the devices included in the list 5104, links 5116 may be provided for accessing additional sources of support. For example, the links 5116 may open a browser window on the client computer 108 addressed to a support web site maintained by the manufacturer of the device associated with the link 5116. Alternatively or in addition, the additional support link 5116 may provide other means for contacting sources of additional support, such as telephone numbers or e-mail addresses for contacts at the manufacturer of the device associated with the link 5116.

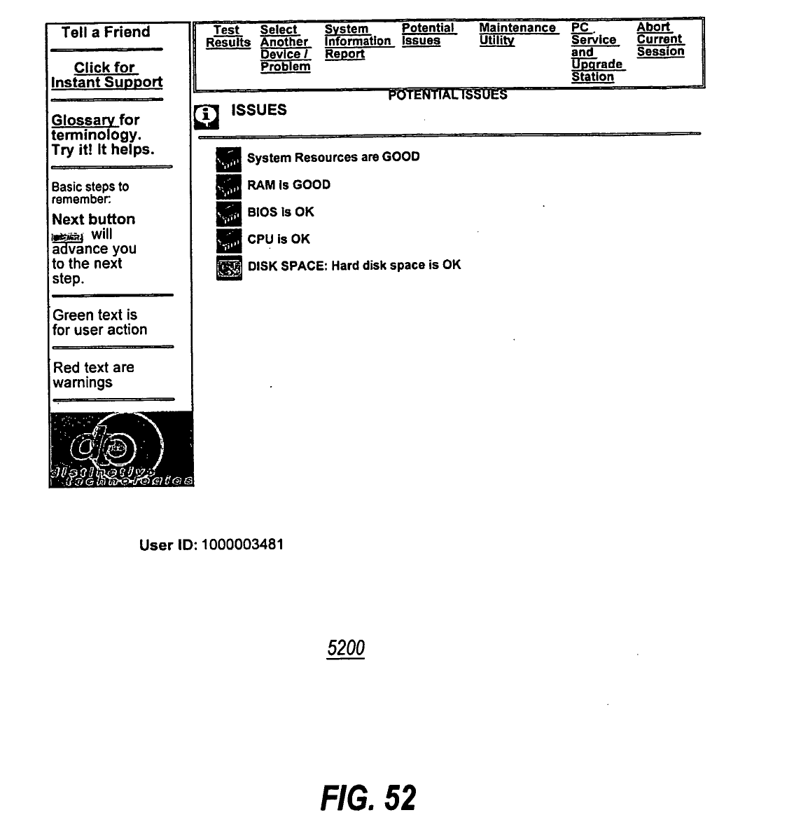

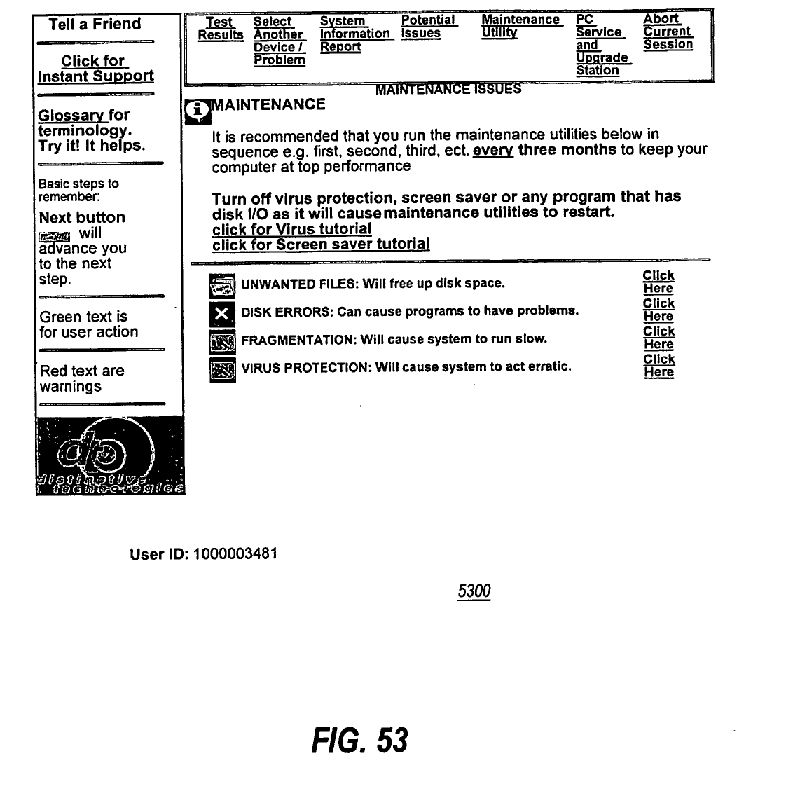

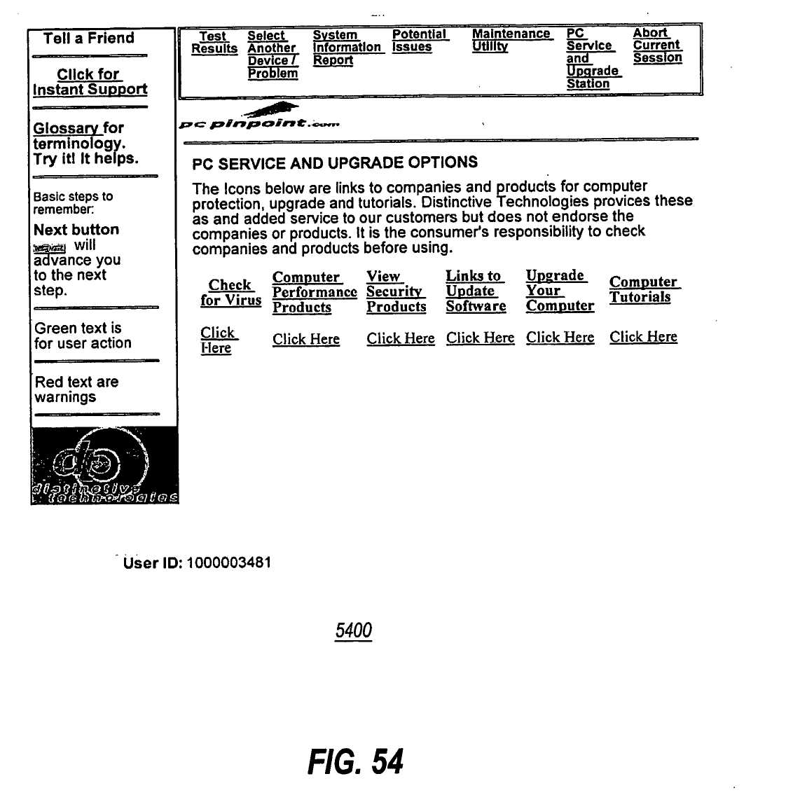

Other links may be provided on the summary report page 5100 that are directed to the future performance of the client computer 108. For example, a potential issues link 5120 may be provided to alert the user to potential future issues with respect to the client computer 108. Accordingly, selecting the potential issues link 5120 may direct the user to a potential issues page 5200 (see FIG. 52) summarizing the condition of various aspects of the client computer 108. The maintenance link 5124 may be selected to allow the user to access tutorials or perform various maintenance procedures. Accordingly, the present invention may provide facilities that allow even a user who is not technically skilled to perform maintenance procedures, thereby potentially avoiding future problems with the client computer. Examples of maintenance procedures that may be accessed through the maintenance link 5124 and in turn the maintenance issues page 5300 (see FIG. 53) include deleting unwanted files, running scan disk, running defragmentation utilities, and installing and updating virus protection software. The product links and services link 5128 presents the user with a service and upgrade options page 5400 (see FIG. 54). From the service and upgrade option page 5400, the user can link to providers of various products, including virus protection software, computer security products, software, hardware suppliers, and computer tutorials.

In accordance with the present invention, a method and apparatus for diagnosing computer hardware and software are provided. The invention in its broader aspects relates to a method and apparatus for diagnosing computer hardware and software without requiring input from a user or technician who is experienced in computer repair. In particular, the present invention provides a method and apparatus that are capable of diagnosing computer hardware and software while receiving only basic input from a user of a computer to be diagnosed, and without requiring human intervention at the server side of the system. Furthermore, the method and apparatus of the present invention is capable of providing repair information, including information necessary to effect a repair automatically.

Although the present invention includes descriptions of particular embodiments, it will be appreciated that various modifications are possible and are within the scope of the description. For example, menu items that may be selected by the user to describe a perceived problem or problems may include items in addition or as alternatives to those described in the foregoing description. As a further example, the computer to be diagnosed may be part of a local computer network, rather than a stand alone computer. Furthermore, the present invention may be used to diagnose digital devices other than personal computers, including personal digital assistants, wireless devices of various configurations, or other devices capable of communicating with a diagnosing server.

The foregoing discussion of the invention has been presented for purposes of illustration and description. Further, the description is not intended to limit the invention to the form disclosed herein. Consequently, variations and modifications commensurate with the above teachings, within the skill and knowledge of the relevant art, are within the scope of the present invention. The embodiments described hereinabove are further intended to explain the best mode presently known of practicing the invention and to enable others skilled in the art to utilize the invention in such or in other embodiments and with various modifications required by the particular application or use of the invention. It is intended that the appended claims be construed to include alternative embodiments to the extent permitted by the prior art.

1. A method for remotely diagnosing a computer, comprising:
establishing communication between a server and a communications interface associated with a client computer;
establishing communication between a client application operating on said client computer and said server;
in response to a signal associated with said communications interface and received by said server, downloading a first diagnostic tool from said server to said client application;
executing said first diagnostic tool;
returning a result from said client application to said server; and
returning a disposition from said server to said communications interface.

2. The method of claim 1, wherein said communications interface includes a browser and the method further comprising:
downloading a client identifier from said server to said browser;
placing said identifier in a title bar of a browser window;
passing said identifier to said client application, wherein said client application copies said identifier from said browser window.

3. The method of claim 1, further comprising:
establishing a user record in a database associated with said server corresponding to said client computer, wherein said record includes a status field;
in response to a signal received from said communications interface, setting said status field to a first value;
executing a second diagnostic tool using said client application in response to said client application detecting said first value in said user record.

4. The method of claim 3, further comprising:
in response to a signal received from said client application, setting said status field to a second value after said step of executing a said second diagnostic tool is essentially complete;
displaying a next page in response to said communications interface detecting said second value in said user record.

5. The method of claim 3, wherein said client application polls said server to detect said first value.

6. The method of claim 4, wherein said communications interface polls said server to detect said second value.

7. The method of claim 1, further comprising:
using said communications interface, prompting a user to select a potential computer problem;
in response to said user's input, downloading and executing a second diagnostic tool using said client application;
returning a result of executing said second diagnostic tool to said server; and
displaying a disposition to said user using said communications interface.

8. The method of claim 7, wherein said server compares said result of executing said second diagnostic tool to a plurality of stored results, wherein each of said stored results is associated with one of a plurality of dispositions, and wherein said server returns at least a first disposition of said plurality of dispositions to said communications interface.

9. The method of claim 7, wherein said second diagnostic tool traps an error message generated on said client computer, and wherein said step of returning a result to said server comprises returning said trapped error message to said server.

10. The method of claim 1, further comprising:
in response to a signal from said communications interface and received by said server, downloading a second client diagnostic tool from said server to said client application;
executing said second client diagnostic tool; and
returning a result from said client application to said server.

11. The method of claim 1, wherein said disposition comprises information concerning at least one of a list of installed hardware, a list of installed software, a hardware fault, a software fault, a recommendation to perform a maintenance procedure and a source for obtaining further information.

12. The method of claim 1, further comprising:
providing at least a partial inventory of devices installed on said client computer to a user; and
prompting the user of said client computer to identify one or more additional installed devices.

13. The method of claim 1, further comprising:
storing at least a partial inventory of devices installed on said client computer in a database associated with said server.

14. A system for remotely diagnosing computer hardware and software, comprising:
a server;
a server application program;
a client computer;
a plurality of client diagnostic tools;
a computer network interconnecting said server and said client computer;
a communications interface in communication with said server;
a client application program, wherein said client application program communicates with said server and said client application performs a number of functions, including:
executing at least a one of said plurality of client diagnostic tools, said at least one of said client diagnostic tools being downloaded from said server; and
returning results obtained from said executing step to said server, wherein in response to said results returned to said server, said server application program returns a disposition concerning said client computer to said communications interface.

15. The system of claim 14, wherein said computer network comprises the Internet.

16. The system of claim 14, wherein a first of said client diagnostic tools creates a first inventory of hardware and software installed on said client computer.

17. The system of claim 16, wherein said first inventory is returned to said communications interface.

18. The system of claim 14, wherein said disposition concerning said client computer comprises at least one of a suggested maintenance operation, a suggested repair, a detected fault and a referral to an additional source of repair information.

19. The system of claim 18, wherein said referral to an additional source of repair information comprises providing at least one of a telephone number, a mailing address, an e-mail address and a Universal Resource Locator.

20. A method for providing a user of a computer with diagnosis of said computer from a remote location, comprising:
establishing a communications channel between a communications interface associated with said computer and a server located at said remote location;
in response to said server receiving a first signal from said communications interface, downloading a client application to said computer;
installing said client application on said computer;
in response to said server receiving a second signal from said communications interface, downloading a first diagnostic tool to said computer;
executing said first diagnostic tool using said client application, wherein at least a partial inventory of hardware associated with said computer is obtained;
returning said at least partial inventory of said hardware from said client application to said server;
downloading a second diagnostic tool to said computer;
executing said second diagnostic tool using said client application, wherein at least a first functional test of at least a portion of said installed hardware is performed;
returning a first result from said first functional test to said server;
analyzing said first result; and
returning a disposition of said computer to said user.

21. The method of claim 20, wherein said step of analyzing said first result comprises comparing said first result to a plurality of stored results having an associated disposition.

22. The method of claim 20, further comprising:
downloading a third diagnostic tool to said computer;
executing said third diagnostic tool using said client application, wherein an application resident in said computer is opened, and wherein information concerning the opening of said resident application is returned to said server.

23. The method of claim 22, wherein said information comprises at least one of a time to load said resident application, an error message, and a time to exit said resident application.

24. The method of claim 20, further comprising:
assigning an identifier to said computer;
downloading said identifier from said server to said communications interface;
placing said identifier in a title bar of a window on said computer; and
copying said identifier from said title bar to said client application.

25. The method of claim 20, wherein said step of executing said first diagnostic tool is initiated in response to said client application detecting a first value in a user record stored on said server, wherein said first value is entered in said user record in response to a signal received from said communications interface.

26. The method of claim 25, wherein following said step of executing said first diagnostic tool a second value is entered in said user record, and wherein in response to said communications interface detecting said second value a next page is displayed.

27. A method for remotely diagnosing a computer, comprising:
providing computer related selector inputs on a display screen including a plurality of the following: a hardware related selector input, a software related selector input, a performance related selector input and an other related selector input;
performing a plurality of the following using the computer: checking at least partially inventory of hardware devices associated with the computer, conducting functional tests associated with a number of said hardware devices, determining performance data associated with the computer, diagnosing software associated with the computer, relying on at least one of said selector inputs, and utilizing log files from test applications associated with the computer to generate diagnostic information related to said hardware devices and/or said software associated with the computer; and
developing output information based on said diagnostic information.

28. A method, as claimed in claim 27, wherein:
said providing step includes selecting said software related selector input and generating a first menu related to diagnosing software.

29. A method, as claimed in claim 27, wherein:
said providing step includes selecting said performance data selector input and generating a second menu related to diagnosing performance of the computer.

30. A method, as claimed in claim 27, wherein:
said performing step includes checking at least partially said inventory of said hardware devices, conducting said functional tests associated with said at least partial inventory of said hardware devices and ascertaining whether at least one of said selector inputs was activated by a user of the computer.

31. A method, as claimed in claim 27, wherein:
said output information relates to at least one of the following: assisting a user of the computer to change the computer, providing a change by said server to the computer and providing a source that can have information related to making a change to the computer.

32. A method, as claimed in claim 31 wherein:
said output information includes at least one of the following: web site link information, telephone link information, customer help line link information, telephone support link information and a software patch.

33. A method, as claimed in claim 27, further comprising:
assigning an identifier to the computer;
providing said identifier to a communications interface associated with the computer; and
providing said identifier to a client application that is executable using the computer.

34. A method, as claimed in claim 33, wherein:
said communications interface includes a client browser and said providing step includes placing said identifier in a title bar of said client browser and reading said title bar using said client application.

35. A system for remotely diagnosing a computer, comprising:
a server; and
storage memory communicating with said server that stores a plurality of the following: a first diagnostic tool related to checking inventory of hardware devices associated with the computer; a second diagnostic tool related to performing functional tests on hardware devices associated with the computer; a third diagnostic tool related to determining performance data associated with the operation of the computer; a fourth diagnostic tool related to diagnosing software associated with the computer; and/or files from test applications associated with the computer.

36. A system, as claimed in claim 35, wherein:
said storage memory stores a client application that can execute on the computer and also stores a sixth diagnostic tool related to utilizing selector inputs.

37. A method, as claimed in claim 36, wherein:
a client application is downloadable to the computer from said server and said client application is used in obtaining information when at least one of said selector inputs is activated by a user of the computer and information related to said at least one selector input when activated is provided to said server.

38. A system, as claimed in claim 37, further comprising:
a first computer that executes said client application and is used to display said selector inputs.

39. A method for diagnosing a computer, comprising:
directing a communications interface application to a diagnosing web site;
providing identifying information related to a computer to be diagnosed;
receiving at said computer to be diagnosed a client application;
receiving test results of hardware installed in said computer to be diagnosed;
selecting a problem to diagnose; and
receiving information regarding said problem, wherein said information includes at least one of a suggested automated fix and a suggested self-help procedure.

40. The method of claim 39, further comprising executing said client application, wherein said client application is executed independently of said communications interface application

41. The method of claim 39, further comprising:
receiving at said computer to be diagnosed at least a first script; and
running said at least a first script;

42. The method of claim 41, wherein said at least a first script comprises a diagnostic program.

43. The method of claim 41, wherein said step of running said at least a first script comprises running said first script in connection with said client application.

44. The method of claim 39, wherein said communications interface application is running on said computer to be diagnosed.

45. The method of claim 39, wherein said communications interface application comprises an Internet browser.

46. The method of claim 39, further comprising providing user identifying information.

47. The method of claim 39, further comprising receiving a script to execute a utility program, wherein in response to receiving information comprising a suggested automated fix, said suggested automated fix can be performed by executing said script to execute a utility program.

48. The method of claim 39, wherein a suggested self-help procedure is received, said suggested self-help procedure comprising a tutorial explaining how to perform said procedure.

49. A method for diagnosing a computer, comprising:
receiving from a remote computer identifying information;
assigning an identifier to said remote computer;
providing a client application to said remote computer;
executing said client application, wherein an inventory of hardware installed in said remote computer is compiled;
returning a disposition to said remote computer, wherein said disposition comprises at least one of a suggested automated fix, a suggested self-help procedure, and a suggested maintenance procedure.

50. The method of claim 49, wherein said step of executing said client application is performed independently of a communications interface application.

51. The method of claim 49, further comprising providing at least a first test script to said remote computer, wherein said step of running said client application comprises running said test script.

52. The method of claim 49, further comprising:
providing at least a first test script to said remote computer; and
diagnosing a problem, wherein said step of diagnosing a problem comprises running said at least a first test script.

53. The method of claim 49, further comprising:
receiving at said remote computer a selection of a problem identified by a user; and
diagnosing said problem, wherein said step of diagnosing a problem is performed in response to said selection.

54. The method of claim 49, further comprising:
providing at least a first test script to said remote computer;
executing said test script, wherein at least a first problem is identified in connection with said remote computer; and
diagnosing said identified problem.

55. The method of claim 49, wherein an inventory of software installed in said remote computer is compiled.

56. The method of claim 49, further comprising providing said remote computer with a script for performing a suggested automated fix.

57. The method of claim 49, further comprising performing said suggested automated fix in response to receiving at said remote computer a signal to perform said suggested automated fix.

58. The method of claim 49, further comprising:
diagnosing at least one of an identified and a selected problem; and
re-diagnosing said problem after said step of returning a disposition.

59. A method for remotely diagnosing computer problems, comprising:
providing a diagnosing server computer;
establishing a connection between said server computer and a remote computer over a communication network;
sending a test script to said remote computer;
receiving from said remote computer a result obtained from a running of said test script;
analyzing at said server said result;
associating said result with a disposition;
sending said disposition to said remote computer.

60. The method of claim 59, further comprising:
receiving an indication of a possible problem with said remote computer submitted by a user of said remote computer.

61. The method of claim 59, wherein said disposition comprises an automated fix.

62. The method of claim 61, wherein said automated fix comprises providing a new device driver to said remote computer.

63. The method of claim 59, wherein said disposition comprises instructions to a user of said remote computer regarding how to correct an identified problem.

64. The method of claim 59, wherein said result comprises configuration information related to said remote computer, said method further comprising:
storing said result.

65. The method of claim 59, wherein said step of establishing a connection between said server computer and a remote computer over a communication network comprises:
establishing communication between said server computer and a communications interface associated with said remote computer; and
establishing communication between said server computer and a client application associated with said remote computer.

66. The method of claim 65, wherein said communications interface comprises a browser program running on said remote computer.

67. The method of claim 65, wherein said client application comprises a client application capable of executing said test script.

68. The method of claim 59, wherein said result comprises an inventory of devices and software residing on said remote device.

69. The method of claim 59, further comprising:
storing said result in a database associated with said server computer.

70. The method of claim 59, further comprising:
determining that said disposition sent to said remote computer was not successful in remedying a problem at said remote computer;
associating said result with an additional disposition;
sending said additional disposition to said remote computer.

71. The method of claim 59, further comprising:
determining an effect of said disposition sent to said remote computer; and
updating a record related to said disposition.

72. A system for remotely diagnosing a computer, comprising:
a network interface, wherein scripts are provided to a remote computer, and wherein test results related to said remote computer are received;
data storage, wherein said test results are stored, and wherein a plurality of dispositions each related to a problem are stored;
a processor, wherein said test results are analyzed and at least a one of said plurality of dispositions is selected for provision to said remote computer.

73. The system of claim 72, wherein said test results related to said remote computer comprise configuration data.

74. The system of claim 72, wherein each of said dispositions included in said plurality of dispositions and stored in said data storage are weighted with respect to a particular problem.

75. The system of claim 72, wherein said selected disposition comprises an automated repair procedure script.

76. The system of claim 72, wherein said network interface, said data storage, and said processor are components of a server computer system, said system further comprising:
a communications interface running on said remote computer, wherein authorization by a user of said remote computer to execute a script is received at said network interface;
a client application running on said remote computer, wherein said client application operates to execute a script received from said network interface.

77. The system of claim 72, wherein a comparison is made between said stored test results and at least one of additional test results and a user indication that a component, device or software program is not functioning properly.
